(19) United States
(12) Patent Application Publication
(10) Pub. No.: US 2016/0034764 A1
(43) Pub. Date: Feb. 4, 2016

(54) Wearable Imaging Member and Spectroscopic Optical Sensor for Food Identification and Nutrition Modification

(71) Applicant: Robert A. Connor, Forest Lake, MN (US)

(72) Inventor: Robert A. Connor, Forest Lake, MN (US)

(21) Appl. No.: 14/449,387

(22) Filed: Aug. 1, 2014

(51) Int. Cl. G06K 9/00; H04N 7/18; G06T 7/00; G06K 9/22

(52) U.S. Cl. CPC G06K 9/00771; G06K 9/228; H04N 7/185; G06T 7/0004; G06K 2209/17; G06T 2207/30128

(57) ABSTRACT

This invention is a wearable device or system for identification and quantification of food comprising an imaging member (such as a camera) that takes pictures of nearby food, an optical sensor (such as a spectroscopic optical sensor) which collects data concerning light that is reflected from this food, an attachment mechanism (such as a wrist band), and an image-analyzing member (such as a data control unit). This invention can further comprise a computer-to-human interface which modifies a person's nutritional intake based on identification of unhealthy vs. healthy food.

### CROSS-REFERENCE TO RELATED APPLICATIONS

This patent application is: (a) a continuation in part of U.S. patent application Ser. No. 13/523,739 by Robert A. Connor entitled “The Willpower Watch™: A Wearable Food Consumption Monitor” filed on Jun. 14, 2012; and is also (b) a continuation in part of U.S. patent application Ser. No. 13/901,099 by Robert A. Connor entitled “Smart Watch and Food-Imaging Member for Monitoring Food Consumption” filed on May 23, 2013, which claimed the priority benefit of: U.S. provisional patent application No. 61/813,780 by Robert A. Connor entitled “Smart Watch that Measures Food Consumption” filed on Apr. 19, 2013; and U.S. provisional patent application No. 61/825,007 by Robert A. Connor entitled “Smart Watch and Food-Imaging Member for Monitoring Food Consumption” filed on May 18, 2013. The entire contents of these related applications are incorporated herein by reference.

### FEDERALLY SPONSORED RESEARCH

Not Applicable

### SEQUENCE LISTING OR PROGRAM

Not Applicable

### BACKGROUND

1. Field of Invention

This invention relates to energy balance, weight loss, and proper nutrition.

2. Introduction to Energy Balance and Proper Nutrition

The United States population has some of the highest prevalence rates of obese and overweight people in the world. Further, these rates have increased dramatically during recent decades. In the late 1990's, around one in five Americans was obese. Today, that figure has increased to around one in three. It is estimated that around one in five American children is now obese. The prevalence of Americans who are generally overweight is estimated to be as high as two out of three.

This increase in the prevalence of Americans who are overweight or obese has become one of the most common causes of health problems in the United States. Potential adverse health effects from obesity include: cancer (especially endometrial, breast, prostate, and colon cancers); cardiovascular disease (including heart attack and arterial sclerosis); diabetes (type 2); digestive diseases; gallbladder disease; hypertension; kidney failure; obstructive sleep apnea; orthopedic complications; osteoarthritis; respiratory problems; stroke; metabolic syndrome (including hypertension, abnormal lipid levels, and high blood sugar); impairment of quality of life in general including stigma and discrimination; and even death.

There are estimated to be over a quarter-million obesity-related deaths each year in the United States. The tangible costs to American society of obesity have been estimated at over $100 billion dollars per year. This does not include the intangible costs of human pain and suffering. Despite the considerable effort that has been focused on developing new approaches for preventing and treating obesity, the problem is growing. There remains a serious unmet need for new ways to help people to moderate their consumption of unhealthy food, better manage their energy balance, and lose weight in a healthy and sustainable manner.

Obesity is a complex disorder with multiple interacting causal factors including genetic factors, environmental factors, and behavioral factors. A person's behavioral factors include the person's caloric intake (the types and quantities of food which the person consumes) and caloric expenditure (the calories that the person burns in regular activities and exercise). Energy balance is the net difference between caloric intake and caloric expenditure. Other factors being equal, energy balance surplus (caloric intake greater than caloric expenditure) causes weight gain and energy balance deficit (caloric intake less than caloric expenditure) causes weight loss.

Since many factors contribute to obesity, good approaches to weight management are comprehensive in nature. Proper nutrition and management of caloric intake are key parts of a comprehensive approach to weight management. Consumption of “junk food” that is high in simple sugars and saturated fats has increased dramatically during the past couple decades, particularly in the United States. This has contributed significantly to the obesity epidemic. For many people, relying on willpower and dieting is not sufficient to moderate their consumption of unhealthy “junk food.” The results are dire consequences for their health and well-being.

The invention that is disclosed herein directly addresses this problem by helping a person to monitor and modify their nutritional intake. The invention that is disclosed herein is an innovative technology that can be a key part of a comprehensive system that helps a person to reduce their consumption of unhealthy food, to better manage their energy balance, and to lose weight in a healthy and sustainable manner. In the following sections, we categorize and review the prior art, provide a summary of this invention, and then provide some detailed examples of how this invention can be embodied to help a person to improve their nutrition and to manage their weight.

### CATEGORIZATION AND REVIEW OF THE PRIOR ART

As part of this review, I have categorized the relevant prior art into general categories. There are five general categories of prior art and a sixth miscellaneous category. With the complexity of this field and the volume of patents therein, seeking to categorize all relevant examples of prior art into discrete categories is challenging. Some examples of prior art span multiple categories and no categorization scheme is perfect.

However, even an imperfect categorization scheme can serve a useful purpose for reviewing the prior art. This is especially true when there is a large quantity of relevant prior art. In the categorization and review of the prior art herein, I have identified and classified over 500 examples of prior art. Writing up individual reviews for each of these 500+ examples would be prohibitively lengthy and would also be less useful for the reader, who would have to wade through these 500+ individual reviews. It is more efficient for the reader to be presented with these 500+ examples of prior art having been grouped into six general categories, wherein these six general categories are then reviewed and discussed. To help readers who may wish to dig further into examples within a particular category or to second guess my categorization scheme, I also provide relatively-detailed information on each example of the prior art, including the patent (application) title and date in addition to the inventors and patent (application) number.

The six categories which I use to categorize the 500+ examples of prior art for this review are as follows: (1) non-wearable devices primarily to help measure food consumption; (2) wearable devices primarily to monitor and measure caloric expenditure activities; (3) wearable devices primarily to monitor and measure food consumption; (4) wearable devices to monitor caloric expenditure activities and to help measure food consumption; (5) wearable devices to monitor and measure both caloric expenditure activities and food consumption; and (6) other potentially-relevant devices and methods.

In general, non-wearable devices that help a person to measure their food consumption depend on voluntary action by the person in association with each specific eating event. These non-wearable devices tend to be relatively non-intrusive with respect to privacy, but can suffer from low accuracy if a person does not use them consistently for every meal and snack. In general, there are few current wearable devices for automatically detecting food consumption and these current devices are not very accurate for identifying the specific types of foods that the person consumes. Future generations of wearable devices will probably be more accurate in identifying which specific foods the person consumes, but may also be highly-intrusive with respect to privacy. The main focus of this invention is on the measurement of food consumption. This is currently the weak link in energy balance measurement. However, devices and methods for measuring caloric expenditure activities, including pedometers and other fitness devices, are also included in this categorization scheme. This is because I believe that there will be increasing convergence of food consumption measurement and caloric expenditure measurement into combined energy balance devices. This makes sense because net energy balance is a function of both energy intake and energy expenditure. This is why, for example, I have included a category in this review for wearable fitness devices which monitor and measure only caloric expenditure activities, even though the primary focus of this invention is on monitoring and measuring food consumption. I now review each of the six categories of prior art.

### (1) Non-Wearable Devices Primarily to Help Measure Food Consumption

There are a wide variety of non-wearable devices and methods in the prior art that are intended primarily to help a person measure their food consumption. Since these devices are not worn by a person and do not automatically monitor the person's activities, they require some type of voluntary action by the person in association with each eating event (apart from the actual act of eating).

For decades, many people manually kept track of what foods they ate and/or the associated calories (often called a “food log,” “diet log,” or “calorie counting”) using a pencil and paper. With the development of personal computers, mobile electronic devices, and smart phone applications, much of this manual food consumption tracking has been made easier with menu-driven human-to-computer interfaces that help people to more easily enter information concerning what food they eat. Databases of common foods and their associated nutritional information (including calories) have made calorie counting easier by automatically associating calories with foods entered.

Today, there are mobile phone applications that enable people to manually enter information concerning what foods they eat. Some of these applications also offer automatic analysis of pictures that people take of food in order to at least partially automate the process of identifying the types and amounts of food consumed. The human-to-computer interfaces of such food-logging applications are evolving from keyboards and keypads to touch screens, speech recognition, and gesture recognition. However, these approaches all rely on voluntary human action. Their accuracy is limited by: the degree to which the person consistently uses the device for each meal or snack; and the accuracy with which the person and/or device evaluates the types and amounts of food consumed when the device is actually used.

Although mobile phone food tracking applications are a popular form of device in this category, there are a wide variety of other devices and methods in this category beyond such mobile phone applications. Examples of devices and methods in this category include: specialized portable computing devices that help a person to manual enter food consumption information to create a food log; food databases that automatically link manually-entered foods with nutritional parameters (e.g. calories or nutrient types) associated with those foods; mobile phone applications with menu-driven human-to-computer interfaces for entering food consumption information (e.g. via keypad, touch screen, speech recognition, or gesture recognition); imaging devices and image-analysis systems that enable automatic analysis of food pictures to identify the types and amounts of food in a picture; non-worn food-imaging devices that use bar codes or other packaging codes to identify foods; non-worn food-imaging devices that use food logos or other packaging patterns to identify foods; interactive food logging and meal planning websites and software; smart cards and other systems based on financial transitions that track food purchases; devices that receive information from RFID tags associated with food; computerized food scales, food-weighing dishes and utensils; utensils and accessories designed to track or modify eating speed; smart food utensils or accessories that measure food weight and/or analyze food content; food utensils and containers that track or modify food portions; and smart food containers that track their contents and/or limit access times. Specific limitations of such devices in the prior art include the following.

Specialized hand-held computing devices for measuring food consumption are limited by whether a person wants to carry around a (separate) specialized electronic device, whether the person will consistently use it for every meal or snack they eat, and how skilled the person is in evaluating the amounts and types of food consumed. Food databases are limited when a person eats foods prepared at a home or restaurant for which portion size and ingredients are not standardized. Mobile phone applications are limited by whether a person consistently uses them for every meal or snack and by how accurate the person is in identifying the portion sizes and ingredients of non-standard foods consumed.

Non-worn imaging devices and image analysis systems are limited by whether a person consistently uses them for every meal or snack, problems in identifying food obscured from view (such as in a cup or bowl), and foods that look similar but have different nutritional compositions. Also, such devices and methods can be time-consuming, easy to circumvent, and embarrassing to use in social dining situations. Further, even if a person does consistently take pictures of every meal or snack that they eat, they may be tempted to postpone food identification for hours or days after a meal has occurred. This can cause inaccuracy. How many chips were left in that bag in the picture? Is that a “before” or “after” picture of that half-gallon of ice cream?

Non-worn food-imaging devices that use bar codes or other packaging information to identify foods are limited because not all foods that people eat have such codes and because people may not eat all food that they purchase or otherwise scan into a system. Some of the food in a given package may be thrown out. Interactive food logging and meal planning websites can be helpful, but they depend heavily on information entry compliance and food consumption recall, which can be problematic.

Smart cards and other systems that are based on financial transitions that track food purchases are limited because people purchase food that they do not eat (e.g. for their family) and eat food that they do not purchase (e.g. at home or as a guest). Also, depending on the longevity of food storage, some food may be eaten soon after purchase and some may be eaten long afterwards. Computerized food scales and food-weighing dishes and utensils are limited because they rely on a person using them consistently for all eating events and because some types of food consumption are not conducive to the use of a dish or utensil. Also, such devices and methods can be time-consuming, easy to circumvent, and embarrassing to use in social dining situations.

Utensils and accessories that are designed to track or modify eating speed can be useful, but depend on consistent use of the device and do not shed light on what types of food the person is eating. Smart food utensils or accessories that measure food weight or analyze food content are limited by the consistency of a person's use of the device. Smart food containers that track their contents and/or limit access times depend on the person's exclusive use of such containers for all food that they eat, which can be problematic.

Specific examples of potentially-relevant prior art which appear to be most appropriately classified into this category include the following U.S. patents: U.S. Pat. No. 4,207,673 (DiGirolamo et al., Jun. 17, 1980, “Cuttlery”); U.S. Pat. No. 4,212,079 (Segar et al., Jul. 8, 1980, “Electronic Calorie Counter”); U.S. Pat. No. 4,218,611 (Cannon, Aug. 19, 1980, “Method and Apparatus for Controlling Eating Behavior”); U.S. Pat. No. 4,321,674 (Krames et al., Mar. 23, 1982, “Nutritional Value Accumulating and Display Device”); U.S. Pat. No. 4,650,218 (Hawke, Mar. 17, 1987, “Method and Apparatus for Controlling Caloric Intake”); U.S. Pat. No. 4,686,624 (Blum et al., Aug. 11, 1987, “Portable Apparatus for Acquiring and Processing Data Relative to the Dietetics and/or the Health of a Person”); U.S. Pat. No. 4,796,182 (Duboff, Jan. 3, 1989, “Diet Monitor and Display Device”); U.S. Pat. No. 4,875,533 (Mihara et al., Oct. 24, 1989, “Automatic Weight Detecting Device”); U.S. Pat. No. 4,891,756 (Williams, Jan. 2, 1990, “Nutritional Microcomputer and Method”); U.S. Pat. No. 4,911,256 (Attikiouzel, Mar. 27, 1990, “Dietetic Measurement Apparatus”); U.S. Pat. No. 4,914,819 (Ash, Apr. 10, 1990, “Eating Utensil for Indicating When Food May be Eaten Therewith and a Method for Using the Utensil”); U.S. Pat. No. 4,951,197 (Mellinger, Aug. 21, 1990, “Weight Loss Management System”); U.S. Pat. No. 4,975,682 (Kerr et al., Dec. 4, 1990, “Meal Minder Device”); U.S. Pat. No. 5,033,561 (Hettinger, Jul. 23, 1991, “Diet Control Device”); U.S. Pat. No. 5,173,588 (Harrah, Dec. 22, 1992, “Food Consumption Monitor”); U.S. Pat. No. 5,233,520 (Kretsch et al., Aug. 3, 1993, “Method and System for Measurement of Intake of Foods, Nutrients and Other Food Components in the Diet”); U.S. Pat. No. 5,299,356 (Maxwell, Apr. 5, 1994, “Diet Eating Utensil”); U.S. Pat. No. 5,388,043 (Hettinger, Feb. 7, 1995, “Diet and Behavioral Control Device”); U.S. Pat. No. 5,412,564 (Ecer, May 2, 1995, “System and Method for Diet Control”); U.S. Pat. No. 5,421,089 (Dubus et al., Jun. 6, 1995, “Fork with Timer”); U.S. Pat. No. 5,478,989 (Shepley, Dec. 26, 1995, “Nutritional Information System for Shoppers”); and U.S. Pat. No. 5,542,420 (Goldman et al., Aug. 6, 1996, “Personalized Method and System for Storage, Communication, Analysis, and Processing of Health-Related Data”).

Additional U.S. patents which appear to be most appropriately classified into this category include: U.S. Pat. No. 5,673,691 (Abrams et al., Oct. 7, 1997, “Apparatus to Control Diet and Weight Using Human Behavior Modification Techniques”); U.S. Pat. No. 5,691,927 (Gump, Nov. 25, 1997, “Nutritional Aid and Method”); U.S. Pat. No. 5,704,350 (Williams, Jan. 6, 1998, “Nutritional Microcomputer and Method”); U.S. Pat. No. 5,729,479 (Golan, Mar. 17, 1998, “Multifunctional Diet Calculator”); U.S. Pat. No. 5,817,006 (Bergh et al., Oct. 6, 1998, “Method and Apparatus for Measurement of Eating Speed”); U.S. Pat. No. 5,819,735 (Mansfield et al., Oct. 13, 1998, “Device and Method for Monitoring Dietary Intake of Calories and Nutrients”); U.S. Pat. No. 5,836,312 (Moore, Nov. 17, 1998, “Computer-Assisted System and Method for Adjudging the Effect of Consumable Intakes on Physiological Parameters”); U.S. Pat. No. 5,839,901 (Karkanen, Nov. 24, 1998, “Integrated Weight Loss Control Method”); U.S. Pat. No. 5,841,115 (Shepley, Nov. 24, 1998, “Nutritional Information System for Shoppers”); U.S. Pat. No. 5,890,128 (Diaz et al., Mar. 30, 1999, “Personalized Hand Held Calorie Computer (ECC)”); U.S. Pat. No. 5,989,188 (Birkhoelzer, Nov. 23, 1999, “Method and Apparatus for Determining the Energy Balance of a Living Subject on the Basis of Energy Used and Nutrition Intake”); U.S. Pat. No. 6,024,281 (Shepley, Feb. 15, 2000, “Nutritional Information System for Shoppers”); U.S. Pat. No. 6,032,676 (Moore, Mar. 7, 2000, “Method for Correlating Consumable Intakes with Physiological Parameters”); U.S. Pat. No. 6,040,531 (Miller-Kovach, Mar. 21, 2000, “Process For Controlling Body Weight”); U.S. Pat. No. 6,083,006 (Coffman, Jul. 4, 2000, “Personalized Nutrition Planning”); U.S. Pat. No. 6,283,914 (Mansfield et al., Sep. 4, 2001, “Device and Method for Monitoring Dietary Intake of Calories and Nutrients”); U.S. Pat. No. 6,290,646 (Cosentino et al., Sep. 18, 2001, “Apparatus and Method for Monitoring and Communicating Wellness Parameters of Ambulatory Patients”); and U.S. Pat. No. 6,336,136 (Harris, Jan. 1, 2002, “Internet Weight Reduction System”).

Further U.S. patents in this category include: U.S. Pat. No. 6,341,295 (Stotler, Jan. 22, 2002, “Virtual Reality Integrated Caloric Tabulator”); U.S. Pat. No. 6,454,705 (Cosentino et al., Sep. 24, 2002, “Medical Wellness Parameters Management System, Apparatus and Method”); U.S. Pat. No. 6,478,736 (Mault, Nov. 12, 2002, “Integrated Calorie Management System”); U.S. Pat. No. 6,553,386 (Alabaster, Apr. 22, 2003, “System and Method for Computerized Visual Diet Behavior Analysis and Training”); U.S. Pat. No. 6,694,182 (Yamazaki et al., Feb. 17, 2004, “Wearable Calorie Calculator”); U.S. Pat. No. 6,723,045 (Cosentino et al., Apr. 20, 2004, “Apparatus and Method for Monitoring and Communicating Wellness Parameters of Ambulatory Patients”); U.S. Pat. No. 6,745,214 (Inoue et al., Jun. 1, 2004, “Calorie Control Apparatus with Voice Recognition”); U.S. Pat. No. 6,755,783 (Cosentino et al., Jun. 29, 2004, “Apparatus and Method for Two-Way Communication in a Device for Monitoring and Communicating Wellness Parameters of Ambulatory Patients”); U.S. Pat. No. 6,856,938 (Kurtz, Feb. 15, 2005, “Weight Monitoring Computer”); U.S. Pat. No. 6,878,885 (Miller-Kovach, Apr. 12, 2005, “Process for Controlling Body Weight”); U.S. Pat. No. 6,917,897 (Mork, Jul. 12, 2005, “Food and Exercise Calculator”); U.S. Pat. No. 6,978,221 (Rudy, Dec. 20, 2005, “Computerized Dietetic Scale”); U.S. Pat. No. 7,044,739 (Matson, May 16, 2006, “System for Controlled Nutrition Consumption”); U.S. Pat. No. 7,096,221 (Nakano, Aug. 22, 2006, “Food Information Management System”); U.S. Pat. No. 7,454,002 (Gardner et al., Nov. 18, 2008, “Integrating Personal Data Capturing Functionality into a Portable Computing Device and a Wireless Communication Device”); U.S. Pat. No. 7,500,937 (Hercules, Mar. 10, 2009, “Diet Compliance System”); U.S. Pat. No. 7,550,683 (Daughtry, Jun. 23, 2009, “Portable Digital Plate Scale”); and U.S. Pat. No. 7,577,475 (Cosentino et al., Aug. 18, 2009, “System, Method, and Apparatus for Combining Information from an Implanted Device with Information from a Patient Monitoring Apparatus”).

Further U.S. patents in this category include: U.S. Pat. No. 7,736,318 (Cosentino et al., Jun. 15, 2010, “Apparatus and Method for Monitoring and Communicating Wellness Parameters of Ambulatory Patients”); U.S. Pat. No. 7,769,635 (Simons-Nikolova, Aug. 3, 2010, “Weight Management System with Simple Data Input”); U.S. Pat. No. 7,857,730 (Dugan, Dec. 28, 2010, “Methods and Apparatus for Monitoring and Encouraging Health and Fitness”); U.S. Pat. No. 7,899,709 (Allard et al., Mar. 1, 2011, “System and Method for Identification and Tracking of Food Items”); U.S. Pat. No. 7,949,506 (Hill et al., May 24, 2011, “Method for Determining and Compensating for a Weight Loss Energy Gap”); U.S. Pat. No. 7,956,997 (Wang et al., Jun. 7, 2011, “Systems and Methods for Food Safety Detection”); U.S. Pat. No. 7,999,674 (Kamen, Aug. 16, 2011, “Device and Method for Food Management”); U.S. Pat. No. 8,075,451 (Dugan, Dec. 13, 2011, “Methods and Apparatus for Monitoring and Encouraging Health and Fitness”); U.S. Pat. No. 8,087,937 (Peplinski et al., Jan. 3, 2012, “System and Method for Monitoring Weight and Nutrition”); U.S. Pat. No. 8,229,676 (Hyde et al., Jul. 24, 2012, “Food Content Detector”); U.S. Pat. No. 8,285,488 (Hyde et al., Oct. 9, 2012, “Food Content Detector”); U.S. Pat. No. 8,290,712 (Hyde et al., Oct. 16, 2012, “Food Content Detector”); U.S. Pat. No. 8,294,581 (Kamen, Oct. 23, 2012, “Device and Method for Food Management”); U.S. Pat. No. 8,299,930 (Schmid-Schonbein et al., Oct. 30, 2012, “Devices, Systems and Methods to Control Caloric Intake”); U.S. Pat. No. 8,321,141 (Hyde et al., Nov. 27, 2012, “Food Content Detector”); U.S. Pat. No. 8,330,057 (Sharawi et al., Dec. 11, 2012, “System and Method for Weighing Food and Calculating Calorie Content Thereof”); U.S. Pat. No. 8,337,367 (Dugan, Dec. 25, 2013, “Methods and Apparatus for Monitoring and Encouraging Health and Fitness”); U.S. Pat. No. 8,345,930 (Tamrakar et al., Jan. 1, 2013, “Method for Computing Food Volume in a Method for Analyzing Food”); U.S. Pat. No. 8,355,875 (Hyde et al., Jan. 15, 2013, “Food Content Detector”); U.S. Pat. No. 8,363,913 (Boushey et al., Jan. 29, 2013, “Dietary Assessment System and Method”); U.S. Pat. No. 8,386,185 (Hyde et al., May 20, 2010, “Food Content Detector”); U.S. Pat. No. 8,392,123 (Hyde et al., May 20, 2010, “Food Content Detector”); U.S. Pat. No. 8,392,124 (Hyde et al., May 20, 2010, “Food Content Detector”); U.S. Pat. No. 8,392,125 (Hyde et al., Mar. 5, 2013, “Food Content Detector”); U.S. Pat. No. 8,396,672 (Hyde et al., Mar. 12, 2013, “Food Content Detector”); and U.S. Pat. No. 8,438,038 (Cosentino et al., May 7, 2013, “Weight Loss or Weight Management System”).

Specific examples of potentially-relevant prior art which appear to be most appropriately classified into this category also include the following U.S. patent applications: 20020062069 (Mault, May, 23, 2002, “System and Method of Integrated Calorie Management Using Interactive Television”); 20020124017 (Mault, Sep. 5, 2002, “Personal Digital Assistant with Food Scale Accessory”); 20020167863 (Davis et al., Nov. 14, 2002, “Portable, Compact Device to Monitor Rate and Quantity of Dietary Intake to Control Body Weight”); 20030076983 (Cox, Apr. 24, 2003, “Personal Food Analyzer”); 20030152607 (Mault, Aug. 14, 2003, “Caloric Management System and Method with Voice Recognition”); 20030163354 (Shamoun, Aug. 28, 2003, “Device for Collecting and Analyzing Nutritional Data and Method Therefor”); 20030165799 (Bisogno, Sep. 4, 2003, “Computer Program, Method, and System for Monitoring Nutrition Content of Consumables and for Facilitating Menu Planning”); 20030219513 (Gordon, Nov. 27, 2003, “Personal Nutrition Control Method”); 20050008994 (Bisogno, Jan. 13, 2005, “Computer Program, Method, and System for Monitoring Nutrition Content of Consumables and for Facilitating Menu Planning”); 20050011367 (Crow, Jan. 20, 2005, “Portion Control Serving Utensils”); 20050014111 (Matson, Jan. 20, 2005, “System for Controlled Nutrition Consumption”); 20050153052 (Williams et al., Jul. 14, 2005, “Food and Beverage Quality Sensor”); 20050184148 (Perlman, Aug. 25, 2005, “Scale Having Nutritional Information Readouts”); 20050247213 (Slilaty, Nov. 10, 2005, “Method of Identifying Particular Attributes of Food Products Consistent with Consumer Needs and/or Desires”); and 20050266385 (Bisogno, Dec. 1, 2005, “Computer Program, Method, and System for Monitoring Nutrition Content of Consumables and for Facilitating Menu Planning”).

Additional U.S. patent applications which appear to be most appropriately classified into this category include: 20060036395 (Shaya et al., Feb. 16, 2006, “Method and Apparatus for Measuring and Controlling Food Intake of an Individual”); 20060074716 (Tilles et al., Apr. 6, 2006, “System and Method for Providing Customized Interactive and Flexible Nutritional Counseling”); 20060189853 (Brown, Aug. 24, 2006, “Method and System for Improving Adherence with a Diet Program or Other Medical Regimen”); 20060229504 (Johnson, Oct. 12, 2006, “Methods and Systems for Lifestyle Management”); 20060263750 (Gordon, Nov. 23, 2006, “Personal Nutrition Control Devices”); 20070021979 (Cosentino et al., Jan. 25, 2007, “Multiuser Wellness Parameter Monitoring System”); 20070027366 (Osburn, Feb. 1, 2007, “Device and System for Entering and Monitoring Dietary Data”); 20070028453 (Crow, Feb. 8, 2007, “Portion Control Serving Utensils”); 20070030339 (Findlay et al., Feb. 8, 2007, “Method, System and Software for Monitoring Compliance”); 20070050058 (Zuziak et al., Mar. 1, 2007, “Placemat for Calculating and Monitoring Calorie Intake”); 20070059672 (Shaw, Mar. 15, 2007, “Nutrition Tracking Systems and Methods”); 20070089335 (Smith et al., Apr. 26, 2007, “Nutrient Consumption/Expenditure Planning and Tracking Apparatus System and Method”); 20070098856 (LePine, May 3, 2007, “Mealtime Eating Regulation Device”); 20070173703 (Lee et al., Jul. 26, 2007, “Method, Apparatus, and Medium for Managing Weight by Using Calorie Consumption Information”); 20070179355 (Rosen, Aug. 2, 2007, “Mobile Self-Management Compliance and Notification Method, System and Computer Program Product”); 20070208593 (Hercules, Sep. 6, 2007, “Diet Compliance System”); 20080019122 (Kramer, Jan. 24, 2008, “Foodware System Having Sensory Stimulating, Sensing and/or Data Processing Components”); 20080060853 (Davidson et al., Mar. 13, 2008, “Scales Displaying Nutritional Information”); and 20080255955 (Simons-Nikolova, Oct. 16, 2008, “Weight Management System with Simple Data Input”).

Further U.S. patent applications in this category include: 20080267444 (Simons-Nikolova, Oct. 30, 2008, “Modifying a Person's Eating and Activity Habits”); 20080270324 (Allard et al., Oct. 30, 2008, “System and Method for Identification and Tracking of Food Items”); 20080276461 (Gold, Nov. 13, 2008, “Eating Utensil Capable of Automatic Bite Counting”); 20090112800 (Athsani, Apr. 30, 2009, “System and Method for Visual Contextual Search”); 20090176526 (Altman, Jul. 9, 2009, “Longitudinal Personal Health Management System Using Mobile Data Capture”); 20090191514 (Barnow, Jul. 30, 2009, “Calorie Counter”); 20090219159 (Morgenstern, Sep. 3, 2009, “Method and System for an Electronic Personal Trainer”); 20090253105 (Lepine, Oct. 8, 2009, “Device for Regulating Eating by Measuring Potential”); 20100003647 (Brown et al., Jan. 7, 2010, “System and Method for Automated Meal Recommendations”); 20100057564 (Godsey et al., Mar. 4, 2010, “System and Method for Fitness Motivation”); 20100062119 (Miller-Kovach, Mar. 11, 2010, “Processes and Systems for Achieving and Assisting in Improved Nutrition”); 20100062402 (Miller-Kovach, Mar. 11, 2010, “Processes and Systems Using and Producing Food Healthfulness Data Based on Linear Combinations of Nutrients”); 20100080875 (Miller-Kovach, Apr. 1, 2010, “Processes and Systems for Achieving and Assisting in Improved Nutrition Based on Food Energy Data and Relative Healthfulness Data”); 20100109876 (Schmid-Schonbein et al., May 6, 2010, “Devices, Systems and Methods to Control Caloric Intake”); 20100111383 (Boushey et al., May 6, 2010, “Dietary Assessment System and Method”); 20100125176 (Hyde et al., May 20, 2010, “Food Content Detector”); and 20100125177 (Hyde et al., May 20, 2010, “Food Content Detector”).

Further U.S. patent applications in this category include: 20100125178 (Hyde et al., May 20, 2010, “Food Content Detector”); 20100125179 (Hyde et al., May 20, 2010, “Food Content Detector”); 20100125180 (Hyde et al., May 20, 2010, “Food Content Detector”); 20100125181 (Hyde et al., May 20, 2010, “Food Content Detector”); 20100125417 (Hyde et al., May 20, 2010, “Food Content Detector”); 20100125418 (Hyde et al., May 20, 2010, “Food Content Detector”); 20100125419 (Hyde et al., May 20, 2010, “Food Content Detector”); 20100125420 (Hyde et al., May 20, 2010, “Food Content Detector”); 20100173269 (Puri et al., Jul. 8, 2010, “Food Recognition Using Visual Analysis and Speech Recognition”); 20100191155 (Kim et al., Jul. 29, 2010, “Apparatus for Calculating Calories Balance by Classifying User's Activity”); 20100205209 (Jokinen, Aug. 12, 2010, “Method and System for Monitoring a Personal Intake”); 20100332571 (Healey et al., Dec. 30, 2010, “Device Augmented Food Identification”); 20110124978 (Williams, May 26, 2011, “Health and Fitness System”); 20110182477 (Tamrakar et al., Jul. 28, 2011, “Method for Computing Food Volume in a Method for Analyzing Food”); 20110184247 (Contant et al., Jul. 28, 2011, “Comprehensive Management of Human Health”); 20110281245 (Mansour, Nov. 17, 2011, “System for Regulating Caloric Intake and Method for Using Same”); 20110318717 (Adamowicz, Dec. 29, 2011, “Personalized Food Identification and Nutrition Guidance System”); 20120031805 (Stolarczyk, Feb. 9, 2012, “Daily Meal Planning System”); 20120055718 (Chen, Mar. 8, 2012, “Electronic Scale for Recording Health Administration Data”); and 20120072233 (Hanlon et al., Mar. 22, 2012, “Medical Health Information System for Health Assessment, Weight Management and Meal Planning”).

Further U.S. patent applications in this category include: 20120077154 (Highet et al., Mar. 29, 2012, “Incrementally-Sized Standard-Sized Eating-Ware System for Weight Management”); 20120083669 (Abujbara, Apr. 5, 2012, “Personal Nutrition and Wellness Advisor”); 20120096405 (Seo, Apr. 19, 2012, “Apparatus and Method for Diet Management”); 20120115111 (Lepine, May 10, 2012, “Mealtime Eating Regulation Device”); 20120126983 (Breibart, May 24, 2012, “Method and Associated Device for Personal Weight Control or Weight Loss”); 20120144912 (Kates et al., Jun. 14, 2012, “Portion Control System for Weight Loss and Maintenance”); 20120170801 (De Oliveira et al., Jul. 5, 2012, “System for Food Recognition Method Using Portable Devices Having Digital Cameras”); 20120178065 (Naghavi et al., Jul. 12, 2012, “Advanced Button Application for Individual Self-Activating and Monitored Control System in Weight Loss Program”); 20120179665 (Baarman et al., Jul. 12, 2012, “Health Monitoring System”); 20120221495 (Landers, Aug. 30, 2012, “Digital Weight Loss Aid”); 20120295233 (Cooperman, Nov. 22, 2012, “Computerized System and Method for Monitoring Food Consumption”); 20120315609 (Miller-Kovach et al., Dec. 13, 2012, “Methods and Systems for Weight Control by Utilizing Visual Tracking of Living Factor(s)”); 20120321759 (Marinkovich et al., Dec. 20, 2012, “Characterization of Food Materials by Optomagnetic Fingerprinting”); 20130006063 (Wang, Jan. 3, 2013, “Physiological Condition, Diet and Exercise Plan Recommendation and Management System”); 20130006802 (Dillahunt et al., Jan. 3, 2013, “Generating a Location-Aware Preference and Restriction-Based Customized Menu”); and 20130006807 (Bai et al., Jan. 3, 2013, “Guideline-Based Food Purchase Management”).

Further U.S. patent applications in this category include: 20130012788 (Horseman, Jan. 10, 2013, “Systems, Computer Medium and Computer-Implemented Methods for Monitoring and Improving Biometric Health of Employees”); 20130012789 (Horseman, Jan. 10, 2013, “Systems, Computer Medium and Computer-Implemented Methods for Monitoring and Improving Biomechanical Health of Employees”); 20130012790 (Horseman, Jan. 10, 2013, “Systems, Computer Medium and Computer-Implemented Methods for Monitoring and Improving Health and Productivity of Employees”); 20130012802 (Horseman, Jan. 10, 2013, “Systems, Computer Medium and Computer-Implemented Methods for Monitoring and Improving Cognitive and Emotive Health of Employees”); 20130013331 (Horseman, Jan. 10, 2013, “Systems, Computer Medium and Computer-Implemented Methods for Monitoring Health of Employees Using Mobile Devices”); 20130043997 (Cosentino et al., Feb. 21, 2013, “Weight Loss Or Weight Management System”); 20130043997 (Cosentino et al., Feb. 21, 2013, “Weight Loss or Weight Management System”); 20130045467 (Kamen, Feb. 21, 2013, “Device and Method for Food Management”); 20130090565 (Quy, Apr. 11, 2013, “Method and Apparatus for Monitoring Exercise with Wireless Internet Connectivity”); 20130091454 (Papa et al., Apr. 11, 2013, “Physical Health Application and Method for Implementation”); 20130105565 (Kamprath, May 2, 2013, “Nutritional Information System”); 20130108993 (Katz; David L. May 2, 2013, “Method and System for Scoring a Diet”); and 20130113933 (Boushey et al., May 9, 2013, “Dietary Assessment System and Method”). Prior art which appears to be most appropriately classified into this category also includes WO 1997028738 (Zuabe, Aug. 14, 1997, “Portable Apparatus for Monitoring Food Intake”).

### (2) Wearable Devices Primarily to Monitor and Measure Caloric Expenditure Activities

Although the main focus of this invention is on the monitoring and measurement of food consumption, there are reasons why I have also included this category for wearable fitness devices which primarily or exclusively monitor and measure caloric expenditure activities. First, there has been more progress in the prior art toward automatic monitoring and measuring of caloric expenditure activities than there has been toward automatic monitoring and measuring of caloric intake. There can be lessons learned and cross-over technology between the two sides of the energy balance equation. Second, there will probably be increasing convergence of caloric expenditure and intake measurement into combined energy balance devices. For example, especially for wearable fitness devices that include an accelerometer, it may be possible to use this accelerometer to also monitor for possible eating events (especially if the device is worn on a body member that moves when a person is eating).

Most devices and methods in this category include a wearable accelerometer which is used to analyze a person's movements and/or estimate their caloric expenditure. Some of the more-sophisticated devices also include wearable sensors that measure heart rate, blood pressure, temperature, electromagnetic signals from the body, and/or other physiologic parameters. Some fitness monitors also supplement an accelerometer with an altimeter and GPS functionality.

Most devices and methods in this category measure motion from one location on a person's body, unlike the full-body “motion capture” technology that is used for animation in motion pictures. There is movement toward the use of full-body motion recognition in gaming systems for measuring caloric expenditure, but this is not currently wearable and portable technology. Most wearable and portable technology is still based on measurement of body movement from one location on a person's body. Accordingly, some types of calorie burning activities are more accurately measured than others. For example, although fidgeting burns calories, an accelerometer attached to a person's torso, on their neck, or in their pocket will not measure this type of calorie-burning activity very well.

Although devices and methods in this category can be an important part of monitoring and measuring energy balance, they currently provide very little (if any) monitoring or measurement of a person's food consumption. I did my best to thoroughly review the 500+ examples of prior art and to place into this category those examples which appear to focus primarily on measuring caloric expenditure activities with little (or no) mention of food, nutrition, eating, or caloric intake. However, if I missed a reference to measuring food consumption or caloric intake in the details of one of these examples, then that example could be better classified into either category 4 or 5 which follow. By definition, prior art in this category is very limited in terms of monitoring or measuring food consumption.

Specific examples of potentially-relevant prior art which appear to be most appropriately classified into this category include the following U.S. patents: U.S. Pat. No. 4,757,453 (Nasiff, Jul. 12, 1988, “Body Activity Monitor Using Piezoelectric Transducers on Arms and Legs”); U.S. Pat. No. 5,038,792 (Mault, Aug. 13, 1991, “Oxygen Consumption Meter”); U.S. Pat. No. 6,135,951 (Richardson et al., Oct. 24, 2000, “Portable Aerobic Fitness Monitor for Walking and Running”); U.S. Pat. No. 6,498,994 (Vock et al., Dec. 24, 2002, “Systems and Methods for Determining Energy Experienced by a User and Associated With Activity”); U.S. Pat. No. 6,527,711 (Stivoric et al., Mar. 4, 2003, “Wearable Human Physiological Data Sensors and Reporting System Therefor”); U.S. Pat. No. 6,856,934 (Vock et al., Feb. 15, 2005, “Sport Monitoring Systems and Associated Methods”); U.S. Pat. No. 7,054,784 (Flentov et al., May 30, 2006, “Sport Monitoring Systems”); U.S. Pat. No. 7,057,551 (Vogt, Jun. 6, 2006, “Electronic Exercise Monitor and Method Using a Location Determining Component and a Pedometer”); U.S. Pat. No. 7,153,262 (Stivoric et al., Dec. 26, 2006, “Wearable Human Physiological Data Sensors and Reporting System Therefor”); U.S. Pat. No. 7,255,437 (Howell et al., Aug. 14, 2007, “Eyeglasses with Activity Monitoring”); U.S. Pat. No. 7,373,820 (James, May 20, 2008, “Accelerometer for Data Collection and Communication”); U.S. Pat. No. 7,398,151 (Burrell et al., Jul. 8, 2008, “Wearable Electronic Device”); U.S. Pat. No. 7,401,918 (Howell et al., Jul. 22, 2008, “Eyeglasses with Activity Monitoring”); U.S. Pat. No. 7,438,410 (Howell et al., Oct. 21, 2008, “Tethered Electrical Components for Eyeglasses”); U.S. Pat. No. 7,451,056 (Flentov et al., Nov. 11, 2008, “Activity Monitoring Systems and Methods”); U.S. Pat. No. 7,481,531 (Howell et al., Jan. 27, 2009, “Eyeglasses with User Monitoring”); U.S. Pat. No. 7,512,515 (Vock et al., Mar. 31, 2009, “Activity Monitoring Systems and Methods”); U.S. Pat. No. 7,640,804 (Daumer et al., Jan. 5, 2010, “Apparatus for Measuring Activity”); and U.S. Pat. No. 7,717,866 (Damen, May 18, 2010, “Portable Device Comprising an Acceleration Sensor and Method of Generating Instructions or Advice”).

Additional U.S. patents which appear to be most appropriately classified into this category include: U.S. Pat. No. 7,805,196 (Miesel et al., Sep. 28, 2010, “Collecting Activity Information to Evaluate Therapy”); U.S. Pat. No. 7,841,966 (Aaron et al., Nov. 30, 2010, “Methods, Systems, and Products for Monitoring Athletic Performance”); U.S. Pat. No. 7,980,997 (Thukral et al., Jul. 19, 2011, “System for Encouraging a User to Perform Substantial Physical Activity”); U.S. Pat. No. 8,021,297 (Aerts, Sep. 20, 2011, “Wearable Device”); U.S. Pat. No. 8,033,959 (Oleson et al., Oct. 11, 2011, “Portable Fitness Monitoring Systems, and Applications Thereof”); U.S. Pat. No. 8,068,858 (Werner et al., Nov. 29, 2011, “Methods and Computer Program Products for Providing Information about a User During a Physical Activity”); U.S. Pat. No. 8,162,804 (Tagliabue, Apr. 24, 2012, “Collection and Display of Athletic Information”); U.S. Pat. No. 8,184,070 (Taubman, May 22, 2012, “Method and System for Selecting a User Interface for a Wearable Computing Device”); U.S. Pat. No. 8,244,278 (Werner et al., Aug. 14, 2012, “Portable Fitness Systems, and Applications Thereof”); U.S. Pat. No. 8,265,907 (Nanikashvili et al., Sep. 11, 2012, “System and a Method for Physiological Monitoring”); U.S. Pat. No. 8,352,211 (Vock et al., Jan. 8, 2013, “Activity Monitoring Systems and Methods”); U.S. Pat. No. 8,370,549 (Burton et al., Feb. 5, 2013, “Wearable Device Assembly Having Athletic Functionality”); U.S. Pat. No. 8,378,811 (Crump et al., Feb. 19, 2013, “Mobile Wireless Customizable Health and Condition Monitor”); U.S. Pat. No. 8,403,845 (Stivoric et al., Mar. 26, 2013, “Wearable Human Physiological and Environmental Data Sensors and Reporting System Therefor”); U.S. Pat. No. 8,408,436 (Berry et al., Apr. 2, 2013, “Wearable Device Assembly Having Athletic Functionality”); U.S. Pat. No. 8,416,102 (Yin Apr. 9, 2013, “Activity Monitoring System Insensitive to Accelerations Induced by External Motion Factors”); and U.S. Pat. No. 8,421,620 (Boyd et al., Apr. 16, 2013, “Electronically Triggered Personal Athletic Device”).

Specific examples of potentially-relevant prior art which appear to be most appropriately classified into this category also include the following U.S. patent applications: 20110288379 (Wu, Nov. 24, 2011, “Body Sign Dynamically Monitoring System”); 20120004883 (Vock et al., Jan. 5, 2012, “Activity Monitoring Systems and Methods”); 20120150074 (Yanev et al., Jun. 14, 2012, “Physical Activity Monitoring System”); 20120150327 (Altman et al., Jun. 14, 2012, “System, Method, Apparatus, or Computer Program Product for Exercise and Personal Security”); 20120245716 (Srinivasan et al., Sep. 27, 2012, “Activity Monitoring Device and Method”); 20120251079 (Meschter et al., Oct. 4, 2012, “Systems and Methods for Time-Based Athletic Activity Measurement and Display”); 20120253485 (Weast et al., Oct. 4, 2012, “Wearable Device Having Athletic Functionality”); 20120258433 (Hope et al., Oct. 11, 2012, “Fitness Monitoring Methods, Systems, and Program Products, and Applications Thereof”); 20120268592 (Aragones et al., Oct. 25, 2012, “Processing Data of a User Performing an Athletic Activity to Estimate Energy Expenditure”); 20120274508 (Brown et al., Nov. 1, 2012, “Athletic Watch”); 20120274554 (Kinoshita et al., Nov. 1, 2012, “Body Movement Detection Device and Display Control Method of Body Movement Detection Device”); 20120283855 (Hoffman et al., Nov. 8, 2012, “Monitoring Fitness Using a Mobile Device”); 20120289867 (Kasama, Nov. 15, 2012, “State Determining Device and State Determination Method”); 20120290109 (Engelberg et al., Nov. 15, 2012, “Methods and Systems for Encouraging Athletic Activity”); 20120310971 (Tran, Dec. 6, 2012, “Fitness Device”); 20120316406 (Rahman et al., Dec. 13, 2012, “Wearable Device and Platform for Sensory Input”); 20120316455 (Rahman et al., Dec. 13, 2012, “Wearable Device and Platform for Sensory Input”); and 20120316456 (Rahman et al., Dec. 13, 2012, “Sensory User Interface”).

Additional U.S. patent applications which appear to be most appropriately classified into this category include: 20120316471 (Rahman et al., Dec. 13, 2012, “Power Management in a Data-Capable Strapband”); 20120316661 (Rahman et al., Dec. 13, 2012, “Media Device, Application, and Content Management Using Sensory Input”); 20120317430 (Rahman et al., Dec. 13, 2012, “Power Management in a Data-Capable Strapband”); 20120323346 (Ashby et al., Dec. 20, 2012, “Portable Physical Activity Sensing System”); 20120323496 (Burroughs et al., Dec. 20, 2012, “Tracking of User Performance Metrics During a Workout Session”); 20130005534 (Rosenbaum, Jan. 3, 2013, “Instrumented Article of Fitness and Method of Determining Caloric Requirements”); 20130006583 (Weast et al., Jan. 3, 2013, “Sensor-Based Athletic Activity Measurements”); 20130041617 (Pease et al., Feb. 14, 2013, “Systems and Methods for Monitoring Athletic Performance”); 20130052623 (Thukral et al., Feb. 28, 2013, “System for Encouraging a User to Perform Substantial Physical Activity”); 20130053990 (Ackland, Feb. 28, 2013, “Classification System and Method”); 20130073368 (Squires, Mar. 21, 2013, “Incentivizing Physical Activity”); 20130083009 (Geisner et al., Apr. 4, 2013, “Exercising Applications for Personal Audio/Visual System”); 20130102387 (Barsoum et al., Apr. 25, 2013, “Calculating Metabolic Equivalence with a Computing Device”); 20130103416 (Amigo et al., Apr. 25, 2013, “Systems and Methods for Activity Evaluation”); 20130106603 (Weast et al., May 2, 2013, “Wearable Device Assembly Having Athletic Functionality”); 20130106684 (Weast et al., May 2, 2013, “Wearable Device Assembly Having Athletic Functionality”); 20130110011 (McGregor et al., May 2, 2013, “Method of Monitoring Human Body Movement”); 20130110264 (Weast et al., May 2, 2013, “Wearable Device Having Athletic Functionality”); 20130115583 (Gordon et al., May 9, 2013, “User Interface for Remote Joint Workout Session”); and 20130115584 (Gordon et al., May 9, 2013, “User Interface and Fitness Meters for Remote Joint Workout Session”).

### (3) Wearable Devices Primarily to Monitor and Measure Food Consumption

Devices and methods in the previous category (category 2) focus primarily or exclusively on the caloric expenditure side of the energy balance equation. Devices and methods in this present category (category 3) focus primarily or exclusively on the caloric intake side of energy balance. Prior art in this present category includes wearable devices that are primarily for monitoring and measuring food consumption. In general, there has been less progress on the caloric intake side of the equation. Also, most devices that offer automatic monitoring and measurement of food consumption also offer at least some monitoring and measurement of caloric expenditure activities. Wearable devices that offer at least some measurement of both food consumption and caloric expenditure activities are classified in categories 4 or 5 which follow.

Examples of devices and methods in this category include: wearable accelerometers or other motion sensors that detect body motions associated with eating (e.g. particular patterns of hand movements or mouth movements); wearable heart rate, blood pressure, and/or electromagnetic body signal monitors that are used to detect eating events; wearable thermal energy sensors that are used to detect eating events; wearable glucose monitors that are used to detect eating events and provide some information about the nutritional composition of food consumed; wearable body fluid sampling devices such as continuous micro-sampling blood analysis devices; wearable sound sensors that detect body sounds or environmental sounds associated with eating events (e.g. chewing sounds, swallowing sounds, gastrointestinal organ sounds, and verbal food orders); and wearable cameras that continually take video images of the space surrounding the person wherein these video images are analyzed to detect eating events and identify foods consumed.

As mentioned previously, the prior art for devices and methods for wearable food consumption monitoring is generally less well-developed than the prior art for wearable caloric expenditure monitoring. Most of the prior art in this category offers some indication of eating events, but not very good identification of the specific amounts and types of food that a person eats. For example, a wrist-mounted accelerometer may be able to generally count the number of mouthfuls of food that a person consumes, but does not shed light on what type of food that person is eating. The same limitation is generally true for wearable heart rate, blood pressure, temperature, and electromagnetic monitors. Wearable continuous glucose monitors can provide more information than the preceding monitors, but still fall far short of creating a complete food consumption log for energy balance and nutritional purposes.

Wearable video imaging devices that continually record video images of the space surrounding a person have the potential to offer much more accurate detection of eating and identification of the types and amounts of food consumed. However, as we have discussed, such devices can also be highly-intrusive with respect to the privacy of the person being monitored and also everyone around them. This privacy concern can be a serious limitation for the use of a wearable video imaging device for monitoring and measuring food consumption. Since most developers of wearable video imaging devices appear to be developing such devices for many more applications than just monitoring food consumption, most such prior art is not categorized into this category.

Specific examples of potentially-relevant prior art which appear to be most appropriately classified into this category include the following U.S. patents: U.S. Pat. No. 4,100,401 (Tutt et al., Jul. 11, 1978, “Calorie Calculator-Chronometer”); U.S. Pat. No. 4,192,000 (Lipsey, Mar. 4, 1980, “Electronic Calorie Counter”); U.S. Pat. No. 4,509,531 (Ward, Apr. 9, 1985, “Personal Physiological Monitor”); U.S. Pat. No. 4,823,808 (Clegg et al., Apr. 25, 1989, “Method for Control of Obesity Overweight and Eating Disorders”); U.S. Pat. No. 4,965,553 (DelBiondo et al., Oct. 23, 1990, “Hand-Near-Mouth Warning Device”); U.S. Pat. No. 5,050,612 (Matsumura, Sep. 24, 1991, “Device for Computer-Assisted Monitoring of the Body”); U.S. Pat. No. 5,067,488 (Fukada et al., Nov. 26, 1991, “Mastication Detector and Measurement Apparatus and Method of Measuring Mastication”); U.S. Pat. No. 5,263,491 (Thornton, Nov. 23, 1993, “Ambulatory Metabolic Monitor”); U.S. Pat. No. 5,398,688 (Laniado, Mar. 21, 1995, “Method, System and Instrument for Monitoring Food Intake”); U.S. Pat. No. 5,424,719 (Ravid, Jun. 13, 1995, “Consumption Control”); U.S. Pat. No. 5,497,772 (Schulman et al., Mar. 12, 1996, “Glucose Monitoring System”); U.S. Pat. No. 5,563,850 (Hanapole, Oct. 8, 1996, “Food Intake Timer”); U.S. Pat. No. 6,135,950 (Adams, Oct. 24, 2000, “E-fit Monitor”); U.S. Pat. No. 6,249,697 (Asano, Jun. 19, 2001, “Electrogastrograph and Method for Analyzing Data Obtained by the Electrogastrograph”); U.S. Pat. No. 6,425,862 (Brown, Jul. 30, 2002, “Interactive Furniture for Dieters”); U.S. Pat. No. 6,508,762 (Karnieli, Jan. 21, 2003, “Method for Monitoring Food Intake”); and U.S. Pat. No. 6,893,406 (Takeuchi et al., May 17, 2005, “Mastication Monitoring Device”).

Additional U.S. patents which appear to be most appropriately classified into this category include: U.S. Pat. No. 7,855,936 (Czarnek et al., Dec. 21, 2010, “Diet Watch”); U.S. Pat. No. 7,878,975 (Liljeryd et al., Feb. 1, 2011, “Metabolic Monitoring, a Method and Apparatus for Indicating a Health-Related Condition of a Subject”); U.S. Pat. No. 8,112,281 (Yeung et al., Feb. 7, 2012, “Accelerometer-Based Control of Wearable Audio Recorders”); U.S. Pat. No. 8,158,082 (Imran, Apr. 17, 2012, “Micro-Fluidic Device”); U.S. Pat. No. 8,236,242 (Drucker et al., Aug. 7, 2012, “Blood Glucose Tracking Apparatus and Methods”); U.S. Pat. No. 8,275,438 (Simpson et al., Sep. 25, 2012, “Analyte Sensor”); U.S. Pat. No. 8,280,476 (Jina, Oct. 2, 2012, “Devices, Systems, Methods and Tools for Continuous Glucose Monitoring”); U.S. Pat. No. 8,287,453 (Li et al., Oct. 16, 2012, “Analyte Sensor”); U.S. Pat. No. 8,298,142 (Simpson et al., Oct. 30, 2012, “Analyte Sensor”); U.S. Pat. No. 8,310,368 (Hoover et al., Nov. 13, 2012, “Weight Control Device”); U.S. Pat. No. 8,369,919 (Kamath et al., Feb. 5, 2013, “Systems and Methods for Processing Sensor Data”); U.S. Pat. No. 8,417,312 (Kamath et al., Apr. 9, 2013, “Systems and Methods for Processing Sensor Data”); and U.S. Pat. No. 8,423,113 (Shariati et al., Apr. 16, 2013, “Systems and Methods for Processing Sensor Data”); U.S. Pat. No. 8,438,163 (Li et al., May 7, 2013, “Automatic Learning of Logos for Visual Recognition”).

Specific examples of potentially-relevant prior art which appear to be most appropriately classified into this category also include the following U.S. patent applications: 20020022774 (Karnieli, Feb. 21, 2002, “Method for Monitoring Food Intake”); 20040073142 (Takeuchi et al., Apr. 15, 2004, “Mastication Monitoring Device”); 20050283096 (Chau et al., Dec. 22, 2005, “Apparatus and Method for Detecting Swallowing Activity”); 20060197670 (Breibart, Sep. 7, 2006, “Method and Associated Device for Personal Weight Control”); 20080137486 (Czarenk et al., Jun. 12, 2008, “Diet Watch”); 20080262557 (Brown, Oct. 23, 2008, “Obesity Management System”); 20100194573 (Hoover et al., Aug. 5, 2010, “Weight Control Device”); 20100240962 (Contant, Sep. 23, 2010, “Eating Utensil to Monitor and Regulate Dietary Intake”); 20120078071 (Bohm et al., Mar. 29, 2012, “Advanced Continuous Analyte Monitoring System”); 20120149996 (Stivoric et al., Jun. 14, 2012, “Method and Apparatus for Providing Derived Glucose Information Utilizing Physiological and/or Contextual Parameters”); 20120149996 (Stivoric et al., Jun. 14, 2012, “Method and Apparatus for Providing Derived Glucose Information Utilizing Physiological and/or Contextual Parameters”); 20120191052 (Rao, Jul. 26, 2012, “Intelligent Activated Skin Patch System”); 20120194418 (Osterhout et al., Aug. 2, 2012, “AR Glasses with User Action Control and Event Input Based Control of Eyepiece Application”); 20120194419 (Osterhout et al., Aug. 2, 2012, “AR Glasses with Event and User Action Control of External Applications”); and 20120194420 (Osterhout et al., Aug. 2, 2012, “AR Glasses with Event Triggered User Action Control of AR Eyepiece Facility”).

Additional U.S. patent applications which appear to be most appropriately classified into this category include: 20120194549 (Osterhout et al., Aug. 2, 2012, “AR Glasses Specific User Interface Based on a Connected External Device Type”); 20120194550 (Osterhout et al., Aug. 2, 2012, “Sensor-Based Command and Control of External Devices with Feedback from the External Device to the AR Glasses”); 20120194551 (Osterhout et al., Aug. 2, 2012, “AR Glasses with User-Action Based Command and Control of External Devices”); 20120194552 (Osterhout et al., Aug. 2, 2012, “AR Glasses with Predictive Control of External Device Based on Event Input”); 20120194553 (Osterhout et al., Aug. 2, 2012, “AR Glasses with Sensor and User Action Based Control of External Devices with Feedback”); 20120200488 (Osterhout et al., Aug. 9, 2012, “AR Glasses with Sensor and User Action Based Control of Eyepiece Applications with Feedback”); 20120200499 (Osterhout et al., Aug. 9, 2012, “AR Glasses with Event, Sensor, and User Action Based Control of Applications Resident on External Devices with Feedback”); 20120200601 (Osterhout et al., Aug. 9, 2012, “AR Glasses with State Triggered Eye Control Interaction with Advertising Facility”); 20120201725 (Imran, Aug. 9, 2012, “Micro-Fluidic Device”); 20120203081 (Leboeuf et al., Aug. 9, 2012, “Physiological and Environmental Monitoring Apparatus and Systems”); 20120206322 (Osterhout et al., Aug. 16, 2012, “AR Glasses with Event and Sensor Input Triggered User Action Capture Device Control of AR Eyepiece Facility”); 20120206323 (Osterhout et al., Aug. 16, 2012, “AR Glasses with Event and Sensor Triggered AR Eyepiece Interface to External Devices”); and 20120206334 (Osterhout et al., Aug. 16, 2012, “AR Glasses with Event and User Action Capture Device Control of External Applications”).

Further U.S. patent applications in this category include: 20120206335 (Osterhout et al., Aug. 16, 2012, “AR Glasses with Event, Sensor, and User Action Based Direct Control of External Devices with Feedback”); 20120206485 (Osterhout et al., Aug. 16, 2012, “AR Glasses with Event and Sensor Triggered User Movement Control of AR Eyepiece Facilities”); 20120212398 (Border et al., Aug. 23, 2012, “See-Through Near-Eye Display Glasses Including a Partially Reflective, Partially Transmitting Optical Element”); 20120212399 (Border et al., Aug. 23, 2012, “See-Through Near-Eye Display Glasses Wherein Image Light Is Transmitted to and Reflected from an Optically Flat Film”); 20120212400 (Border et al., Aug. 23, 2012, “See-Through Near-Eye Display Glasses Including a Curved Polarizing Film in the Image Source, a Partially Reflective, Partially Transmitting Optical Element and an Optically Flat Film”); 20120212406 (Osterhout et al., Aug. 23, 2012, “AR Glasses with Event and Sensor Triggered AR Eyepiece Command and Control Facility of the AR Eyepiece”); 20120212414 (Osterhout et al., Aug. 23, 2012, “AR Glasses with Event and Sensor Triggered Control of AR Eyepiece Applications”); 20120218172 (Border et al., Aug. 30, 2012, “See-Through Near-Eye Display Glasses with a Small Scale Image Source”); 20120218301 (Miller, Aug. 30, 2012, “See-Through Display with an Optical Assembly Including a Wedge-Shaped Illumination System”); 20120235883 (Border et al., Sep. 20, 2012, “See-Through Near-Eye Display Glasses with a Light Transmissive Wedge Shaped Illumination System”); 20120235885 (Miller et al., Sep. 20, 2012, “Grating in a Light Transmissive Illumination System for See-Through Near-Eye Display Glasses”); and 20120235886 (Border et al., Sep. 20, 2012, “See-Through Near-Eye Display Glasses with a Small Scale Image Source”).

Further U.S. patent applications in this category include: 20120235887 (Border et al., Sep. 20, 2012, “See-Through Near-Eye Display Glasses Including a Partially Reflective, Partially Transmitting Optical Element and an Optically Flat Film”); 20120235900 (Border et al., Sep. 20, 2012, “See-Through Near-Eye Display Glasses with a Fast Response Photochromic Film System for Quick Transition from Dark to Clear”); 20120236030 (Border et al., Sep. 20, 2012, “See-Through Near-Eye Display Glasses Including a Modular Image Source”); 20120236031 (Haddick et al., Sep. 20, 2012, “System and Method for Delivering Content to a Group of See-Through Near Eye Display Eyepieces”); 20120242678 (Border et al., Sep. 27, 2012, “See-Through Near-Eye Display Glasses Including an Auto-Brightness Control for the Display Brightness Based on the Brightness in the Environment”); 20120242697 (Border et al., Sep. 27, 2012, “See-Through Near-Eye Display Glasses with the Optical Assembly Including Absorptive Polarizers or Anti-Reflective Coatings to Reduce Stray Light”); 20120242698 (Haddick et al., Sep. 27, 2012, “See-Through Near-Eye Display Glasses with a Multi-Segment Processor-Controlled Optical Layer”); 20120249797 (Haddick et al., Oct. 4, 2012, “Head-Worn Adaptive Display”); 20120302855 (Kamath et al., Nov. 29, 2012, “Systems and Methods for Processing Sensor Data”); 20130035563 (Angelides, Feb. 7, 2013, “Progressively Personalized Wireless-Based Interactive Diabetes Treatment”); 20130083003 (Perez et al., Apr. 4, 2013, “Personal Audio/Visual System”); 20130083064 (Geisner et al., Apr. 4, 2013, “Personal Audio/Visual Apparatus Providing Resource Management”); and 20130095459 (Tran, Apr. 18, 2013, “Health Monitoring System”). Prior art which appears to be most appropriately classified into this category also includes: U.S. patent application Ser. No. 13/523,739 (Connor, Jun. 14, 2012, “The Willpower Watch™: A Wearable Food Consumption Monitor”); U.S. patent application Ser. No. 13/616,238 (Connor, Sep. 14, 2012, “Interactive Voluntary and Involuntary Caloric Intake Monitor”); and WO 2003032629 (Grosvenor, Apr. 17, 2003, “Automatic Photography”).

### (4) Wearable Devices to Monitor Caloric Expenditure Activities and to Help Measure Food Consumption

Wearable devices and methods in this category provide at least some measurement of both caloric expenditure activities and food consumption, but their measurement of food consumption is much less automated and accurate than that of caloric expenditure activities. In some respects, devices and methods in this category are like those in the first category, with the addition of caloric expenditure monitoring.

Most of the devices and methods in this category include a wearable accelerometer (and possibly also other wearable sensors) for measuring caloric expenditure, but rely on non-automated logging of food consumption information through a human-to-computer interface. Most of the devices and methods in this category display information concerning food consumption as part of the energy balance equation, but do not automatically collect this food consumption information.

Wearable devices and methods in this category are a useful step toward developing wearable energy balance devices that can help people to monitor and manage their energy balance and weight. However, prior art in this category has limitations with respect to the accuracy of food consumption measurement. These limitations are generally the same as the limitations of devices and methods in the first category (non-wearable devices to help measure food consumption). Their accuracy depends critically on the consistency with which a person enters information into the device and the accuracy with which the person assesses the amounts and ingredients of non-standard foods consumed. Both of these factors can be problematic.

Specific examples of potentially-relevant prior art which appear to be most appropriately classified into this category include the following U.S. patents: U.S. Pat. No. 6,095,949 (Arai, Aug. 1, 2000, “Health Management Device”); U.S. Pat. No. 6,506,152 (Lackey et al., Jan. 14, 2003, “Caloric Energy Balance Monitor”); U.S. Pat. No. 6,571,200 (Mault, May 27, 2003, “Monitoring Caloric Expenditure Resulting from Body Activity”); U.S. Pat. No. 6,635,015 (Sagel, Oct. 21, 2003, “Body Weight Management System”); U.S. Pat. No. 6,675,041 (Dickinson, Jan. 6, 2004, “Electronic Apparatus and Method for Monitoring Net Calorie Intake”); U.S. Pat. No. 7,361,141 (Nissila et al., Apr. 22, 2008, “Method and Device for Weight Management of Humans”); U.S. Pat. No. 8,180,591 (Yuen et al., May 15, 2012, “Portable Monitoring Devices and Methods of Operating Same”); U.S. Pat. No. 8,180,592 (Yuen et al., May 15, 2012, “Portable Monitoring Devices and Methods of Operating Same”); U.S. Pat. No. 8,311,769 (Yuen et al., Nov. 13, 2012, “Portable Monitoring Devices and Methods of Operating Same”); U.S. Pat. No. 8,311,770 (Yuen et al., Nov. 13, 2012, “Portable Monitoring Devices and Methods of Operating Same”); U.S. Pat. No. 8,386,008 (Yuen et al., Feb. 26, 2013, “Activity Monitoring Systems and Methods of Operating Same”); U.S. Pat. No. 8,386,008 (Yuen et al., Feb. 26, 2013, “Portable Monitoring Devices and Methods of Operating Same”); and U.S. Pat. No. 8,437,980 (Yuen et al., May 7, 2013, “Portable Monitoring Devices and Methods of Operating Same”).

Specific examples of potentially-relevant prior art which appear to be most appropriately classified into this category also include the following U.S. patent applications: 20020109600 (Mault et al., Aug. 15, 2002, “Body Supported Activity and Condition Monitor”); 20020156351 (Sagel, Oct. 24, 2002, “Body Weight Management System”); 20050004436 (Nissila et al., Jan. 6, 2005, “Method and Device for Weight Management of Humans”); 20100079291 (Kroll et al., Apr. 1, 2010, “Personalized Activity Monitor and Weight Management System”); 20100228160 (Schweizer, Sep. 9, 2010, “Apparatus for Activity Monitoring”); 20110087137 (Hanoun, Apr. 14, 2011, “Mobile Fitness and Personal Caloric Management System”); 20120083705 (Yuen et al., Apr. 5, 2012, “Activity Monitoring Systems and Methods of Operating Same”); 20120083714 (Yuen et al., Apr. 5, 2012, “Activity Monitoring Systems and Methods of Operating Same”); 20120083715 (Yuen et al., Apr. 5, 2012, “Portable Monitoring Devices and Methods of Operating Same”); 20120083716 (Yuen et al., Apr. 5, 2012, “Portable Monitoring Devices and Methods of Operating Same”); 20120084053 (Yuen et al., Apr. 5, 2012, “Portable Monitoring Devices and Methods of Operating Same”); 20120084054 (Yuen et al., Apr. 5, 2012, “Portable Monitoring Devices and Methods of Operating Same”); and 20120226471 (Yuen et al., Sep. 6, 2012, “Portable Monitoring Devices and Methods of Operating Same”).

Additional U.S. patent applications which appear to be most appropriately classified into this category include: 20120226472 (Yuen et al., Sep. 6, 2012, “Portable Monitoring Devices and Methods of Operating Same”); 20120316458 (Rahman et al., Dec. 13, 2012, “Data-Capable Band for Medical Diagnosis, Monitoring, and Treatment”); 20120316896 (Rahman et al., Dec. 13, 2012, “Personal Advisor System Using Data-Capable Band”); 20120316932 (Rahman et al., Dec. 13, 2012, “Wellness Application for Data-Capable Band”); 20120316932 (Rahman et al., Dec. 13, 2012, “Wellness Application for Data-Capable Band”); 20120317167 (Rahman et al., Dec. 13, 2012, “Wellness Application for Data-Capable Band”); 20130006125 (Kroll et al., Jan. 3, 2013, “Personalized Activity Monitor and Weight Management System”); 20130029807 (Amsel, Jan. 31, 2013, “Health Tracking Program”); 20130073254 (Yuen et al., Mar. 21, 2013, “Portable Monitoring Devices and Methods of Operating Same”); 20130073255 (Yuen et al., Mar. 21, 2013, “Portable Monitoring Devices and Methods of Operating Same”); 20130080113 (Yuen et al., Mar. 28, 2013, “Portable Monitoring Devices and Methods of Operating Same”); and 20130096843 (Yuen et al., Apr. 18, 2013, “Portable Monitoring Devices and Methods of Operating Same”).

### (5) Wearable Devices to Monitor and Measure Both Caloric Expenditure Activities and Food Consumption

Wearable devices and methods in this category provide monitoring and measurement of both caloric expenditure activities and food consumption. Their monitoring and measurement of food consumption is generally not as automated or accurate as the monitoring and measurement of caloric expenditure activities, but devices in this category are a significant step toward integrated wearable energy balance devices. In some respects, devices and methods in this category are like those in the third category, with the addition of caloric expenditure monitoring.

Although wearable device and methods in this category are a significant step toward developing integrated energy balance devices which can be useful for energy balance, weight management, and proper nutrition, prior art in this category has not yet solved the dilemma of personal privacy vs. accuracy of food consumption measurement. Some prior art in this category offers relatively-low privacy intrusion, but has relatively-low accuracy of food consumption measurement. Other prior art in this category offers relatively-high accuracy for food consumption measurement, but comes with relatively-high privacy intrusion. The invention that we will disclose later will solve this problem by offering relatively-high accuracy for food consumption measurement with relatively-low privacy intrusion.

Specific examples of potentially-relevant prior art which appear to be most appropriately classified into this category include the following U.S. patents: U.S. Pat. No. 6,513,532 (Mault et al., Feb. 4, 2003, “Diet and Activity Monitoring Device”); U.S. Pat. No. 6,605,038 (Teller et al., Aug. 12, 2003, “System for Monitoring Health, Wellness and Fitness”); U.S. Pat. No. 6,790,178 (Mault et al., Sep. 14, 2004, “Physiological Monitor and Associated Computation, Display and Communication Unit”); U.S. Pat. No. 7,020,508 (Stivoric et al., Mar. 28, 2006, “Apparatus for Detecting Human Physiological and Contextual Information”); U.S. Pat. No. 7,261,690 (Teller et al., Aug. 28, 2007, “Apparatus for Monitoring Health, Wellness and Fitness”); U.S. Pat. No. 7,285,090 (Stivoric et al., Oct. 23, 2007, “Apparatus for Detecting, Receiving, Deriving and Displaying Human Physiological and Contextual Information”); U.S. Pat. No. 7,689,437 (Teller et al., Mar. 30, 2010, “System for Monitoring Health, Wellness and Fitness”); U.S. Pat. No. 7,914,468 (Shalon et al., Mar. 29, 2011, “Systems and Methods for Monitoring and Modifying Behavior”); U.S. Pat. No. 7,959,567 (Stivoric et al., Jun. 14, 2011, “Device to Enable Quick Entry of Caloric Content”); U.S. Pat. No. 8,073,707 (Teller et al., Dec. 6, 2011, “System for Detecting Monitoring and Reporting an Individual's Physiological or Contextual Status”); U.S. Pat. No. 8,157,731 (Teller et al., Apr. 17, 2012, “Method and Apparatus for Auto Journaling of Continuous or Discrete Body States Utilizing Physiological and/or Contextual Parameters”); U.S. Pat. No. 8,323,189 (Tran et al., Dec. 4, 2012, “Health monitoring appliance”); U.S. Pat. No. 8,328,718 (Tran, Dec. 11, 2012, “Health Monitoring Appliance”); U.S. Pat. No. 8,398,546 (Pacione et al., Mar. 19, 2013, “System for Monitoring and Managing Body Weight and Other Physiological Conditions Including Iterative and Personalized Planning, Intervention and Reporting Capability”); and U.S. Pat. No. 8,425,415 (Tran, Apr. 23, 2013, “Health Monitoring Appliance”).

Specific examples of potentially-relevant prior art which appear to be most appropriately classified into this category also include the following U.S. patent applications: 20010049470 (Mault et al., Dec. 6, 2001, “Diet and Activity Monitoring Device”); 20020027164 (Mault et al., Mar. 7, 2002, “Portable Computing Apparatus Particularly Useful in a Weight Management Program”); 20020047867 (Mault et al., Apr. 25, 2002, “Image Based Diet Logging”); 20020133378 (Mault et al., Sep. 19, 2002, “System and Method of Integrated Calorie Management”); 20030065257 (Mault et al., Apr. 3, 2003, “Diet and Activity Monitoring Device”); 20030208110 (Mault et al., Nov. 6, 2003, “Physiological Monitoring using Wrist-Mounted Device”); 20040034289 (Teller et al., Feb. 19, 2004, “System for Monitoring Health, Wellness and Fitness”); 20040133081 (Teller et al., Jul. 8, 2004, “Method and Apparatus for Auto Journaling of Continuous or Discrete Body States Utilizing Physiological and/or Contextual Parameters”); 20040152957 (Stivoric et al., Aug. 5, 2004, “Apparatus for Detecting, Receiving, Deriving and Displaying Human Physiological and Contextual Information”); 20050113650 (Pacione et al., May 26, 2005, “System for Monitoring and Managing Body Weight and Other Physiological Conditions Including Iterative and Personalized Planning Intervention and Reporting Capability”); 20060031102 (Teller et al., Feb. 9, 2006, “System for Detecting Monitoring and Reporting an Individual's Physiological or Contextual Status”); 20060064037 (Shalon et al., Mar. 23, 2006, “Systems and Methods for Monitoring and Modifying Behavior”); 20060122474 (Teller et al., Jun. 8, 2006, “Apparatus for Monitoring Health Wellness and Fitness”); and 20060264730 (Stivoric et al., Nov. 23, 2006, “Apparatus for Detecting Human Physiological and Contextual Information”).

Additional U.S. patent applications which appear to be most appropriately classified into this category include: 20070100666 (Stivoric et al., May 3, 2007, “Devices and Systems for Contextual and Physiological-Based Detection, Monitoring, Reporting, Entertainment, and Control of Other Devices”); 20080161654 (Teller et al., Jul. 3, 2008, “Method and Apparatus for Auto Journaling of Body States and Providing Derived Physiological States Utilizing Physiological and/or Contextual Parameter”); 20080161655 (Teller et al., Jul. 3, 2008, “Method and Apparatus for Auto Journaling of Body States and Providing Derived Physiological States Utilizing Physiological and/or Contextual Parameter”); 20080167535 (Andre et. al, Jul. 10, 2008, “Devices and Systems for Contextual and Physiological-Based Reporting, Entertainment, Control of Other Devices, Health Assessment and Therapy”); 20080167536 (Teller et al., Jul. 10, 2008, “Method and Apparatus for Auto Journaling of Body States and Providing Derived Physiological States Utilizing Physiological and/or Contextual Parameter”); 20080167537 (Teller et al., Jul. 10, 2008, “Method and Apparatus for Auto Journaling of Body States and Providing Derived Physiological States Utilizing Physiological and/or Contextual Parameter”); 20080167538 (Teller et al., Jul. 10, 2008, “Method and Apparatus for Auto Journaling of Body States and Providing Derived Physiological States Utilizing Physiological and/or Contextual Parameter”); 20080167539 (Teller et al., Jul. 10, 2008, “Method and Apparatus for Auto Journaling of Body States and Providing Derived Physiological States Utilizing Physiological and/or Contextual Parameter”); and 20080171920 (Teller et al., Jul. 17, 2008, “Method and Apparatus for Auto Journaling of Body States and Providing Derived Physiological States Utilizing Physiological and/or Contextual Parameter”).

Further U.S. patent applications in this category include: 20080171921 (Teller et al., Jul. 17, 2008, “Method and Apparatus for Auto Journaling of Body States and Providing Derived Physiological States Utilizing Physiological and/or Contextual Parameter”); 20080171922 (Teller et al., Jul. 17, 2008, “Method and Apparatus for Auto Journaling of Body States and Providing Derived Physiological States Utilizing Physiological and/or Contextual Parameter”); 20080275309 (Stivoric et al., Nov. 6, 2008, “Input Output Device for Use with Body Monitor”); 20090012433 (Fernstrom et al., Jan. 8, 2009, “Method, Apparatus and System for Food Intake and Physical Activity Assessment”); 20090177068 (Stivoric et al., Jul. 9, 2009, “Method and Apparatus for Providing Derived Glucose Information Utilizing Physiological and/or Contextual Parameters”); 20110125063 (Shalon et al., May 26, 2011, “Systems and Methods for Monitoring and Modifying Behavior”); 20110276312 (Shalon et al., Nov. 10, 2011, “Device for Monitoring and Modifying Eating Behavior”); 20120313776 (Utter et al., Dec. 13, 2012, “General Health and Wellness Management Method and Apparatus for a Wellness Application Using Data from a Data-Capable Band”); 20120313776 (Utter, Dec. 13, 2012, “General Health and Wellness Management Method and Apparatus for a Wellness Application Using Data from a Data-Capable Band”); and 20120326873 (Utter, Dec. 27, 2012, “Activity Attainment Method and Apparatus for a Wellness Application Using Data from a Data-Capable Band”).

Further U.S. patent applications in this category include: 20120326873 (Utter, Dec. 27, 2012, “Activity Attainment Method and Apparatus for a Wellness Application Using Data from a Data-Capable Band”); 20120330109 (Tran, Dec. 27, 2012, “Health Monitoring Appliance”); 20130002435 (Utter, Jan. 3, 2013, “Sleep Management Method and Apparatus for a Wellness Application Using Data from a Data-Capable Band”); 20130004923 (Utter, Jan. 3, 2013, “Nutrition Management Method and Apparatus for a Wellness Application Using Data from a Data-Capable Band”); 20130069780 (Tran et al., Mar. 21, 2013, “Health Monitoring Appliance”); and 20130072765 (Kahn et al., Mar. 21, 2013, “Body-Worn Monitor”). Prior art which appears to be most appropriately classified into this category also includes: WO 2005029242 (Pacione et al., Jun. 9, 2005, “System for Monitoring and Managing Body Weight and Other Physiological Conditions Including Iterative and Personalized Planning, Intervention and Reporting Capability”); WO 2010070645 (Einav, Jun. 24, 2010, “Method and System for Monitoring Eating Habits”); and WO 2012170584 (Utter, Dec. 13, 2012, “General Health and Wellness Management Method and Apparatus for a Wellness Application Using Data from a Data-Capable Band”).

### (6) Other Potentially-Relevant Devices and Methods

When reviewing the prior art, I found a number of examples of prior art that may be potentially relevant to this present invention but which do not fall neatly into one of the above five categories. I include them here in a miscellaneous category of other potentially-relevant devices and methods. The titles are given to help the reader get insights into their diverse, but potentially-relevant, contents. Specific examples of potentially-relevant prior art which appear to be most appropriately classified into this category include the following U.S. patents: U.S. Pat. No. 3,885,576 (Symmes, May 27, 1975, “Wrist Band Including a Mercury Switch to Induce an Electric Shock”); U.S. Pat. No. 4,221,959 (Sessler, Sep. 9, 1980, “Checking Device for Checking the Food Intake”); U.S. Pat. No. 4,310,316 (Thomann, Jan. 12, 1982, “Diet Control Apparatus”); U.S. Pat. No. 4,355,645 (Mitani et al., Oct. 26, 1982, “Device for Displaying Masticatory Muscle Activities”); U.S. Pat. No. 4,819,860 (Hargrove et al., Apr. 11, 1989, “Wrist-Mounted Vital Functions Monitor and Emergency Locator”); U.S. Pat. No. 4,917,108 (Mault, Apr. 17, 1990, “Oxygen Consumption Meter”); U.S. Pat. No. 5,148,002 (Kuo et al., Sep. 15, 1992, “Multi-Functional Garment System”); U.S. Pat. No. 5,285,398 (Janik, Feb. 8, 1994, “Flexible Wearable Computer”); U.S. Pat. No. 5,301,679 (Taylor, Apr. 12, 1994, “Method and System for Analysis of Body Sounds”); U.S. Pat. No. 5,491,651 (Janik, Feb. 13, 1996, “Flexible Wearable Computer”); U.S. Pat. No. 5,515,858 (Myllymaki, May 14, 1996, “Wrist-Held Monitoring Device for Physical Condition”); U.S. Pat. No. 5,555,490 (Carroll, Sep. 10, 1996, “Wearable Personal Computer System”); U.S. Pat. No. 5,581,492 (Janik, Dec. 3, 1996, “Flexible Wearable Computer”); U.S. Pat. No. 5,636,146 (Flentov et al., Jun. 3, 1997, “Apparatus and Methods for Determining Loft Time and Speed”); U.S. Pat. No. 5,908,301 (Lutz, Jun. 1, 1999, “Method and Device for Modifying Behavior”); U.S. Pat. No. 6,095,985 (Raymond et al., Aug. 1, 2000, “Health Monitoring System”); U.S. Pat. No. 6,218,358 (Firestein et al., Apr. 17, 2001, “Functional Expression of, and Assay for, Functional Cellular Receptors In Vivo”); U.S. Pat. No. 6,266,623 (Vock et al., Jul. 24, 2001, “Sport Monitoring Apparatus for Determining Loft Time, Speed, Power Absorbed and Other Factors Such as Height”); U.S. Pat. No. 6,387,329 (Lewis et al., May 14, 2002, “Use of an Array of Polymeric Sensors of Varying Thickness for Detecting Analytes in Fluids”); U.S. Pat. No. 6,473,368 (Stanfield, Oct. 29, 2002, “Consumption Controller”); and U.S. Pat. No. 6,572,542 (Houben et al., Jun. 3, 2003, “System and Method for Monitoring and Controlling the Glycemic State of a Patient”).

Additional U.S. patents which appear to be most appropriately classified into this category include: U.S. Pat. No. 6,595,929 (Stivoric et al., Jul. 22, 2003, “System for Monitoring Health Wellness and Fitness Having a Method and Apparatus for Improved Measurement of Heat Flow”); U.S. Pat. No. 6,610,367 (Lewis et al., Aug. 26, 2003, “Use of an Array of Polymeric Sensors of Varying Thickness for Detecting Analytes in Fluids”); U.S. Pat. No. 6,765,488 (Stanfield, Jul. 20, 2004, “Enhanced Consumption Controller”); U.S. Pat. No. 6,850,861 (Faiola et al., Feb. 1, 2005, “System for Monitoring Sensing Device Data Such as Food Sensing Device Data”); U.S. Pat. No. 7,122,152 (Lewis et al., Oct. 17, 2006, “Spatiotemporal and Geometric Optimization of Sensor Arrays for Detecting Analytes Fluids”); U.S. Pat. No. 7,192,136 (Howell et al., Mar. 20, 2007, “Tethered Electrical Components for Eyeglasses”); U.S. Pat. No. 7,241,880 (Adler et al., Jul. 10, 2007, “T1R Taste Receptors and Genes Encoding Same”); U.S. Pat. No. 7,247,023 (Peplinski et al., Jul. 24, 2007, “System and Method for Monitoring Weight and Nutrition”); U.S. Pat. No. 7,502,643 (Farringdon et al., Mar. 10, 2009, “Method and Apparatus for Measuring Heart Related Parameters”); U.S. Pat. No. 7,595,023 (Lewis et al., Sep. 29, 2009, “Spatiotemporal and Geometric Optimization of Sensor Arrays for Detecting Analytes in Fluids”); U.S. Pat. No. 7,651,868 (Mcdevitt et al., Jan. 26, 2010, “Method and System for the Analysis of Saliva using a Sensor Array”); U.S. Pat. No. 7,882,150 (Badyal, Feb. 1, 2011, “Health Advisor”); U.S. Pat. No. 7,905,815 (Ellis et al., Mar. 15, 2011, “Personal Data Collection Systems and Methods”); U.S. Pat. No. 7,905,832 (Lau et al., Mar. 15, 2011, “Method and System for Personalized Medical Monitoring and Notifications Therefor”); and U.S. Pat. No. 7,931,562 (Ellis et al., Apr. 26, 2011, “Mobile Data Logging Systems and Methods”).

Further U.S. patents in this category include: U.S. Pat. No. 8,067,185 (Zoller et al., Nov. 29, 2011, “Methods of Quantifying Taste of Compounds for Food or Beverages”); U.S. Pat. No. 8,116,841 (Bly et al., Feb. 14, 2012, “Adherent Device with Multiple Physiological Sensors”); U.S. Pat. No. 8,121,673 (Tran, Feb. 12, 1012, “Health Monitoring Appliance”); U.S. Pat. No. 8,170,656 (Tan et al., May 1, 2012, “Wearable Electromyography-Based Controllers for Human-Computer Interface”); U.S. Pat. No. 8,275,635 (Stivoric et al., Sep. 25, 2012, “Integration of Lifeotypes with Devices and Systems”); U.S. Pat. No. 8,285,356 (Bly et al., Oct. 9, 2012, “Adherent Device with Multiple Physiological Sensors”); U.S. Pat. No. 8,314,224 (Adler et al., Nov. 20, 2012, “T1R Taste Receptors and Genes Encoding Same”); U.S. Pat. No. 8,323,188 (Tran, Dec. 4, 2012, “Health Monitoring Appliance”); U.S. Pat. No. 8,323,218 (Davis et al., Dec. 4, 2012, “Generation of Proportional Posture Information Over Multiple Time Intervals”); U.S. Pat. No. 8,334,367 (Adler, Dec. 18, 2012, “T2R Taste Receptors and Genes Encoding Same”); U.S. Pat. No. 8,340,754 (Chamney et al., Dec. 25, 2012, “Method and a Device for Determining the Hydration and/or Nutrition Status of a Patient”); U.S. Pat. No. 8,344,325 (Merrell et al., Jan. 1, 2013, “Electronic Device With Sensing Assembly and Method for Detecting Basic Gestures”); U.S. Pat. No. 8,344,998 (Fitzgerald et al., Jan. 1, 2013, “Gesture-Based Power Management of a Wearable Portable Electronic Device with Display”); U.S. Pat. No. 8,345,414 (Mooring et al., Jan. 1, 2013, “Wearable Computing Module”); U.S. Pat. No. 8,364,250 (Moon et al., Jan. 29, 2013, “Body-Worn Vital Sign Monitor”); and U.S. Pat. No. 8,369,936 (Farringdon et al., Feb. 5, 2013, “Wearable Apparatus for Measuring Heart-Related Parameters and Deriving Human Status Parameters from Sensed Physiological and Contextual Parameters”).

Further U.S. patents in this category include: U.S. Pat. No. 8,370,176 (Vespasiani, Feb. 5, 2013, “Method and System for Defining and Interactively Managing a Watched Diet”); U.S. Pat. No. 8,379,488 (Gossweiler et al., Feb. 19, 2013, “Smart-Watch Including Flip Up Display”); U.S. Pat. No. 8,382,482 (Miller-Kovach et al., Feb. 26, 2013, “Processes and Systems for Achieving and Assisting in Improved Nutrition Based on Food Energy Data and Relative Healthfulness Data”); U.S. Pat. No. 8,382,681 (Escutia et al., Feb. 26, 2013, “Fully Integrated Wearable or Handheld Monitor”); U.S. Pat. No. 8,409,118 (Agrawal et al., Apr. 2, 2013, “Upper Arm Wearable Exoskeleton”); U.S. Pat. No. 8,417,298 (Mittleman et al., Apr. 9, 2013, “Mounting Structures for Portable Electronic Devices”); U.S. Pat. No. 8,419,268 (Yu Apr. 16, 2013, “Wearable Electronic Device”); U.S. Pat. No. 8,421,634 (Tan et al., Apr. 16, 2013, “Sensing Mechanical Energy to Appropriate the Body for Data Input”); U.S. Pat. No. 8,423,378 (Goldberg, Apr. 16, 2013, “Facilitating Health Care Management of Subjects”); U.S. Pat. No. 8,423,380 (Gelly Apr. 16, 2013, “Method and System for Interactive Health Regimen Accountability and Patient Monitoring”); and U.S. Pat. No. 8,437,823 (Ozawa et al., May 7, 2013, “Noninvasive Living Body Measurement Apparatus and Noninvasive Living Body Measurement Method”).

Specific examples of potentially-relevant prior art which appear to be most appropriately classified into this category also include the following U.S. patent applications: 20020049482 (Fabian et al., Apr. 25, 2002, “Lifestyle Management System”); 20040100376 (Lye et al., May 27, 2004, “Healthcare Monitoring System”); 20050113649 (Bergantino, May 26, 2005, “Method and Apparatus for Managing a User's Health”); 20050146419 (Porter, Jul. 7, 2005, “Programmable Restricted Access Food Storage Container and Behavior Modification Assistant”); 20050263160 (Utley et al., Dec. 1, 2005, “Intraoral Aversion Devices and Methods”); 20060015016 (Thornton, Jan. 19, 2006, “Caloric Balance Weight Control System and Methods of Making and Using Same”); 20060122468 (Tavor, Jun. 8, 2006, “Nutritional Counseling Method and Server”); 20070106129 (Srivathsa et al., May 10, 2007, “Dietary Monitoring System for Comprehensive Patient Management”); 20080036737 (Hernandez-Rebollar, Feb. 14, 2008, “Arm Skeleton for Capturing Arm Position and Movement”); 20080140444 (Karkanias et al., Jun. 12, 2008, “Patient Monitoring Via Image Capture”); 20090261987 (Sun, Oct. 22, 2009, “Sensor Instrument System Including Method for Detecting Analytes in Fluids”); 20100000292 (Karabacak et al., Jan. 7, 2010, “Sensing Device”); 20100049004 (Edman et al., Feb. 25, 2010, “Metabolic Energy Monitoring System”); 20100049010 (Goldreich, Feb. 25, 2010, “Method and Device for Measuring Physiological Parameters at the Wrist”); 20100055271 (Miller-Kovach et al., Mar. 4, 2010, “Processes and Systems Based on Metabolic Conversion Efficiency”); 20100055652 (Miller-Kovach et al., Mar. 4, 2010, “Processes and Systems Based on Dietary Fiber as Energy”); and 20100055653 (Miller-Kovach et al., Mar. 4, 2010, “Processes and Systems Using and Producing Food Healthfulness Data Based on Food Metagroups”).

Additional U.S. patent applications which appear to be most appropriately classified into this category include: 20100209897 (Utley et al., Aug. 19, 2010, “Intraoral Behavior Monitoring and Aversion Devices and Methods”); 20100291515 (Pinnisi et al., Nov. 18, 2010, “Regulating Food and Beverage Intake”); 20110053128 (Alman, Mar. 3, 2011, “Automated Patient Monitoring and Counseling System”); 20110077471 (King, Mar. 31, 2011, “Treatment and Prevention of Overweight and Obesity by Altering Visual Perception of Food During Consumption”); 20110205851 (Harris, Aug. 25, 2011, “E-Watch”); 20110218407 (Haberman et al., Sep. 8, 2011, “Method and Apparatus to Monitor, Analyze and Optimize Physiological State of Nutrition”); 20120015432 (Adler, Jan. 19, 2012, “Isolated Bitter Taste Receptor Polypeptides”); 20120021388 (Arbuckle et al., Jan. 26, 2012, “System and Method for Weight Management”); 20120053426 (Webster et al., Mar. 1, 2012, “System and Method for Measuring Calorie Content of a Food Sample”); 20120071731 (Gottesman, Mar. 22, 2012, “System and Method for Physiological Monitoring”); 20120179020 (Wekell, Jul. 12, 2012, “Patient Monitoring Device”); 20120188158 (Tan et al., Jul. 26, 2012, “Wearable Electromyography-Based Human-Computer Interface”); 20120214594 (Kirovski et al., Aug. 23, 2012, “Motion Recognition”); 20120231960 (Osterfeld et al., Sep. 13, 2012, “Systems and Methods for High-Throughput Detection of an Analyte in a Sample”); 20120235647 (Chung et al., Sep. 20, 2012, “Sensor with Energy-Harvesting Device”); 20120239304 (Hayter et al., Sep. 20, 2012, “Method and System for Determining Analyte Levels”); 20120242626 (Hu, Sep. 27, 2012, “Electronic Watch Capable of Adjusting Display Angle of Screen Content Thereof”); and 20120245472 (Rulkov et al., Sep. 27, 2012, “Monitoring Device with an Accelerometer, Method and System”).

Further U.S. patent applications in this category include: 20120245714 (Mueller et al., Sep. 27, 2012, “System and Method for Counting Swimming Laps”); 20120254749 (Downs et al., Oct. 4, 2012, “System and Method for Controlling Life Goals”); 20120258804 (Ahmed, Oct. 11, 2012, “Motion-Based Input for Platforms and Applications”); 20120277638 (Skelton et al., Nov. 1, 2012, “Obtaining Baseline Patient Information”); 20120303638 (Bousamra et al., Nov. 29, 2012, “Location Enabled Food Database”); 20120315986 (Walling, Dec. 13, 2012, “Virtual Performance System”); 20120316793 (Jung et al., Dec. 13, 2012, “Methods and Systems for Indicating Behavior in a Population Cohort”); 20120326863 (Johnson et al., Dec. 27, 2012, “Wearable Portable Device and Method”); 20120330112 (Lamego et al., Dec. 27, 2012, “Patient Monitoring System”); 20120331201 (Rondel, Dec. 27, 2012, “Strap-Based Computing Device”); 20130002538 (Mooring et al., Jan. 3, 2013, “Gesture-Based User Interface for a Wearable Portable Device”); 20130002545 (Heinrich et al., Jan. 3, 2013, “Wearable Computer with Curved Display and Navigation Tool”); 20130002724 (Heinrich et al., Jan. 3, 2013, “Wearable Computer with Curved Display and Navigation Tool”); 20130009783 (Tran, Jan. 10, 2013, “Personal Emergency Response (PER) System”); 20130017789 (Chi et al., Jan. 17, 2013, “Systems and Methods for Accessing an Interaction State Between Multiple Devices”); 20130021226 (Bell, Jan. 24, 2013, “Wearable Display Devices”); 20130021658 (Miao et al., Jan. 24, 2013, “Compact See-Through Display System”); 20130027060 (Tralshawala et al., Jan. 31, 2013, “Systems and Methods for Non-Destructively Measuring Calorie Contents of Food Items”); and 20130035575 (Mayou et al., Feb. 7, 2013, “Systems and Methods for Detecting Glucose Level Data Patterns”).

Further U.S. patent applications in this category include: 20130035865 (Mayou et al., Feb. 7, 2013, “Systems and Methods for Detecting Glucose Level Data Patterns”); 20130038056 (Donelan et al., Feb. 14, 2013, “Methods and Apparatus for Harvesting Biomechanical Energy”); 20130041272 (Guillen et al., Feb. 14, 2013, “Sensor Apparatus Adapted to be Incorporated in a Garment”); 20130044042 (Olsson et al., Feb. 21, 2013, “Wearable Device with Input and Output Structures”); 20130045037 (Schaffer, Feb. 21, 2013, “Wristwatch Keyboard”); 20130048737 (Baym et al., Feb. 28, 2013, “Systems, Devices, Admixtures, and Methods Including Transponders for Indication of Food Attributes”); 20130048738 (Baym et al., Feb. 28, 2013, “Systems, Devices, Admixtures, and Methods Including Transponders for Indication of Food Attributes”); 20130049931 (Baym et al., Feb. 28, 2013, “Systems, Devices, Methods, and Admixtures of Transponders and Food Products for Indication of Food Attributes”); 20130049932 (Baym et al., Feb. 28, 2013, “Systems, Devices, Methods, and Admixtures of Transponders and Food Products for Indication of Food Attributes”); 20130049933 (Baym et al., Feb. 28, 2013, “Systems, Devices, Methods, and Admixtures Including Interrogators and Interrogation of Tags for Indication of Food Attributes”); 20130049934 (Baym et al., Feb. 28, 2013, “Systems, Devices, Methods, and Admixtures Including Interrogators and Interrogation of Tags for Indication of Food Attributes”); and 20130053655 (Castellanos, Feb. 28, 2013, “Mobile Vascular Health Evaluation Devices”).

Further U.S. patent applications in this category include: 20130053661 (Alberth et al., Feb. 28, 2013, “System for Enabling Reliable Skin Contract of an Electrical Wearable Device”); 20130063342 (Chen et al., Mar. 14, 2013, “Human Interface Input Acceleration System”); 20130065680 (Zavadsky et al., Mar. 14, 2013, “Method and Apparatus for Facilitating Strength Training”); 20130069931 (Wilson et al., Mar. 21, 2013, “Correlating Movement Information Received from Different Sources”); 20130069985 (Wong et al., Mar. 21, 2013, “Wearable Computer with Superimposed Controls and Instructions for External Device”); 20130070338 (Gupta et al., Mar. 21, 2013, “Lightweight Eyepiece for Head Mounted Display”); 20130072807 (Tran, Mar. 21, 2013, “Health Monitoring Appliance”); 20130083496 (Franklin et al., Apr. 4, 2013, “Flexible Electronic Devices”); 20130100027 (Wang et al., Apr. 25, 2013, “Portable Electronic Device”); 20130107674 (Gossweiler et al., May 2, 2013, “Smart-Watch with User Interface Features”); 20130109947 (Wood, May 2, 2013, “Methods and Systems for Continuous Non-Invasive Blood Pressure Measurement Using Photoacoustics”); 20130110549 (Lawn et al., May 2, 2013, “Device and Method for Assessing Blood Glucose Control”); 20130111611 (Barros Almedo et al., May 2, 2013, “Method to Measure the Metabolic Rate or Rate of Glucose Consumption of Cells or Tissues with High Spatiotemporal Resolution Using a Glucose Nanosensor”); 20130115717 (Guo et al., May 9, 2013, “Analyzing Chemical and Biological Substances Using Nano-Structure Based Spectral Sensing”); 20130116525 (Heller et al., May 9, 2013, “Analyte Monitoring Device and Methods of Use”); 20130117040 (James et al., May 9, 2013, “Method and System for Supporting a Health Regimen”); 20130117041 (Boyce et al., May 9, 2013, “Computer Method and System for Promoting Health, Wellness, and Fitness with Multiple Sponsors”); 20130117135 (Riddiford et al., May 9, 2013, “Multi-User Food and Drink Ordering System”); and 20130119255 (Dickinson et al., May 16, 2013, “Methods and Devices for Clothing Detection about a Wearable Electronic Device”).

### SUMMARY OF THE INVENTION

This invention can be embodied as a wearable device or system for identification and quantification of food, ingredients, and/or nutrients. In an example, this invention can comprise: (a) at least one imaging member (such as a camera) that takes pictures of nearby food, wherein these food pictures are automatically analyzed to identify the types and quantities of food, ingredients, and/or nutrients; (b) an optical sensor (such as a spectroscopic optical sensor) which collects data concerning light that is reflected from nearby food, wherein this data is automatically analyzed to identify types of food, ingredients in the food, and/or nutrients in the food; (c) an attachment mechanism (such as a wrist band) which holds the imaging member and the optical sensor in close proximity to the surface of a person's body; and (d) an image-analyzing member (such as a data control unit).

In an example, this invention can further comprise a computer-to-human interface which modifies a person's food consumption and/or nutritional intake based on identification of unhealthy vs. healthy types and quantities of food, ingredients, and/or nutrients. In an example, this invention can encourage consumption and/or increase nutritional intake of healthy food, ingredients, and/or nutrients and can discourage consumption and/or decrease nutritional intake of unhealthy food, ingredients, and/or nutrients.

In an example, this invention can serve as the energy-input measuring component of an overall system for energy balance and weight management. In an example, information from this invention can be combined with information from a separate caloric expenditure monitoring device in order to comprise an overall system for energy balance, fitness, weight management, and health improvement. This invention is not a panacea for good nutrition, energy balance, and weight management, but it can be a useful part of an overall strategy for encouraging good nutrition, energy balance, weight management, and health improvement.

### INTRODUCTION TO THE FIGURES

FIG. 1 through 10 show different examples of how this invention can be embodied, but they do not limit the full generalizability of the claims.

FIGS. 1 through 3 show examples of how this invention can be embodied in a wearable device or system for food identification and quantification.

FIG. 1 shows an example of how this invention can be embodied in a wearable device for food identification and quantification comprising an imaging member (e.g. camera), an optical sensor (e.g. spectroscopic optical sensor), an attachment mechanism (e.g. wrist band), and an image-analyzing member (e.g. data control unit), wherein the imaging member and optical sensor are on the anterior/palmar/lower side of a person's wrist.

FIG. 2 shows an example that is like the example in FIG. 1 except that FIG. 2 further comprises a projected light-based fiducial marker.

FIG. 3 shows an example of how this invention can be embodied in a wearable device for food identification and quantification comprising an imaging member (e.g. camera), an optical sensor (e.g. spectroscopic optical sensor), an attachment mechanism (e.g. wrist band), and an image-analyzing member (e.g. data control unit), wherein the imaging member and optical sensor are on the lateral/narrow side of a person's wrist.

FIGS. 4 through 10 show examples of how this invention can be embodied in a wearable system or device for food identification and nutritional intake modification.

FIG. 4 shows an example that is similar to the example in FIG. 3 except that FIG. 4 further comprises a computer-to-human interface that is an implanted substance-releasing device that releases an absorption-reducing substance into the person's stomach.

FIG. 5 shows an example that is similar to the example in FIG. 3 except that FIG. 5 further comprises a computer-to-human interface that is an implanted electromagnetic energy emitter that delivers electromagnetic energy to a portion of the person's gastrointestinal tract and/or to nerves which innervate that portion.

FIG. 6 shows an example that is similar to the example in FIG. 3 except that FIG. 6 further comprises a computer-to-human interface that is an implanted electromagnetic energy emitter that delivers electromagnetic energy to nerves which innervate a person's tongue and/or nasal passages.

FIG. 7 shows an example that is similar to the example in FIG. 3 except that FIG. 7 further comprises a computer-to-human interface that is an implanted substance-releasing device that releases a taste and/or smell modifying substance into a person's oral cavity and/or nasal passages.

FIG. 8 shows an example that is similar to the example in FIG. 3 except that FIG. 8 further comprises a computer-to-human interface that is an implanted gastrointestinal constriction device.

FIG. 9 shows an example that is similar to the example in FIG. 3 except that FIG. 9 further comprises eyewear and a virtually-displayed image.

FIG. 10 shows an example that is similar to the example in FIG. 3 except that FIG. 10 further comprises an audio message to the person wearing the device.

### DETAILED DESCRIPTION OF THE FIGURES

### 1. Device or System for Food Identification and Quantification

In an example, this invention can be embodied in a wearable device or system for food identification and quantification comprising: at least one imaging member, wherein this imaging member takes pictures and/or records images of nearby food, and wherein these food pictures and/or images are automatically analyzed to identify the types and quantities of food; an optical sensor, wherein this optical sensor collects data concerning light that is transmitted through or reflected from nearby food, and wherein this data is automatically analyzed to identify the types of food, the types of ingredients in the food, and/or the types of nutrients in the food; one or more attachment mechanisms, wherein these one or more attachment mechanisms are configured to hold the imaging member and the optical sensor in close proximity to the surface of a person's body; and an image-analyzing member which automatically analyzes food pictures and/or images.

With respect to the imaging member, a device, system, or method for measuring types of food, ingredients, and/or nutrients can include a camera or other picture-taking device that takes pictures of food. In an example, a camera can be positioned on a person's wrist at a location from which it takes pictures along an imaging vector that is directed generally downward toward a reachable food source. In an example, a device, system, or method for measuring types of food, ingredients, and/or nutrients can take pictures of food using a device selected from the group consisting of: smart watch, smart bracelet, fitness watch, fitness bracelet, watch phone, bracelet phone, wrist band, or other wrist-worn device; arm bracelet; and smart ring or finger ring.

With respect to analyzing pictures or images of nearby food, one or more methods to analyze pictures or images in order to estimate types and quantities of food can be selected from the group consisting of: pattern recognition; food recognition; word recognition; logo recognition; bar code recognition; face recognition; gesture recognition; and human motion recognition. In various examples, a picture or image of a person's mouth and/or a reachable food source can be analyzed with one or more methods selected from the group consisting of: pattern recognition or identification; human motion recognition or identification; face recognition or identification; gesture recognition or identification; food recognition or identification; word recognition or identification; logo recognition or identification; bar code recognition or identification; and 3D modeling.

In an example, this invention can measure a person's consumption of at least one type of food, ingredient, or nutrient. In an example, this invention can identify and track in an entirely automatic manner the types and amounts of foods, ingredients, or nutrients that a person consumes. In an example, such identification can occur in a partially-automatic manner in which there is interaction between automated and human identification methods. In an example, identification (from pictures of food) of the types and quantities of food, ingredients, or nutrients that a person consumes can be a combination of, or interaction between, automated food identification methods and human-based food identification methods. In various examples, automatic identification of food types and quantities can be based on: color and texture analysis; image segmentation; image pattern recognition; volumetric analysis based on a fiducial marker or other object of known size; and/or three-dimensional modeling based on pictures from multiple perspectives.

The term “food” is broadly defined herein to include liquid nourishment, such as beverages, in addition to solid food. Food consumption is broadly defined to include consumption of liquid beverages and gelatinous food as well as consumption of solid food. In an example, nearby food can also be referred to as a “reachable food source” and can be defined as a source of food that a person can access and from which they can bring a piece (or portion) of food to their mouth by moving their arm and hand. In an example, nearby food can be selected from the group consisting of: food on a plate, food in a bowl, food in a glass, food in a cup, food in a bottle, food in a can, food in a package, food in a container, food in a wrapper, food in a bag, food in a box, food on a table, food on a counter, food on a shelf, and food in a refrigerator.

With respect to different types of food, a device, system, or method for measuring types of food, ingredients, and/or nutrients should be able to differentiate between healthy foods vs unhealthy foods. This requires the ability to identify consumption of selected types of food, ingredients, and/or nutrients, as well as estimate the amounts of such consumption. It also requires selection of certain types and/or amounts of food, ingredients, and/or nutrients as healthy vs. unhealthy. In an example, a food-identifying device can selectively detect one or more types of unhealthy food, wherein unhealthy food is selected from the group consisting of: food that is high in simple carbohydrates; food that is high in simple sugars; food that is high in saturated or trans fat; fried food; food that is high in Low Density Lipoprotein (LDL); and food that is high in sodium.

In an example, this invention can identify and quantify one or more selected types of food, ingredients, and/or nutrients selected from the group consisting of: a specific type of carbohydrate, a class of carbohydrates, or all carbohydrates; a specific type of sugar, a class of sugars, or all sugars; a specific type of fat, a class of fats, or all fats; a specific type of cholesterol, a class of cholesterols, or all cholesterols; a specific type of protein, a class of proteins, or all proteins; a specific type of fiber, a class of fiber, or all fiber; a specific sodium compound, a class of sodium compounds, and all sodium compounds; high-carbohydrate food, high-sugar food, high-fat food, fried food, high-cholesterol food, high-protein food, high-fiber food, and high-sodium food.

In an example, this invention can identify and quantify a person's consumption of food that is high in simple carbohydrates. In an example, this invention can identify and quantify a person's consumption of food that is high in simple sugars. In an example, this invention can identify and quantify a person's consumption of food that is high in saturated fats. In an example, this invention can identify and quantify a person's consumption of food that is high in trans fats. In an example, this invention can identify and quantify a person's consumption of food that is high in Low Density Lipoprotein (LDL). In an example, this invention can identify and quantify a person's consumption of food that is high in sodium.

In an example, this invention can measure a person's consumption of food wherein a high proportion of its calories comes from simple carbohydrates. In an example, this invention can measure a person's consumption of food wherein a high proportion of its calories comes from simple sugars. In an example, this invention can measure a person's consumption of food wherein a high proportion of its calories comes from saturated fats. In an example, this invention can measure a person's consumption of food wherein a high proportion of its calories comes from trans fats. In an example, this invention can measure a person's consumption of food wherein a high proportion of its calories comes from Low Density Lipoprotein (LDL). In an example, this invention can measure a person's consumption of food wherein a high proportion of its weight or volume is comprised of sodium compounds.

In an example, this invention can measure a person's consumption of one or more selected types of food, ingredients, and/or nutrients selected from the group consisting of: simple carbohydrates, simple sugars, saturated fat, trans fat, Low Density Lipoprotein (LDL), and salt. In an example, this invention can measure a person's consumption of simple carbohydrates. In an example, this invention can measure a person's consumption of simple sugars. In an example, this invention can measure a person's consumption of saturated fats. In an example, this invention can measure a person's consumption of trans fats. In an example, this invention can measure a person's consumption of Low Density Lipoprotein (LDL). In an example, this invention can measure a person's consumption of sodium.

In an example, this invention can identify and quantify one or more selected types of food, ingredients, and/or nutrients selected from the group consisting of: amino acid or protein (a selected type or general class), carbohydrate (a selected type or general class, such as single carbohydrates or complex carbohydrates), cholesterol (a selected type or class, such as HDL or LDL), dairy products (a selected type or general class), fat (a selected type or general class, such as unsaturated fat, saturated fat, or trans fat), fiber (a selected type or class, such as insoluble fiber or soluble fiber), mineral (a selected type), vitamin (a selected type), nuts (a selected type or general class, such as peanuts), sodium compounds (a selected type or general class), sugar (a selected type or general class, such as glucose), and water. In an example, food can be classified into general categories such as fruits, vegetables, or meat.

In an example, this invention can identify one or more potential food allergens, toxins, or other substances selected from the group consisting of: ground nuts, tree nuts, dairy products, shell fish, eggs, gluten, pesticides, animal hormones, and antibiotics. In an example, this invention can identify one or more types of food whose consumption is prohibited or discouraged for religious, moral, and/or cultural reasons, such as pork or meat products of any kind. In an example, a device for measuring nutrient consumption can track the quantities of selected chemicals that a person consumes via food consumption. In various examples, these consumed chemicals can be selected from the group consisting of carbon, hydrogen, nitrogen, oxygen, phosphorus, and sulfur.

In an example, this invention can identify and quantify one or more types of food, ingredients, and/or nutrients selected from the group consisting of: a selected food, ingredient, or nutrient that has been designated as unhealthy by a health care professional organization or by a specific health care provider for a specific person; a selected substance that has been identified as an allergen for a specific person; peanuts, shellfish, or dairy products; a selected substance that has been identified as being addictive for a specific person; alcohol; a vitamin or mineral; vitamin A, vitamin B1, thiamin, vitamin B12, cyanocobalamin, vitamin B2, riboflavin, vitamin C, ascorbic acid, vitamin D, vitamin E, calcium, copper, iodine, iron, magnesium, manganese, niacin, pantothenic acid, phosphorus, potassium, riboflavin, thiamin, and zinc; a selected type of carbohydrate, class of carbohydrates, or all carbohydrates; a selected type of sugar, class of sugars, or all sugars; simple carbohydrates, complex carbohydrates; simple sugars, complex sugars, monosaccharides, glucose, fructose, oligosaccharides, polysaccharides, starch, glycogen, disaccharides, sucrose, lactose, starch, sugar, dextrose, disaccharide, fructose, galactose, glucose, lactose, maltose, monosaccharide, processed sugars, raw sugars, and sucrose; a selected type of fat, class of fats, or all fats; fatty acids, monounsaturated fat, polyunsaturated fat, saturated fat, trans fat, and unsaturated fat; a selected type of cholesterol, a class of cholesterols, or all cholesterols; Low Density Lipoprotein (LDL), High Density Lipoprotein (HDL), Very Low Density Lipoprotein (VLDL), and triglycerides; a selected type of protein, a class of proteins, or all proteins; dairy protein, egg protein, fish protein, fruit protein, grain protein, legume protein, lipoprotein, meat protein, nut protein, poultry protein, tofu protein, vegetable protein, complete protein, incomplete protein, or other amino acids; a selected type of fiber, a class of fiber, or all fiber; dietary fiber, insoluble fiber, soluble fiber, and cellulose; a specific sodium compound, a class of sodium compounds, and all sodium compounds; salt; a selected type of meat, a class of meats, and all meats; a selected type of vegetable, a class of vegetables, and all vegetables; a selected type of fruit, a class of fruits, and all fruits; a selected type of grain, a class of grains, and all grains; high-carbohydrate food, high-sugar food, high-fat food, fried food, high-cholesterol food, high-protein food, high-fiber food, and high-sodium food.

With respect to different quantities of food, there can be different metrics for measuring amounts of food, ingredients, and nutrients. Overall, amounts or quantities of food, ingredients, and nutrients can be measured in terms of volume, mass, or weight. Volume measures how much space the food occupies. Mass measures how much matter the food contains. Weight measures the pull of gravity on the food. The concepts of mass and weight are related, but not identical. Food, ingredient, or nutrient density can also be measured, sometimes as a step toward measuring food mass. In an example, volume can be expressed in metric units (such as cubic millimeters, cubic centimeters, or liters) or U.S. (historically English) units (such as cubic inches, teaspoons, tablespoons, cups, pints, quarts, gallons, or fluid ounces). Mass (and often weight in colloquial use) can be expressed in metric units (such as milligrams, grams, and kilograms) or U.S. (historically English) units (ounces or pounds). The density of specific ingredients or nutrients within food is sometimes measured in terms of the volume of specific ingredients or nutrients per total food volume or measured in terms of the mass of specific ingredients or nutrients per total food mass.

The optical sensor of this invention can be a spectroscopic optical sensor. In an example, an optical sensor can be selected from the group consisting of: spectroscopy sensor, spectrometry sensor, white light spectroscopy sensor, infrared spectroscopy sensor, near-infrared spectroscopy sensor, ultraviolet spectroscopy sensor, ion mobility spectroscopic sensor, mass spectrometry sensor, backscattering spectrometry sensor, and spectrophotometer. In an example, this invention can include a light-based approach to food identification, such as spectroscopy. In an example, types of food, ingredients, and/or nutrients can be identified by the patterns of light that are reflected from, or absorbed by, the food at different wavelengths. In an example, an optical sensor can detect whether food reflects light at a different wavelength than the wavelength of light shone on food. In an example, an optical sensor can detect modulation of light reflected from, or absorbed by, a receptor when the receptor is exposed to food.

In an example, an optical sensor can analyze modulation of light wave parameters by the interaction of that light with a portion of food. In an example, an optical sensor can be a chromatographic sensor, spectrographic sensor, analytical chromatographic sensor, liquid chromatographic sensor, gas chromatographic sensor, optoelectronic sensor, photochemical sensor, or photocell. In an example, this invention can comprise a sensor that is selected from the group consisting of: accelerometer, inclinometer, motion sensor, pedometer, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor.

With respect to the one or more attachment mechanisms, an imaging member and an optical sensor can be attached to a person's body or clothing. In an example, an attachment mechanism can be selected from the group consisting of: band, strap, chain, hook and eye fabric, ring, adhesive, bracelet, buckle, button, clamp, clip, elastic band, eyewear, magnet, necklace, piercing, pin, string, suture, tensile member, wrist band, and zipper.

In an example, a device can be worn on a person in a manner like a clothing accessory or piece of jewelry selected from the group consisting of: wristwatch, wristphone, wristband, bracelet, cufflink, armband, armlet, and finger ring; necklace, neck chain, pendant, dog tags, locket, amulet, necklace phone, and medallion; eyewear, eyeglasses, spectacles, sunglasses, contact lens, goggles, monocle, and visor; clip, tie clip, pin, brooch, clothing button, and pin-type button; headband, hair pin, headphones, ear phones, hearing aid, earring; and dental appliance, palatal vault attachment, and nose ring. In an example, a device can be incorporated or integrated into an article of clothing or a clothing-related accessory. In various examples, a device can be incorporated or integrated into one of the following articles of clothing or clothing-related accessories: belt or belt buckle; neck tie; shirt or blouse; shoes or boots; underwear, underpants, briefs, undershirt, or bra; cap, hat, or hood; coat, jacket, or suit; dress or skirt; pants, jeans, or shorts; purse; socks; and sweat suit.

In an example, a device can be worn in a manner similar to a piece of jewelry or accessory selected from the group consisting of: smart watch, wrist band, wrist phone, wrist watch, fitness watch, or other wrist-worn device; finger ring or artificial finger nail; arm band, arm bracelet, charm bracelet, or smart bracelet; smart necklace, neck chain, neck band, or neck-worn pendant; smart eyewear, smart glasses, electronically-functional eyewear, virtual reality eyewear, or electronically-functional contact lens; cap, hat, visor, helmet, or goggles; smart button, brooch, ornamental pin, clip, smart beads; pin-type, clip-on, or magnetic button; shirt, blouse, jacket, coat, or dress button; head phones, ear phones, hearing aid, ear plug, or ear-worn bluetooth device; dental appliance, dental insert, upper palate attachment or implant; tongue ring, ear ring, or nose ring; electronically-functional skin patch and/or adhesive patch; undergarment with electronic sensors; head band, hair band, or hair clip; ankle strap or bracelet; belt or belt buckle; and key chain or key ring.

In an example, the image-analyzing member can be a data control unit. In an example, the image-analyzing member can be a data control unit, data processing unit, data analysis component, Central Processing Unit (CPU), and/or microprocessor. In an example, an image-analyzing member can analyze pictures or images of food taken by the imaging member in order to estimate types and amounts of food, ingredients, nutrients, and/or calories. In an example, this invention can comprise one or more components selected from the group consisting of: a data processing unit, data analysis component, Central Processing Unit (CPU), or microprocessor; a food-consumption monitoring component (motion sensor, electromagnetic sensor, optical sensor, and/or chemical sensor); a graphic display component (display screen and/or coherent light projection); a human-to-computer communication component (speech recognition, touch screen, keypad or buttons, and/or gesture recognition); a memory component (flash, RAM, or ROM); a power source and/or power-transducing component; a time keeping and display component; and a wireless data transmission and reception component.

In an example, this invention can serve as the energy-input measuring component of an overall system for energy balance and weight management. In an example, this invention can estimate the energy-input component of energy balance. In an example, information from this invention can be combined with information from a separate caloric expenditure monitoring device that measures a person's caloric expenditure in order to comprise an overall system for energy balance, fitness, weight management, and health improvement. In an example, this invention can be in wireless communication with a separate fitness monitoring device. In an example, the capability for monitoring food consumption can be combined with capability for monitoring caloric expenditure within a single device. In an example, a single device can be used to measure the types and amounts of food, ingredients, and/or nutrients that a person consumes as well as the types and durations of the calorie-expending activities in which the person engages.

This invention is not a panacea for good nutrition, energy balance, and weight management, but it can be a useful part of an overall strategy for encouraging good nutrition, energy balance, weight management, and health improvement. Although it is not sufficient to ensure energy balance and good health, it can be very useful in combination with proper exercise and other good health behaviors. This invention can help a person to track and modify their eating habits as part of an overall system for good nutrition, energy balance, weight management, and health improvement.

### 2. Using a Camera as an Imaging Member

In an example, at least one imaging member can be a camera. In an example, a device, system, or method for measuring types of food, ingredients, or nutrients can include a camera, or other picture-taking device, that takes pictures of food. In an example, this invention can comprise a camera with a field of vision which extends outwards from the camera aperture and downwards toward a reachable food source. In an example, a reachable food source can be food on a plate. In an example, a reachable food source can be encompassed by the field of vision. In an example, a camera can have an imaging vector that is generally perpendicular to the longitudinal bones of a person's upper arm. In an example, a camera can be positioned on a person's wrist at a location from which it takes pictures along an imaging vector that is directed generally downward from the imaging member toward a reachable food source as the person eats.

In an example, a camera can take pictures of the interaction between a person and food, including food apportionment, hand-to-mouth movements, and chewing movements. In an example, this invention can be embodied in a device, system, and method for monitoring food consumption which comprises an imaging member, wherein this imaging member is used to take pictures of food that the person eats.

In an example, a device, system, or method for measuring food can include taking multiple pictures of food. In an example, taking pictures of food from at least two different angles can better segment a meal into different types of food, estimate the three-dimensional volume of each type of food, and control for lighting and shading differences. In an example, a camera or other imaging device can take pictures of food from multiple perspectives in order to create a virtual three-dimensional model of food in order to determine food volume. In an example, an imaging device can estimate the quantities of specific foods from pictures or images of those foods by volumetric analysis of food from multiple perspectives and/or by three-dimensional modeling of food from multiple perspectives.

In an example, this invention can comprise at least two cameras or other imaging members. A first camera may be worn on a location on the human body from which it takes pictures along an imaging vector which points toward a person's mouth while the person eats. A second camera may be worn on a location on the human body from which it takes pictures along an imaging vector which points toward a reachable food source. In an example, a device can comprise two imaging members. A first imaging member can be worn on a person's wrist like a wrist watch. This first member can take pictures of the person's mouth. A second imaging member can be worn on a person's neck like a necklace. This second member takes pictures of the person's hand and a reachable food source.

3. Imaging Member that Faces Outward

In an example, at least one imaging member can be configured to have a focal direction which points outward from the surface of a person's body or clothing. In an example, an imaging member can point outward and/or downward from the surface of a person's body or clothing in order to capture images of nearby food. In an example, an imaging member can point outward and/or downward from the surface of a person's body or clothing in order to capture images of the interaction between a person's hand and food. In an example, an imaging member can point outward and/or upward from the surface of a person's body or clothing in order to capture images of a person's mouth. In an example, an imaging member can point outward and/or upward from the surface of a person's body or clothing in order to capture images of the interaction between a person's mouth and food conveyed by person's hand. In an example, an imaging member can have a focal direction which is substantially perpendicular to the longitudinal bones of a person's upper arm. In an example, the focal direction of an imaging member can be configured along a vector which: points outward from a person's wrist or arm; and which is substantially perpendicular to the surface of a person's arm and/or the longitudinal bones of a person's arm.

In an example, this invention can include a camera with a field of vision which extends outwards from the camera aperture and downwards toward a reachable food source. In an example, a reachable food source can be food on a plate. In an example, a reachable food source can be encompassed by the field of vision. In an example, a camera can be positioned on a person's wrist at a location from which it takes pictures along an imaging vector that is directed generally downward from the imaging member toward a reachable food source as the person eats. In an example, a camera can be positioned on a person's wrist at a location from which it takes pictures along an imaging vector that is directed generally upward from the imaging member toward the person's mouth as the person eats. In an example, a camera can have a field of vision which extends outwards from the camera aperture and upwards toward a person's mouth.

In an example, an imaging member can maintain a line of sight to one or both of a person's hands. In an example, an imaging member can scan for (and identify and maintain a line of sight to) a person's hand when one or more sensors indicate that the person is eating. In an example, an imaging member can scan for, acquire, and maintain a line of sight to a reachable food source when a sensor indicates that a person is probably eating. In an example, this invention can monitor the location of a person's mouth. In an example, this invention can monitor space around a person, especially space in the vicinity of the person's hand, to detect possible reachable food sources. In an example, this invention may only monitor the location of a person's mouth, or scan for possible reachable food sources, when one or more sensors indicate that the person is probably eating.

In an example, this invention can comprise at least two cameras or other imaging members. A first camera may be worn on a location on the human body from which it takes pictures along an imaging vector which points toward a person's mouth while the person eats. A second camera may be worn on a location on the human body from which it takes pictures along an imaging vector which points toward a reachable food source. In an example, a device may comprise two imaging members, or two cameras mounted on a single member, which are generally perpendicular to the longitudinal bones of the upper arm. In an example, one of these imaging members can have an imaging vector that points toward a food source at different times. In an example, another one of these imaging members may have an imaging vector that points toward the person's mouth at different times. In an example, these different imaging vectors may occur simultaneously as a body moves and/or food travels. In another example, these different imaging vectors may occur sequentially as a body moves and/or food travels. This device and method can provide images from multiple imaging vectors, such that these images from multiple perspectives are automatically and collectively analyzed to identify the types and quantities of food consumed by a person.

In an example, a camera that is used for identifying food can have a variable focal length. In an example, the imaging vector and/or focal distance of a camera can be actively and automatically adjusted to focus on: the person's hands, space surrounding the person's hands, a reachable food source, a food package, a menu, the person's mouth, and the person's face. In an example, in the interest of privacy, the focal length of a camera can be automatically adjusted in order to focus on food and not other people.

### 4. Spectroscopic Optical Sensor

In an example, the optical sensor can be a spectroscopic optical sensor. In an example, an optical sensor can be a spectroscopic optical sensor that collects data concerning the spectrum of light that is transmitted through and/or reflected from nearby food. In an example, an optical sensor can be selected from the group consisting of: spectroscopy sensor, spectrometry sensor, white light spectroscopy sensor, infrared spectroscopy sensor, near-infrared spectroscopy sensor, ultraviolet spectroscopy sensor, ion mobility spectroscopic sensor, mass spectrometry sensor, backscattering spectrometry sensor, and spectrophotometer. In an example, an optical sensor can analyze modulation of light wave parameters by the interaction of that light with a portion of food. In an example, an optical sensor can detect modulation of light reflected from, or absorbed by, a receptor when the receptor is exposed to food.

In an example, this invention can comprise a sensor selected from the group consisting of: accelerometer, inclinometer, motion sensor, pedometer, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor. In an example, an optical sensor can be a chromatographic sensor, spectrographic sensor, analytical chromatographic sensor, liquid chromatographic sensor, gas chromatographic sensor, optoelectronic sensor, photochemical sensor, and photocell.

In an example, this invention can identify a type of food by optically analyzing food. In an example, this invention can identify types and amounts of food by recording the effects of light that is interacted with food. In an example, this invention can identify the types and amounts of food consumed via spectroscopy. In an example, types of food, ingredients, and/or nutrients can be identified by the patterns of light that are reflected from, or absorbed by, food at different wavelengths. In an example, a light-based sensor can detect food consumption or can identify consumption of a specific food, ingredient, or nutrient based on the reflection of light from food or the absorption of light by food at different wavelengths. In an example, an optical sensor can detect whether food reflects light at a different wavelength than the wavelength of light shone on food. In an example, a light-based sensor can identify consumption of a selected type of food, ingredient, or nutrient with a spectral analysis sensor. In an example, this invention can comprise a light-based approach to food identification such as spectroscopy. In an example, an optical sensor can emit and/or detect white light, infrared light, or ultraviolet light.

In an example, this invention can comprise a sensor which collects information concerning the wavelength spectra of light reflected from, or absorbed by, food. In an example, this invention can comprise a sensor that identifies types of food, ingredients, or nutrients by detecting light reflection spectra, light absorption spectra, or light emission spectra. In an example, a spectral measurement sensor can be a spectroscopy sensor or a spectrometry sensor. In an example, a spectral measurement sensor can be a white light spectroscopy sensor, an infrared spectroscopy sensor, a near-infrared spectroscopy sensor, an ultraviolet spectroscopy sensor, an ion mobility spectroscopic sensor, a mass spectrometry sensor, a backscattering spectrometry sensor, or a spectrophotometer. In an example, light at different wavelengths can be absorbed by, or reflected off, food and the results can be analyzed in spectral analysis.

In an example, this invention can analyze the chemical composition of food by measuring the effects of the interaction between food and light energy. In an example, this interaction can comprise the degree of reflection or absorption of light by food at different light wavelengths. In an example, this interaction can include spectroscopic analysis. In an example, this invention can collect data that is used to analyze the chemical composition of food by measuring the absorption of light, sound, or electromagnetic energy by food that is in proximity to a person. In an example, this invention can collect data that is used to analyze the chemical composition of food by measuring the reflection of different wavelengths of light, sound, or electromagnetic energy by food that is in proximity to a person. In an example, this invention can comprise a sensor that identifies a selected type of food, ingredient, or nutrient by detecting light reflection spectra, light absorption spectra, or light emission spectra.

### 5. Outward-Facing Optical Sensor

In an example, an optical sensor can be configured to have a sensing direction which points outward from the surface of a person's body or clothing. In an example, an optical sensor can point outward and/or downward from the surface of a person's body or clothing in order to capture light transmitted through and/or reflected from nearby food. In an example, an optical sensor can have a sensing direction which is substantially perpendicular to the longitudinal bones of a person's upper arm. In an example, the sensing direction of an optical sensor can be configured along a vector which: points outward from a person's wrist or arm; and which is substantially perpendicular to the surface of a person's arm and/or the longitudinal bones of a person's arm.

In an example, this invention can collect data that is used to analyze the chemical composition of food by measuring the absorption of light, sound, or electromagnetic energy by food that is in proximity to the person whose consumption is being monitored. In an example, this invention can collect data that is used to analyze the chemical composition of food by measuring the reflection of different wavelengths of light, sound, or electromagnetic energy by food that is in proximity to the person whose consumption is being monitored. In an example, this invention can comprise a sensor which collects information concerning the wavelength spectra of light reflected from, or absorbed by, food.

### 6. Attachment Mechanisms

In an example, one or more attachment mechanisms can be selected from the group consisting of: arm band, bracelet, brooch, collar, cuff link, dog tags, ear ring, ear-mounted bluetooth device, eyeglasses, finger ring, headband, hearing aid, necklace, pendant, wearable mouth microphone, wrist band, and wrist watch. In an example, one or more attachment mechanisms can be selected from the group consisting of: wrist watch, wrist band, bracelet, arm band, necklace, pendant, brooch, collar, eyeglasses, ear ring, headband, or ear-mounted bluetooth device. In an example, one or more attachment mechanisms can be selected from the group consisting of: wrist watch, bracelet, finger ring, necklace, or ear ring. In an example, one or more attachment mechanisms can be selected from the group consisting of: necklace; pendant, dog tags; brooch; cuff link; ear ring; eyeglasses; wearable mouth microphone; and hearing aid.

In an example, one or more attachment mechanisms can be worn like a clothing accessory or piece of jewelry selected from the group consisting of: wristwatch, wristphone, wristband, bracelet, cufflink, armband, armlet, and finger ring; necklace, neck chain, pendant, dog tags, locket, amulet, necklace phone, and medallion; eyewear, eyeglasses, spectacles, sunglasses, contact lens, goggles, monocle, and visor; clip, tie clip, pin, brooch, clothing button, and pin-type button; headband, hair pin, headphones, ear phones, hearing aid, earring; and dental appliance, palatal vault attachment, and nose ring.

In an example, one or more attachment mechanisms can be worn like a piece of jewelry or accessory selected from the group consisting of: smart watch, wrist band, wrist phone, wrist watch, fitness watch, or other wrist-worn device; finger ring or artificial finger nail; arm band, arm bracelet, charm bracelet, or smart bracelet; smart necklace, neck chain, neck band, or neck-worn pendant; smart eyewear, smart glasses, electronically-functional eyewear, virtual reality eyewear, or electronically-functional contact lens; cap, hat, visor, helmet, or goggles; smart button, brooch, ornamental pin, clip, smart beads; pin-type, clip-on, or magnetic button; shirt, blouse, jacket, coat, or dress button; head phones, ear phones, hearing aid, ear plug, or ear-worn bluetooth device; dental appliance, dental insert, upper palate attachment or implant; tongue ring, ear ring, or nose ring; electronically-functional skin patch and/or adhesive patch; undergarment with electronic sensors; head band, hair band, or hair clip; ankle strap or bracelet; belt or belt buckle; and key chain or key ring.

In an example, a device or system for measuring a person's consumption of types of food, ingredients, and/or nutrients can take pictures of food using a device selected from the group consisting of: smart watch, smart bracelet, fitness watch, fitness bracelet, watch phone, bracelet phone, wrist band, or other wrist-worn device; arm bracelet; and smart ring or finger ring. In an example, a wearable sensor can be part of an electronically-functional wrist band or smart watch.

In an example, a device or system can be attached to a person's body or clothing. In an example, an attachment mechanism can be selected from the group consisting of: band, strap, chain, hook and eye fabric, ring, adhesive, bracelet, buckle, button, clamp, clip, elastic band, eyewear, magnet, necklace, piercing, pin, string, suture, tensile member, wrist band, and zipper. In an example, a device or system can be attached to a person or to a person's clothing by a means selected from the group consisting of: strap, clip, clamp, snap, pin, hook and eye fastener, magnet, and adhesive.

In an example, this invention can be worn on, or attached to, a person's body. In an example, this invention can be worn on, or attached to, a person's clothing. In an example, this invention can be incorporated into the creation of a specific article of clothing. In an example, this invention can be integrated into a specific article of clothing by a means selected from the group consisting of: adhesive, band, buckle, button, clip, elastic band, hook and eye fabric, magnet, pin, pocket, pouch, sewing, strap, tensile member, and zipper. In an example, a device for measuring a person's food consumption can be incorporated or integrated into an article of clothing or a clothing-related accessory.

In an example, a device or system can be worn on, or attached to, one or more parts of a person's body that are selected from the group consisting of: wrist (one or both), hand (one or both), or finger; neck or throat; eyes (directly such as via contact lens or indirectly such as via eyewear); mouth, jaw, lips, tongue, teeth, or upper palate; arm (one or both); waist, abdomen, or torso; nose; ear; head or hair; and ankle or leg. In various examples, a device can be incorporated or integrated into one of the following articles of clothing or clothing-related accessories: belt or belt buckle; neck tie; shirt or blouse; shoes or boots; underwear, underpants, briefs, undershirt, or bra; cap, hat, or hood; coat, jacket, or suit; dress or skirt; pants, jeans, or shorts; purse; socks; and sweat suit.

In an example, a device can have an unobtrusive, or even attractive, design like a piece of jewelry. In an example, a device for measuring a person's consumption of at least one selected type of food, ingredient, or nutrient can be worn in a manner similar to a piece of jewelry or accessory. In an example, a wearable sensor can be part of an electronically-functional adhesive patch that can be worn on a person's skin.

### 7. Image-Analyzing Member and Methods of Image Analysis

In an example, the image-analyzing member can be a data control unit. In an example, the image-analyzing member can be selected from the group consisting of: a data control unit, a data processing unit, a data analysis component, a Central Processing Unit (CPU), and a microprocessor. In an example, an image-analyzing member can analyze pictures or images of food taken by an imaging member in order to estimate types and amounts of foods, ingredients, nutrients, and/or calories. In an example, this invention can comprise a data analysis component, wherein this component analyzes pictures of food taken by an imaging member to estimate types and amounts of foods, ingredients, nutrients, and/or calories.

In an example, an image-analyzing member and/or a data control unit can comprise one or more components selected from the group consisting of: a data processing unit, data analysis component, Central Processing Unit (CPU), or microprocessor; a food-consumption monitoring component (motion sensor, electromagnetic sensor, optical sensor, and/or chemical sensor); a graphic display component (display screen and/or coherent light projection); a human-to-computer communication component (speech recognition, touch screen, keypad or buttons, and/or gesture recognition); a memory component (flash, RAM, or ROM); a power source and/or power-transducing component; a time keeping and display component; and a wireless data transmission and reception component.

In an example, a image-analyzing member and/or a data control unit can comprise one or more components selected from the group consisting of: a food-consumption monitor or food-identifying sensor; a central processing unit (CPU) such as a microprocessor; a database of different types of food and food attributes; a memory to store, record, and retrieve data such as the cumulative amount consumed for at least one selected type of food, ingredient, or nutrient; a communications member to transmit data to from external sources and to receive data from external sources; a power source such as a battery or power transducer; a human-to-computer interface such as a touch screen, keypad, or voice recognition interface; and a computer-to-human interface such as a display screen or voice-producing interface.

In an example, this invention can further comprise one or more components selected from the group consisting of: a data processing unit, data analysis component, Central Processing Unit (CPU), or microprocessor; a food-consumption monitoring component (motion sensor, electromagnetic sensor, optical sensor, and/or chemical sensor); a graphic display component (display screen and/or coherent light projection); a human-to-computer communication component (speech recognition, touch screen, keypad or buttons, and/or gesture recognition); a memory component (flash, RAM, or ROM); a power source and/or power-transducing component; a time keeping and display component; and a wireless data transmission and reception component.

In an example, this invention can further comprise one or more components selected from the group consisting of: a food-consumption monitor or food-identifying sensor; a central processing unit (CPU) such as a microprocessor; a database of different types of food and food attributes; a memory to store, record, and retrieve data such as the cumulative amount consumed for at least one selected type of food, ingredient, or nutrient; a communications member to transmit data to from external sources and to receive data from external sources; a power source such as a battery or power transducer; a human-to-computer interface such as a touch screen, keypad, or voice recognition interface; and a computer-to-human interface such as a display screen or voice-producing interface.

In an example, an image-analyzing member and/or a data control unit can be part of a wearable device or can be the wearable component of a system. In an example, data concerning food consumption that is collected by a wearable device can be analyzed by an image-analyzing member and/or a data control unit within the wearable device in order to identify the types and amounts of foods, ingredients, or nutrients that a person consumes. In another example, an image-analyzing member and/or a data control unit can be in a remote location and in wireless communication to receive data from a wearable device or the wearable component of a system.

In an example, automated identification of types of food based on images and/or automated association of selected types of ingredients or nutrients with that food can occur within a wearable device. In an example, data collected by a wearable device can be transmitted to an external device wherein automated identification occurs and the results can then be transmitted back to the wearable device. In an example, food image information can be transmitted from a wearable device to a remote location wherein automatic food identification occurs and the results can be transmitted back to the wearable device. In another example, data concerning food consumption that is collected by a wearable device can be transmitted to an external device or system for analysis at a remote location. In an example, pictures of food can be transmitted to an external device or system for food identification at a remote location. In an example, chemical analysis results can be transmitted to an external device or system for food identification at a remote location. In an example, the results of analysis at a remote location can be transmitted back to a wearable device.

In an example, a food-consumption monitoring and nutrient identifying system can include a component that is selected from the group consisting of: smart phone, mobile phone, cell phone, or application of such a phone; electronic tablet, other flat-surface mobile electronic device, Personal Digital Assistant (PDA), or laptop; digital camera; and smart eyewear, electronically-functional eyewear, or augmented reality eyewear. In an example, such a component can be in wireless communication with another component of such a system. In an example, a device for measuring food consumption can be in wireless communication with an external device selected from the group consisting of: internet portal; smart phone, mobile phone, cell phone, or application of such a phone; electronic tablet, other flat-surface mobile electronic device, Personal Digital Assistant (PDA), remote control unit, or laptop; smart eyewear, electronically-functional eyewear, or augmented reality eyewear; electronic store display, electronic restaurant menu, or vending machine; and desktop computer, television, or mainframe computer. In an example, a device, method, or system for detecting food consumption or measuring consumption of a selected type of food, ingredient, or nutrient can include integration with a general-purpose mobile device that is used to collects data concerning food consumption. In an example, a component of such a system can be a general purpose device, of which collecting data for food identification is only one among many functions that it performs.

In an example, an imaging member and an optical sensor can be in wireless communication with each other or other devices. In an example, a device or system for measuring a person's consumption of types of food, ingredients, or nutrients can include one or more communications components for wireless transmission and reception of data. In an example, multiple communications components can enable wireless communication (including data exchange) between separate components of such a device and system. In an example, a communications component can enable wireless communication with an external device or system. In various examples, the means of this wireless communication can be selected from the group consisting of: radio transmission, Bluetooth transmission, Wi-Fi, and infrared energy.

In an example, food can be identified directly by wireless information received from a food display, RFID tag, electronically-functional restaurant menu, or vending machine. In an example, food or its nutritional composition can be identified directly by wireless transmission of information from a food display, menu, food vending machine, food dispenser, or other point of food selection or sale and a device that is worn, held, or otherwise transported with a person. In various examples, a device can receive food-identifying information from a source selected from the group consisting of: electromagnetic transmissions from a food display or RFID food tag in a grocery store, electromagnetic transmissions from a physical menu or virtual user interface at a restaurant, and electromagnetic transmissions from a vending machine. With respect to meals ordered at restaurants, some restaurants (especially fast-food restaurants) have standardized menu items with standardized food ingredients. In such cases, identification of types and amounts of food, ingredients, or nutrients can be conveyed at the point of ordering (via an electronically-functional menu) or purchase (via purchase transaction).

In an example, a device and system for measuring a person's consumption of at least one selected type of food, ingredient, or nutrient can identify and track food consumption at the point of selection or point of sale. In an example, a device or system for monitoring food consumption or consumption of selected types of food, ingredients, or nutrients can approximate such measurements by tracking a person's food selections and purchases at a grocery store, at a restaurant, or via a vending machine. In an example, such tracking can be done with specific methods of payment, such as a credit card or bank account. In an example, such tracking can be done with electronically-functional food identification means such as bar codes, RFID tags, or electronically-functional restaurant menus. Electronic communication for food identification can also occur between a food-consumption monitoring device and a vending machine.

In various examples, food may be identified by pattern recognition of food itself, by recognition of words on food packaging or containers, by recognition of food brand images and logos, or by recognition of product identification codes (such as “bar codes”). In an example, a device for measuring a person's consumption of at least one selected type of food, ingredient, or nutrient can identify food using information from a food's packaging or container. In an example, food can be identified directly by automated recognition of information on food packaging, such as a logo, label, or barcode. In various examples, information on a food's packaging or container that is used to identify the type and/or amount of food can be selected from the group consisting of: bar code, food logo, food trademark design, nutritional label, optical text recognition, and UPC code. Food can be identified by scanning a barcode or other machine-readable code on the food's packaging (such as a Universal Product Code or European Article Number), on a menu, on a store display sign, or otherwise in proximity to food at the point of food selection, sale, or consumption. In an example, the type of food (and/or specific ingredients or nutrients within the food) can be identified by machine-recognition of a food label, nutritional label, or logo on food packaging, menu, or display sign.

In an example, a device for measuring types of food, ingredients, or nutrients can identify the types and amounts of food in an automated manner based on analyzing pictures or images of that food. In an example, identification of the types and quantities of foods, ingredients, or nutrients from pictures or images of food can be a combination of, or interaction between, automated food identification methods and human-based food identification methods. In an example, this invention can identify and track the selected types and amounts of foods, ingredients, or nutrients in an entirely automatic manner. In an example, such identification can occur in a partially automatic manner in which there is interaction between automated and human identification methods.

In an example, methods for automatic identification of food types and amounts from food pictures can include: color analysis, image pattern recognition, image segmentation, texture analysis, three-dimensional modeling based on pictures from multiple perspectives, and volumetric analysis based on a fiducial marker or other object of known size. In an example, this invention can use one or more methods to analyze pictures of images of food wherein these methods are selected from the group consisting of: 3D modeling, bar code recognition or identification, changes in food at a reachable food source, face recognition or identification, food recognition or identification, gesture recognition or identification, human motion recognition or identification, logo recognition or identification, pattern recognition or identification, number of cycles of food moving along a food consumption pathway, and word recognition or identification. In an example, images of a person's mouth and a reachable food source may be taken from at least two different perspectives in order to enable the creation of three-dimensional models of food.

In example, this invention can comprise one or more image-analyzing members that analyze one or more factors selected from the group consisting of: number and type of reachable food sources; changes in the volume of food observed at a reachable food source; number and size of chewing movements; number and size of swallowing movements; number of times that pieces (or portions) of food travel along the food consumption pathway; and size of pieces (or portions) of food traveling along the food consumption pathway. In various examples, one or more of these factors may be used to analyze images to estimate the types and quantities of food consumed by a person. In example, this invention can comprise one or more image-analyzing members that analyze one or more factors selected from the group consisting of: one or more factors selected from the group consisting of: number of reachable food sources; types of reachable food sources; changes in the volume of food at a reachable food source; number of times that the person brings food to their mouth; sizes of portions of food that the person brings to their mouth; number of chewing movements; frequency or speed of chewing movements; and number of swallowing movements.

In an example, this invention can use one or more methods to analyze pictures of images of food wherein these methods are selected from the group consisting of: image attribute adjustment or normalization; inter-food boundary determination and food portion segmentation; image pattern recognition and comparison with images in a food database to identify food type; comparison of a vector of food characteristics with a database of such characteristics for different types of food; scale determination based on a fiducial marker and/or three-dimensional modeling to estimate food quantity; and association of selected types and amounts of ingredients or nutrients with selected types and amounts of food portions based on a food database that links common types and amounts of foods with common types and amounts of ingredients or nutrients.

In an example, this invention can use one or more methods to analyze pictures of images of food wherein these methods are selected from the group consisting of: analysis of variance (ANOVA), Chi-squared analysis, cluster analysis, color and texture analysis, comparison of a vector of food parameters with a food database containing such parameters, comparison with food images with food images in a food database, energy balance tracking, factor analysis, food portion segmentation, Fourier transformation and/or fast Fourier transform (FFT), image attribute adjustment or normalization, image pattern recognition, image segmentation, inter-food boundary determination, linear discriminant analysis, linear regression, logistic regression, multivariate linear regression, neural network and machine learning, non-linear programming, pattern recognition, principal components analysis, probit analysis, scale determination using a physical or virtual fiducial marker, survival analysis, three-dimensional modeling, time series analysis, volumetric analysis based on a fiducial marker or other object of known size, and volumetric modeling.

In an example, this invention can take multiple still pictures or moving video pictures of food. In an example, this invention can take multiple pictures of food from different angles in order to perform three-dimensional analysis or modeling of the food to better determine the volume of food. In an example, this invention can take multiple pictures of food from different angles in order to better control for differences in lighting and portions of food that are obscured from some perspectives. In an example, this invention can take multiple pictures of food from different angles in order to perform three-dimensional modeling or volumetric analysis to determine the three-dimensional volume of food in the picture. In an example, volume estimation can include obtaining video images of food or multiple still pictures of food in order to obtain pictures of food from multiple perspectives. In an example, pictures of food from multiple perspectives can be used to create three-dimensional or volumetric models of that food in order to estimate food volume. In an example, multiple pictures of food from different angles can enable three-dimensional modeling of food volume.

In an example, this invention can comprise two or more imaging members wherein a first imaging member is pointed toward a person's mouth most of the time, as the person moves their arm to move food, and wherein a second imaging member is pointed toward a reachable food source most of the time, as the person moves their arm to move food. In an example, this invention can comprise one or more imaging members wherein: a first imaging member points toward a person's mouth at least once as the person brings a piece (or portion) of food to their mouth from a reachable food source; and a second imaging member points toward the reachable food source at least once as the person brings a piece (or portion) of food to their mouth from the reachable food source.

In an example, this invention can further comprise a locally or remotely housed food database. In an example, a food database can be used to identify food types and quantify food amounts. In an example, a device can collect food images that are automatically associated with images of food in a food database for food identification. In an example, analysis of images can occur in real time, as a person is consuming food. In an example, analysis of images by this device and method can occur after a person has consumed food.

In an example, a food database can include one or more elements selected from the group consisting of: food name, food picture (individually or in combinations with other foods), food color, food shape, food texture, food type, food packaging bar code or nutritional label, food packaging or logo pattern, common geographic or intra-building locations for serving or consumption, common or standardized ingredients (per serving, per volume, or per weight), common or standardized number of calories (per serving, per volume, or per weight), common or standardized nutrients (per serving, per volume, or per weight), common or standardized size (per serving), common times or special events for serving or consumption, and commonly associated or jointly-served foods.

The concepts of food identification, ingredient identification, and nutrient identification are closely related. Various embodiments of this invention can identify specific ingredients or nutrients indirectly (through food identification and use of a database) or directly (through the use of nutrient-specific sensors such as a spectroscopic optical sensor). In an example, a food database can be used to link common types and quantities of ingredients or nutrients with common types and quantities of food. In an example, types and quantities of ingredients and/or nutrients can be estimated indirectly using a database that links common types and amounts of food with common types and amounts of ingredients or nutrients. In an example, this invention can directly identify types and quantities of ingredients and/or nutrients. The latter does not rely on estimates from a database, but does require ingredient-specific or nutrient-specific sensors (such as a spectroscopic optical sensor).

In an example, the amount of a specific ingredient or nutrient within (a portion of) food can be measured directly by a sensing mechanism. In an example, the amount of a specific ingredient or nutrient within (a portion of) food can be estimated indirectly by measuring the amount of food and then linking this amount of food to amounts of ingredients or nutrients using a database that links specific foods with standard amounts of ingredients or nutrients. In an example, specific ingredients or nutrients that are associated with selected types of food can be estimated based on a database linking foods to ingredients and nutrients.

In an example, a device, method, or system for measuring a person's consumption of at least one selected type of food, ingredient, or nutrient can identify and track a person's food consumption at the point of consumption. In an example, such a device, method, or system can include a database of different types of food. In an example, such a device, method, or system can be in wireless communication with an externally-located database of different types of food. In an example, such a database of different types of food and their associated attributes can be used to help identify selected types of food, ingredients, or nutrients. In an example, a database of attributes for different types of food can be used to associate types and amounts of specific ingredients, nutrients, and/or calories with selected types and amounts of food.

In an example, a food database can be used to identify the amount of calories that are associated with an identified type and amount of food. In an example, a food database can be used to identify the type and amount of at least one selected type of food that a person consumes. In an example, a food database can be used to identify the type and amount of at least one selected type of ingredient that is associated with an identified type and amount of food. In an example, a food database can be used to identify the type and amount of at least one selected type of nutrient that is associated with an identified type and amount of food. In an example, an ingredient or nutrient can be associated with a type of food on a per-portion, per-volume, or per-weight basis.

In an example, for some foods with standardized sizes (such as foods that are manufactured in standard sizes at high volume), food weight can be estimated as part of food identification. In an example, information concerning the weight of food consumed can be linked to nutrient quantities in a computer database in order to estimate cumulative consumption of selected types of nutrients. In an example, a food database can also include average amounts of specific ingredients and/or nutrients associated with specific types and amounts of foods for measurement of at least one selected type of ingredient or nutrient. In an example, a food database can be used to identify the type and amount of at least one selected type of ingredient that is associated with an identified type and amount of food.

In an example, attributes of food in an image can be represented by a multi-dimensional food attribute vector. In an example, this food attribute vector can be statistically compared to the attribute vector of known foods in order to automate food identification. In an example, multivariate analysis can be done to identify the most likely identification category for a particular portion of food in an image. In an example, automatic identification of food amounts and types can include extracting a vector of food parameters (such as color, texture, shape, and size) from a food picture and comparing this vector with vectors of these parameters in a food database. In various examples, a multi-dimensional food attribute vector can include attributes selected from the group consisting of: food color; food texture; food shape; food size or scale; geographic location of selection, purchase, or consumption; timing of day, week, or special event; common food combinations or pairings; image brightness, resolution, or lighting direction; infrared light reflection; spectroscopic analysis; and person-specific historical eating patterns.

In an example, images of food can be automatically analyzed in order to identify types and quantities of food. In an example, pictures of food taken by a camera or other picture-taking device can be automatically analyzed to estimate the types and amounts of food, ingredients, or nutrients. In an example, an initial stage of an image analysis system can comprise adjusting, normalizing, or standardizing image elements for better food segmentation, identification, and volume estimation. In an example, a device can identify specific foods from pictures or images by image segmentation, color analysis, texture analysis, and pattern recognition.

In an example, there can be a preliminary stage of processing or analysis of food pictures wherein image elements and/or attributes are adjusted, normalized, or standardized. In an example, a food picture can be adjusted, normalized, or standardized before it is compared with food pictures in a food database. This can improve segmentation of a meal into different types of food, identification of foods, and estimation of food volume or mass.

In an example, food lighting or shading can be adjusted, normalized, or standardized before comparison with pictures in a food database. In an example, food size or scale can be adjusted, normalized, or standardized before comparison with pictures in a food database. In an example, food texture can be adjusted, normalized, or standardized before comparison with pictures in a food database. In various examples a preliminary stage of food picture processing and/or analysis can include adjustment, normalization, or standardization based on one or more factors selected from the group consisting of: adjacent foods, context, food color, food shape, food size, food texture, food texture, geographic location, image brightness, image resolution, light angle, place setting context, scale, and temperature (infrared).

In an example, analysis of food images can include the step of automatically segmenting regions of a food image into different types or portions of food. In an example, a picture of a meal as a whole can be automatically segmented into portions of different types of food for comparison with different types of food in a food database. In an example, this invention can automatically identify boundaries between different types of food in an image that contains multiple types or portions of food. In an example, the creation of boundaries between different types of food and/or segmentation of a meal into different food types can include edge detection, shading analysis, texture analysis, and three-dimensional modeling. In an example, this process can also be informed by common patterns of jointly-served foods and common boundary characteristics of such jointly-served foods.

In an example, an imaging device can take pictures of food at different times, such as before and after an eating event, in order to better determine how much food the person actually ate (as compared to the amount of food served or nearby). In an example, pictures of food at different times (such as before and after a meal) can enable estimation of the amount of proximal food that is actually consumed vs. just being served in proximity to the person. In an example, changes in the volume of food in sequential pictures before and after consumption can be compared to the cumulative volume of food conveyed to a person's mouth to determine a more accurate estimate of food volume consumed.

In an example, a method for measuring a person's consumption of types of food, ingredients, or nutrients can include monitoring changes in the volume or weight of food at a reachable location near the person. In an example, pictures of food can be taken at multiple times before, during, and after food consumption in order to better estimate the amount of food that the person actually consumes, which can differ from the amount of food served to the person or the amount of food left over after the person eats. In an example, estimates of the amount of food that the person actually consumes can be made by digital image subtraction and/or 3D modeling. In an example, changes in the volume or weight of nearby food can be correlated with hand motions in order to estimate the amount of food that a person actually eats. In an example, a device can track the cumulative number of hand-to-mouth motions, number of chewing motions, or number of swallowing motions.

In an example, this invention can collect data that enables tracking the cumulative amount of foods, ingredients, and/or nutrients which a person consumes during a period of time (such as an hour, day, week, or month) or during a particular eating event. In an example, the time boundaries of a particular eating event can be defined by a maximum time between chews or mouthfuls during a meal and/or a minimum time between chews or mouthfuls between meals. In an example, the time boundaries of a particular eating event can be defined by Fourier Transformation analysis of the variable frequencies of chewing, swallowing, or biting during meals vs. between meals.

In an example, a standard or target cumulative amount of food, ingredient, or nutrient consumption can be selected from the group consisting of: daily recommended minimum amount; daily recommended maximum amount or allowance; weekly recommended minimum amount; weekly recommended maximum amount or allowance; target amount to achieve a health goal; and maximum amount or allowance per meal. In an example, a standard amount can be a Reference Daily Intake (RDI) value or a Daily Reference Value.

In an example, analysis of cumulative food consumption can include comparison of food consumption parameters between a specific person and a reference population. In an example, data analysis can include analysis of a person's food consumption patterns over time. In an example, such analysis can track the cumulative amount of at least one selected type of food, ingredient, or nutrient that a person consumes during a selected period of time. In an example, an amount of a selected type of food, ingredient, or nutrient consumed can be expressed as an absolute amount. In an example, an amount of a selected type of food, ingredient, or nutrient consumed can be expressed as a percentage of a standard amount.

In an example, a target amount of cumulative food, ingredient, or nutrient consumption can be based on one or more factors selected from the group consisting of: the selected type of selected food, ingredient, or nutrient; amount of this type recommended by a health care professional or governmental agency; specificity or breadth of the selected nutrient type; the person's age, gender, and/or weight; the person's diagnosed health conditions; the person's exercise patterns and/or caloric expenditure; the person's physical location; the person's health goals and progress thus far toward achieving them; one or more general health status indicators; magnitude and/or certainty of the effects of past consumption of the selected nutrient on the person's health; the amount and/or duration of the person's consumption of healthy food or nutrients; changes in the person's weight; time of day; day of the week; occurrence of a holiday or other occasion involving special meals; dietary plan created for the person by a health care provider; input from a social network and/or behavioral support group; input from a virtual health coach; health insurance copay and/or health insurance premium; financial payments, constraints, and/or incentives; cost of food; speed or pace of nutrient consumption; and accuracy of a sensor in detecting the selected nutrient.

In an example, this invention can include a computer-to-human interface. In an example, a computer-to-human interface can provide information and/or feedback to a person wearing a device, wherein the person's food consumption and/or nutritional intake is changed if the person volitionally changes their food consumption behavior based on this information and/or feedback. In an example, this invention can provide information and/or feedback concerning food consumption to a person. In an example, a computer-to-human interface can communicate information about the types and amounts of food that a person has consumed, should consume, or should not consume. In an example, a computer-to-human interface can provide feedback to a person concerning their eating habits and the effects of those eating habits.

In an example, this invention can provide information and/or feedback to a person that is selected from the group consisting of: feedback concerning food consumption (such as types and amounts of foods, ingredients, and nutrients consumed, calories consumed, calories expended, and net energy balance during a period of time); information about good or bad ingredients in nearby food; information concerning financial incentives or penalties associated with acts of food consumption and achievement of health-related goals; information concerning progress toward meeting a weight, energy-balance, and/or other health-related goal; information concerning the calories or nutritional components of specific food items; and number of calories consumed per eating event or time period.

Information from this invention can be combined with a computer-to-human interface that provides feedback to encourage the person to eat healthy foods and to limit excess consumption of unhealthy foods. In order to be really useful for achieving good nutrition and health goals, a device, system, and method for measuring food consumption should differentiate between a person's consumption of healthy foods versus unhealthy foods. A device, system, or method can monitor a person's eating habits to encourage consumption of healthy foods and to discourage excess consumption of unhealthy foods.

In an example, this invention can provide information and/or feedback concerning the types and quantities of nearby food. In an example, this invention can provide information and/or feedback on the types and quantities of ingredients or nutrients in nearby food. In an example, this invention can provide a person with information and/or feedback on the types and quantities of food that the person is consuming. In an example, this invention can provide a person with information and/or feedback on the types and quantities ingredients or nutrients in food that the person is consuming. In an example, this invention can provide a person with information and/or feedback on their cumulative consumption types of food, ingredients, or nutrients.

In an example, this invention can track the cumulative amount of a food, ingredient, or nutrient consumed by the person and provide feedback to the person based on the person's cumulative consumption relative to a target amount. In an example, this invention can provide negative feedback when a person exceeds a target amount of cumulative consumption. In an example, a device and system can sound an alarm or provide other real-time feedback to a person when the consumed amount of a selected type of food, ingredient, or nutrient exceeds an allowable amount (in total, per meal, or per unit of time).

Information from a food-consumption monitoring device that measures a person's consumption of at least one selected type of food, ingredient, and/or nutrient can also be combined with a computer-to-human interface that provides feedback to encourage the person to eat healthy foods and to limit excess consumption of unhealthy foods. In an example, capability for monitoring food consumption can be combined with capability for providing behavior-modifying feedback within a single device. In an example, a single device can be used to measure the selected types and amounts of foods, ingredients, and/or nutrients that a person consumes and to provide visual, auditory, tactile, or other feedback to encourage the person to eat in a healthier manner.

In an example, this invention can provide information and/or feedback to a person that is selected from the group consisting of: augmented reality feedback (such as virtual visual elements superimposed on foods within a person's field of vision); changes in a picture or image of a person reflecting the likely effects of a continued pattern of food consumption; display of a person's progress toward achieving energy balance, weight management, dietary, or other health-related goals; graphical display of foods, ingredients, or nutrients consumed relative to standard amounts (such as embodied in pie charts, bar charts, percentages, color spectrums, icons, emoticons, animations, and morphed images); graphical representations of food items; graphical representations of the effects of eating particular foods; information on a computer display screen (such as a graphical user interface); lights, pictures, images, or other optical feedback; touch screen display; and visual feedback through electronically-functional eyewear. In an example, an amount of a selected type of food, ingredient, or nutrient consumed can be displayed as a portion of a standard amount such as in a bar chart, pie chart, thermometer graphic, or battery graphic.

In an example, a computer-to-human interface of this invention can be used to not just provide information concerning eating behavior, but also to actively change eating behavior, nutritional intake, and/or nutritional absorption. In an example, this invention can be in wireless communication with a separate feedback device that modifies the person's nutritional intake. In an example, this invention can deliver neural stimulation (or be in wireless communication with a separate device which delivers neural stimulation) in order to modify a person's nutritional intake. In an example, this invention can create a phantom taste or smell (or be in wireless communication with a separate device which creates a phantom taste or smell) in order to modify a person's nutritional intake. In an example, this invention can exert pressure (or be in wireless communication with a separate device which exerts pressure) in order to modify a person's nutritional intake.

In an example, this invention can include a computer-to-human interface that is selected from the group consisting of: auditory feedback (such as a voice message, alarm, buzzer, ring tone, or song); feedback via computer-generated speech; mild external electric charge or neural stimulation; periodic feedback at a selected time of the day or week; phantom taste or smell; phone call; pre-recorded audio or video message by the person from an earlier time; television-based messages; and tactile, vibratory, or pressure-based feedback. In another example, a computer-to-human interface can comprise one or more mechanisms which actively change a person's food consumption and/or nutritional intake from consumed food.

In an example, this invention can engage other people as well as the person wearing the device. In an example, this invention can provide feedback selected from the group consisting of: advice concerning consumption of specific foods or suggested food alternatives (such as advice from a dietician, nutritionist, nurse, physician, health coach, other health care professional, virtual agent, or health plan); electronic verbal or written feedback (such as phone calls, electronic verbal messages, or electronic text messages); live communication from a health care professional; questions to the person that are directed toward better measurement or modification of food consumption; real-time advice concerning whether to eat specific foods and suggestions for alternatives if foods are not healthy; social feedback (such as encouragement or admonitions from friends and/or a social network); suggestions for meal planning and food consumption for an upcoming day; and suggestions for physical activity and caloric expenditure to achieve desired energy balance outcomes.

In an example, this invention can also include a human-to-computer interface for communication from a human to a computer. This human-to-computer interface can be selected from the group consisting of: speech recognition or voice recognition interface; touch screen or touch pad; physical keypad/keyboard, virtual keypad or keyboard, control buttons, or knobs; gesture recognition interface; motion recognition clothing; eye movement detector, smart eyewear, and/or electronically-functional eyewear; head movement tracker; conventional flat-surface mouse, 3D blob mouse, track ball, or electronic stylus; graphical user interface, drop down menu, pop-up menu, or search box; and neural interface or EMG sensor.

In an example, this invention can further comprise a power source that is selected from the group consisting of: power from a power source that is internal to a device during regular operation (such as an internal battery, capacitor, energy-storing microchip, or wound coil or spring); power that is obtained, harvested, or transduced from a power source other than the person's body that is external to the device (such as a rechargeable battery, electromagnetic inductance from external source, solar energy, indoor lighting energy, wired connection to an external power source, ambient or localized radiofrequency energy, or ambient thermal energy); and power that is obtained, harvested, or transduced from the person's body (such as kinetic or mechanical energy from body motion, electromagnetic energy from the person's body, blood flow or other internal fluid flow, glucose metabolism, or thermal energy from the person's body).

In addition to at least one imaging member (e.g. camera) and optical sensor (e.g. spectroscopic optical sensor), this invention can also comprise one or more sensors selected from the group consisting of: accelerometer (single or multiple axis), chemical sensor, chewing sensor, cholesterol sensor, electrogoniometer or strain gauge, electromagnetic sensor, EMG sensor, glucose sensor, infrared sensor, miniature microphone, motion sensor, pulse sensor, skin galvanic response (Galvanic Skin Response) sensor, sodium sensor, sound sensor, speech recognition sensor, swallowing sensor, temperature sensor, thermometer, and ultrasound sensor.

### 8. Quantifying Close Proximity

In an example, close proximity can be defined as being less than three inches away. In an example, close proximity can be defined as being less than six inches away from the surface of a person's body. In an example, close proximity can be defined as being less than one inch away from the surface of a person's body.

9. Imaging Member on the Wrist, Finger, Hand, and/or Arm

In an example, one or more attachment mechanisms can be configured to hold at least one imaging member in close proximity to a person's wrist, finger, hand, and/or arm. In an example, this invention can comprise one or more imaging members worn on a body member selected from the group consisting of: wrist, hand, finger, upper arm, and lower arm. In various examples, one or more attachment mechanisms can be selected from the group consisting of: wrist watch; bracelet; arm band; and finger ring.

In an example, this device and method can comprise an imaging member that is worn on a person's finger in a manner similar to wearing a finger ring, such that the imaging member automatically takes pictures of the person's mouth, a reachable food source, or both as the person moves their arm and hand as the person eats. In an example, a device or system can be worn on, or attached to, one or more parts of a person's body that are selected from the group consisting of: wrist (one or both), hand (one or both), or finger; neck or throat; eyes (directly such as via contact lens or indirectly such as via eyewear); mouth, jaw, lips, tongue, teeth, or upper palate; arm (one or both); waist, abdomen, or torso; nose; ear; head or hair; and ankle or leg.

10. Imaging Member on or within a Wrist Band, Bracelet, and/or Smart Watch

In an example, one or more attachment mechanisms can comprise a wrist band, bracelet, and/or smart watch which is configured to hold at least one imaging member on a person's wrist. In an example, one or more imaging members can be integrated into one or more wearable members that appear similar to a wrist watch, wrist band, bracelet, arm band, necklace, pendant, brooch, collar, eyeglasses, ear ring, headband, or ear-mounted bluetooth device. In an example, one or more attachment mechanisms can be selected from the group consisting of: wrist watch; bracelet; arm band; and finger ring. In an example, this invention can comprise one or more imaging members that are worn in a manner similar to a wearable member selected from the group consisting of: wrist watch; bracelet; arm band; and finger ring. In an example, an imaging member can be a smart watch.

In an example, a device and system for measuring a person's consumption of at least one selected type of food, ingredient, or nutrient can take pictures of food using a device selected from the group consisting of: smart watch, smart bracelet, fitness watch, fitness bracelet, watch phone, bracelet phone, wrist band, or other wrist-worn device; arm bracelet; and smart ring or finger ring. In an example, a device can look similar to an attractive wrist watch, bracelet, finger ring, necklace, or ear ring. In an example, a device or system can be worn on, or attached to, one or more parts of a person's body that are selected from the group consisting of: wrist (one or both), hand (one or both), or finger; neck or throat; eyes (directly such as via contact lens or indirectly such as via eyewear); mouth, jaw, lips, tongue, teeth, or upper palate; arm (one or both); waist, abdomen, or torso; nose; ear; head or hair; and ankle or leg.

In an example, a device can comprise two imaging members. A first imaging member can be worn on a person's wrist like a wrist watch. In an example, two cameras can be worn on the narrow sides of a person's wrist, between the posterior and anterior surfaces of the wrist, such that the moving field of vision from the first of these cameras automatically encompasses the person's mouth (as the person moves their arm when they eat) and the moving field of vision from the second of these cameras automatically encompasses the reachable food source (as the person moves their arm when they eat). This embodiment of the invention is comparable to a (conventional) wrist-watch that has been rotated 90 degrees around the person's wrist, with a first camera located where the watch face would be and a second camera located on the opposite side of the wrist.

In an example, a device for measuring a person's consumption can be worn in a manner similar to a piece of jewelry or accessory selected from the group consisting of: smart watch, wrist band, wrist phone, wrist watch, fitness watch, or other wrist-worn device; finger ring or artificial finger nail; arm band, arm bracelet, charm bracelet, or smart bracelet; smart necklace, neck chain, neck band, or neck-worn pendant; smart eyewear, smart glasses, electronically-functional eyewear, virtual reality eyewear, or electronically-functional contact lens; cap, hat, visor, helmet, or goggles; smart button, brooch, ornamental pin, clip, smart beads; pin-type, clip-on, or magnetic button; shirt, blouse, jacket, coat, or dress button; head phones, ear phones, hearing aid, ear plug, or ear-worn bluetooth device; dental appliance, dental insert, upper palate attachment or implant; tongue ring, ear ring, or nose ring; electronically-functional skin patch and/or adhesive patch; undergarment with electronic sensors; head band, hair band, or hair clip; ankle strap or bracelet; belt or belt buckle; and key chain or key ring.

### 11. Imaging Member on the Anterior/Palmar/Lower Side or a Lateral/Narrow Side of the Wrist

In an example, one or more attachment mechanisms can comprise a wrist band, bracelet, and/or smart watch which is configured to hold at least one imaging member on the anterior/palmar/lower side or a lateral/narrow side of a person's wrist for imaging nearby food. In an example, this device can comprise a camera that is worn on the anterior surface of a person's wrist or upper arm, in a manner similar to wearing a (conventional) watch or bracelet that is rotated approximately 180 degrees. In another example, this device can comprise an imaging member with a camera that is worn on the narrow side of a person's wrist or upper arm, in a manner similar to wearing a (conventional) watch or bracelet that is rotated approximately 90 degrees.

In an example, a device can have two cameras attached to a wrist band on opposite (narrow) sides of the person's wrist. In an example, two cameras can be worn on the narrow sides of a person's wrist, between the posterior and anterior surfaces of the wrist. This embodiment of the invention is comparable to a (conventional) wrist-watch that has been rotated 90 degrees around the person's wrist, with a first camera located where the (conventional) watch face would be and a second camera located on the opposite side of the wrist.

### 12. Imaging Member Around the Neck or on the Head

In an example, one or more attachment mechanisms can be configured to hold at least one imaging member in close proximity to a person's neck or head. In an example, a system and device can include one or more imaging members that are worn on a body member selected from the group consisting of: neck; head; and torso. In an example, a device or system can be worn on, or attached to, one or more parts of a person's body that are selected from the group consisting of: wrist (one or both), hand (one or both), or finger; neck or throat; eyes (directly such as via contact lens or indirectly such as via eyewear); mouth, jaw, lips, tongue, teeth, or upper palate; arm (one or both); waist, abdomen, or torso; nose; ear; head or hair; and ankle or leg.

13. Imaging Member on or within a Necklace

In an example, one or more attachment mechanisms can comprise a neck-encircling member which is configured to hold at least one imaging member in proximity to a person's neck. In an example, one or more imaging members can be integrated into one or more wearable members that appear similar to a wrist watch, wrist band, bracelet, arm band, necklace, pendant, brooch, collar, eyeglasses, ear ring, headband, or ear-mounted bluetooth device. In an example, this device can look similar to an attractive wrist watch, bracelet, finger ring, necklace, or ear ring. In an example, a device and system for measuring a person's consumption of at least one selected type of food, ingredient, or nutrient can take pictures of food using a device selected from the group consisting of: smart necklace, smart beads, smart button, neck chain, and neck pendant. In an example, this invention can comprise an electronically-functional necklace.

In an example, a device for measuring a person's food consumption can be worn in a manner similar to a piece of jewelry or accessory selected from the group consisting of: smart watch, wrist band, wrist phone, wrist watch, fitness watch, or other wrist-worn device; finger ring or artificial finger nail; arm band, arm bracelet, charm bracelet, or smart bracelet; smart necklace, neck chain, neck band, or neck-worn pendant; smart eyewear, smart glasses, electronically-functional eyewear, virtual reality eyewear, or electronically-functional contact lens; cap, hat, visor, helmet, or goggles; smart button, brooch, ornamental pin, clip, smart beads; pin-type, clip-on, or magnetic button; shirt, blouse, jacket, coat, or dress button; head phones, ear phones, hearing aid, ear plug, or ear-worn bluetooth device; dental appliance, dental insert, upper palate attachment or implant; tongue ring, ear ring, or nose ring; electronically-functional skin patch and/or adhesive patch; undergarment with electronic sensors; head band, hair band, or hair clip; ankle strap or bracelet; belt or belt buckle; and key chain or key ring.

In an example, this invention can include one or more imaging members that are worn in a manner similar to a wearable member selected from the group consisting of: necklace; pendant, dog tags; brooch; cuff link; ear ring; eyeglasses; wearable mouth microphone; and hearing aid. In an example, a device or system can comprise two imaging members. One imaging member can be worn on a person's neck like a necklace.

14. Imaging Member on or within Eyewear

In an example, one or more attachment mechanisms can comprise eyewear which is configured to hold at least one imaging member in proximity to a person's head. In an example, this invention can include one or more imaging members that are worn in a manner similar to a wearable member selected from the group consisting of: necklace; pendant, dog tags; brooch; cuff link; ear ring; eyeglasses; wearable mouth microphone; and hearing aid. In an example, this invention can comprise a device selected from the group consisting of: smart glasses, visor, or other eyewear; electronically-functional glasses, visor, or other eyewear; augmented reality glasses, visor, or other eyewear; virtual reality glasses, visor, or other eyewear; and electronically-functional contact lens. In an example, an imaging member can be electronically-functional eyewear.

In an example, a device for measuring a person's food consumption can be worn in a manner similar to a piece of jewelry or accessory selected from the group consisting of: smart watch, wrist band, wrist phone, wrist watch, fitness watch, or other wrist-worn device; finger ring or artificial finger nail; arm band, arm bracelet, charm bracelet, or smart bracelet; smart necklace, neck chain, neck band, or neck-worn pendant; smart eyewear, smart glasses, electronically-functional eyewear, virtual reality eyewear, or electronically-functional contact lens; cap, hat, visor, helmet, or goggles; smart button, brooch, ornamental pin, clip, smart beads; pin-type, clip-on, or magnetic button; shirt, blouse, jacket, coat, or dress button; head phones, ear phones, hearing aid, ear plug, or ear-worn bluetooth device; dental appliance, dental insert, upper palate attachment or implant; tongue ring, ear ring, or nose ring; electronically-functional skin patch and/or adhesive patch; undergarment with electronic sensors; head band, hair band, or hair clip; ankle strap or bracelet; belt or belt buckle; and key chain or key ring.

15. Optical Sensor on the Wrist, Finger, Hand, and/or Arm

In an example, one or more attachment mechanisms can be configured to hold an optical sensor in close proximity to a person's wrist, finger, hand, and/or arm. In an example, one or more attachment mechanisms can be configured to hold a spectroscopic optical sensor in close proximity to a person's wrist, finger, hand, and/or arm. In an example, a wearable sensor can be worn on a person's wrist, hand, finger, and/or arm. In various examples, a sensor can be worn on a person in a location selected from the group consisting of: wrist, neck, finger, hand, head, ear, eyes, nose, teeth, mouth, torso, chest, waist, and leg. In an example, a wearable sensor can be part of an electronically-functional wrist band or smart watch. In an example, a device or system can be worn on, or attached to, one or more parts of a person's body that are selected from the group consisting of: wrist (one or both), hand (one or both), or finger; neck or throat; eyes (directly such as via contact lens or indirectly such as via eyewear); mouth, jaw, lips, tongue, teeth, or upper palate; arm (one or both); waist, abdomen, or torso; nose; ear; head or hair; and ankle or leg.

16. Optical Sensor on or within a Wrist Band, Bracelet, and/or Smart Watch

In an example, one or more attachment mechanisms can comprise a wrist band, bracelet, and/or smart watch which is configured to hold an optical sensor on a person's wrist. In an example, one or more attachment mechanisms can comprise a wrist band, bracelet, and/or smart watch which is configured to hold a spectroscopic optical sensor on a person's wrist. In an example, a wearable sensor can be part of an electronically-functional wrist band or smart watch. In an example, this device can look similar to an attractive wrist watch, bracelet, finger ring, necklace, or ear ring.

In various examples, a wearable sensor can be worn on a person in a manner like a clothing accessory or piece of jewelry selected from the group consisting of: wristwatch, wristphone, wristband, bracelet, cufflink, armband, armlet, and finger ring; necklace, neck chain, pendant, dog tags, locket, amulet, necklace phone, and medallion; eyewear, eyeglasses, spectacles, sunglasses, contact lens, goggles, monocle, and visor; clip, tie clip, pin, brooch, clothing button, and pin-type button; headband, hair pin, headphones, ear phones, hearing aid, earring; and dental appliance, palatal vault attachment, and nose ring.

In an example, a device for measuring a person's consumption can be worn in a manner similar to a piece of jewelry or accessory selected from the group consisting of: smart watch, wrist band, wrist phone, wrist watch, fitness watch, or other wrist-worn device; finger ring or artificial finger nail; arm band, arm bracelet, charm bracelet, or smart bracelet; smart necklace, neck chain, neck band, or neck-worn pendant; smart eyewear, smart glasses, electronically-functional eyewear, virtual reality eyewear, or electronically-functional contact lens; cap, hat, visor, helmet, or goggles; smart button, brooch, ornamental pin, clip, smart beads; pin-type, clip-on, or magnetic button; shirt, blouse, jacket, coat, or dress button; head phones, ear phones, hearing aid, ear plug, or ear-worn bluetooth device; dental appliance, dental insert, upper palate attachment or implant; tongue ring, ear ring, or nose ring; electronically-functional skin patch and/or adhesive patch; undergarment with electronic sensors; head band, hair band, or hair clip; ankle strap or bracelet; belt or belt buckle; and key chain or key ring.

### 17. Optical Sensor on the Dorsal (or Posterior) Side or the Lateral Side of the Wrist

In an example, one or more attachment mechanisms can comprise a wrist band, bracelet, and/or smart watch which is configured to hold an optical sensor on the anterior/palmar/lower side or a lateral/narrow side of a person's wrist for scanning nearby food. In an example, one or more attachment mechanisms can comprise a wrist band, bracelet, and/or smart watch which is configured to hold a spectroscopic optical sensor on the anterior/palmar/lower side or a lateral/narrow side of a person's wrist for easier scanning of nearby food. In an example, a wearable sensor can be part of an electronically-functional wrist band or smart watch. In an example, this device can look similar to an attractive wrist watch, bracelet, finger ring, necklace, or ear ring.

### 18. Projected Light-Based Fiducial Marker

In an example, this system and device further can comprise a light-emitting member which projects a light-based fiducial marker on, or in proximity to, nearby food to estimate food size. In an example, an object of known size can be used as a fiducial marker in order to measure the size or scale of food. In an example, a laser beam can be projected to create a virtual or optical fiducial marker in order to measure food size or scale.

In an example, the volume of food consumed can be estimated by analyzing one or more pictures of that food. In an example, volume estimation can include the use of a physical or virtual fiducial marker or object of known size for estimating the size of a portion of food. In an example, a physical fiducial marker can be placed in the field of view of an imaging system for use as a point of reference or a measure. In an example, this fiducial marker can be a plate, utensil, or other physical place setting member of known size. In an example, this fiducial marker can be created virtually by the projection of coherent light beams. In an example, a device can project (laser) light points onto food and, in conjunction with infrared reflection or focal adjustment, use those points to create a virtual fiducial marker. A fiducial marker may be used in conjunction with a distance-finding mechanism (such as infrared range finder) that determines the distance from the camera and the food.

### 19. Method Embodiment for Food Identification and Quantification

In an example, this invention can be embodied in a method for food identification and quantification comprising the following steps: taking pictures and/or recording images of nearby food using at least one imaging member which is worn in proximity to a person's body; collecting data concerning the spectrum of light that is transmitted through and/or reflected from nearby food using at least one optical sensor which is worn in proximity to a person's body; and automatically analyzing the food pictures and/or images in order to identify the types and quantities of food, ingredients, and/or nutrients using an image-analyzing member.

In various examples, one or more methods to analyze pictures (in order to estimate the types and quantities of food consumed) can be selected from the group consisting of: pattern recognition; food recognition; word recognition; logo recognition; bar code recognition; face recognition; gesture recognition; and human motion recognition. In various examples, a picture of the person's mouth and/or nearby food can be analyzed with one or more methods selected from the group consisting of: pattern recognition or identification; human motion recognition or identification; face recognition or identification; gesture recognition or identification; food recognition or identification; word recognition or identification; logo recognition or identification; bar code recognition or identification; and 3D modeling.

### 20. Device, System, or Method for Food Identification and Nutritional Intake Modification

In an example, this invention can be embodied in a wearable device or system for food identification and quantification comprising: at least one imaging member, wherein this imaging member takes pictures and/or records images of nearby food, and wherein these food pictures and/or images are automatically analyzed to identify the types and quantities of food; an optical sensor, wherein this optical sensor collects data concerning light that is transmitted through or reflected from nearby food, and wherein this data is automatically analyzed to identify the types of food, the types of ingredients in the food, and/or the types of nutrients in the food; one or more attachment mechanisms, wherein these one or more attachment mechanisms are configured to hold the imaging member and the optical sensor in close proximity to the surface of a person's body; an image-analyzing member which automatically analyzes food pictures and/or images; and a computer-to-human interface which modifies the person's nutritional intake.

In an example, a computer-to-human interface can passively provide a person with information concerning food which can modify the person's eating behavior and food consumption. In an example, a computer-to-human interface can provide information to discourage a person from eating unhealthy food and/or encourage a person to eat healthy food. In an example, food can be identified as unhealthy or healthy using the definitions disclosed herein elsewhere.

In an example, a computer-to-human interface can provide information and/or feedback concerning nearby food. In an example, a computer-to-human interface can provide information and/or feedback concerning food that a person is ordering or purchasing. In an example, a computer-to-human interface can provide information and/or feedback concerning food that a person is consuming. In an example, a computer-to-human interface can provide information and/or feedback concerning food that a person has consumed.

In an example, a computer-to-human interface can modify a person's nutritional intake by actively modifying the person's eating behavior, food consumption, and/or nutritional absorption from consumed food. In an example, a computer-to-human interface can be used to not just provide information concerning eating behavior, but also to change a person's eating behavior in a more-active manner. In an example, a food-consumption monitoring device can be in wireless communication with a separate device that modifies a person's eating behavior in a more-active manner. In an example, a computer-to-human interface can comprise one or more mechanisms which actively change a person's food consumption and/or nutritional intake from consumed food.

In an example, a computer-to-human interface can provide a person with one or more stimuli related to food consumption, wherein these stimuli are selected from the group consisting of: auditory feedback (such as a voice message, alarm, buzzer, ring tone, or song); feedback via computer-generated speech; mild external electric charge or neural stimulation; periodic feedback at a selected time of the day or week; phantom taste or smell; phone call; pre-recorded audio or video message by the person from an earlier time; television-based messages; and tactile, vibratory, or pressure-based feedback.

In an example, a computer-to-human interface can create neural stimulation in order to modify a person's eating behavior and/or nutritional intake. In an example, a wearable device can be in wireless communication with a separate device which creates neural stimulation in order to modify a person's eating behavior and/or nutritional intake. In an example, a wearable device and a neural-stimulation implanted device can together comprise a system for modification of nutritional intake.

In an example, a computer-to-human interface can create pressure in order to modify a person's eating behavior and/or nutritional intake. In an example, a wearable device can be in wireless communication with a separate device which creates pressure in order to modify a person's eating behavior and/or nutritional intake. In an example, a wearable device and a pressure-generating device can together comprise a system for modification of nutritional intake.

In an example, a computer-to-human interface can create a phantom taste or smell in order to modify a person's eating behavior and/or nutritional intake. In an example, a wearable device can be in wireless communication with a separate device which creates a phantom taste or smell in order to modify a person's eating behavior and/or nutritional intake. In an example, a wearable device and a taste-or-smell-creating device can together comprise a system for modification of nutritional intake.

In an example, a computer-to-human interface can create an auditory stimulus in order to modify a person's eating behavior and/or nutritional intake. In an example, a wearable device can be in wireless communication with a separate device which creates an auditory stimulus in order to modify a person's eating behavior and/or nutritional intake. In an example, a wearable device and a sound-producing device can together comprise a system for modification of nutritional intake.

In an example, a computer-to-human interface can create a mild external electric charge in order to modify a person's eating behavior and/or nutritional intake. In an example, a wearable device can be in wireless communication with a separate device which creates an electrical charge in order to modify a person's eating behavior and/or nutritional intake. In an example, a wearable device and a charge-generating device can together comprise a system for modification of nutritional intake.

In an example, a computer-to-human interface can create an augmented reality image in order to modify a person's eating behavior and/or nutritional intake. In an example, a wearable device can be in wireless communication with a separate device which creates an augmented reality image in order to modify a person's eating behavior and/or nutritional intake. In an example, an augmented reality image can be displayed in proximity to food in a person's field of view.

In an example, information from a food-consumption monitoring device that measures a person's consumption of at least one selected type of food, ingredient, and/or nutrient can be combined with a computer-to-human interface that provides feedback to encourage the person to eat healthy foods and to limit excess consumption of unhealthy foods. In an example, a food-consumption monitoring device can be in wireless communication with a separate feedback device that modifies a person's eating behavior. In an example, capability for monitoring food consumption can be combined with capability for providing behavior-modifying feedback within a single device. In an example, a single device can be used to measure the selected types and amounts of foods, ingredients, and/or nutrients that a person consumes and to provide visual, auditory, tactile, or other feedback to encourage the person to eat in a healthier manner.

In an example, this invention can comprise a computer-to-human interface which modifies a person's nutritional intake based on the types and quantities of foods, ingredients, and/or nutrients consumed by the person. In an example, a computer-to-human interface can modify a person's nutritional intake by modifying the type and/or amount of food which the person consumes. In an example, a computer-to-human interface can modify a person's nutritional intake by modifying the absorption of nutrients from food which the person consumes.

In an example, a computer-to-human interface can reduce a person's consumption of an unhealthy type and/or quantity of food. In an example, a computer-to-human interface can reduce a person's absorption of nutrients from an unhealthy type and/or quantity of food which the person has consumed. In an example, a computer-to-human interface can allow normal (or encourage additional) consumption of a healthy type and/or quantity of food. In an example, a computer-to-human interface can allow normal absorption of nutrients from a healthy type and/or quantity of food which a person has consumed.

In an example, a type of food can be identified as being unhealthy based on analysis of images from an imaging device, analysis of data from one or more wearable sensors, analysis of data from one or more implanted sensors, or a combination thereof. In an example, unhealthy food can be identified as having a high amount or concentration of one or more nutrients selected from the group consisting of: sugars, simple sugars, simple carbohydrates, fats, saturated fats, cholesterol, and sodium. In an example, unhealthy food can be identified as having an amount of one or more nutrients selected from the group consisting of sugars, simple sugars, simple carbohydrates, fats, saturated fats, cholesterol, and sodium that is more than the recommended amount of such nutrient for the person during a given period of time.

In an example, a quantity of food or nutrient which is identified as being unhealthy can be based on one or more factors selected from the group consisting of: the type of food or nutrient; the specificity or breadth of the selected food or nutrient type; the accuracy of a sensor in detecting the selected food or nutrient; the speed or pace of food or nutrient consumption; a person's age, gender, and/or weight; changes in a person's weight; a person's diagnosed health conditions; one or more general health status indicators; the magnitude and/or certainty of the effects of past consumption of the selected nutrient on a person's health; achievement of a person's health goals; a person's exercise patterns and/or caloric expenditure; a person's physical location; the time of day; the day of the week; occurrence of a holiday or other occasion involving special meals; input from a social network and/or behavioral support group; input from a virtual health coach; the cost of food; financial payments, constraints, and/or incentives; health insurance copay and/or health insurance premium; the amount and/or duration of a person's consumption of healthy food or nutrients; a dietary plan created for a person by a health care provider; and the severity of a food allergy.

In an example, a computer-to-human interface can be part of a wearable device. In an example, a computer-to-human interface can be part of a wrist band, bracelet, or smart watch. In an example, a computer-to-human interface can be part of electronically-functional eyewear. In an example, a computer-to-human interface can be part of an implanted device which is in electronic communication with a wearable device. In an example, a computer-to-human interface can be a hardware component. In an example, a computer-to-human interface can be a software component.

In an example, a computer-to-human interface can provide feedback to a person and its effect on nutritional intake can depend on the person voluntarily changing their behavior in response to this feedback. In an example, a computer-to-human interface can directly modify the consumption and/or absorption of nutrients in a manner which does not rely on voluntary changes in a person's behavior.

In an example, a computer-to-human interface can provide negative stimuli in association with unhealthy types and quantities of food and/or provide positive stimuli in association with healthy types and quantities of food. In an example, a computer-to-human interface can allow normal absorption of nutrients from healthy types and/or quantities of food, but reduce absorption of nutrients from unhealthy types and/or quantities of food.

In an example, a computer-to-human interface can allow normal absorption of nutrients from a healthy type of food in a person's gastrointestinal tract, but can reduce absorption of nutrients from an unhealthy type of food by releasing an absorption-affecting substance into the person's gastrointestinal tract when the person consumes an unhealthy type of food. In an example, a computer-to-human interface can allow normal absorption of nutrients from a healthy quantity of food in a person's gastrointestinal tract, but can reduce absorption of nutrients from an unhealthy quantity of food by releasing an absorption-affecting substance into the person's gastrointestinal tract when the person consumes an unhealthy quantity of food.

In an example, a computer-to-human interface can reduce absorption of nutrients from an unhealthy type and/or quantity of consumed food by releasing a substance which coats the food as it passes through a person's gastrointestinal tract. In an example, a computer-to-human interface can reduce absorption of nutrients from an unhealthy type and/or quantity of consumed food by releasing a substance which coats a portion of the person's gastrointestinal tract as (or before) that food passes through the person's gastrointestinal tract. In an example, a computer-to-human interface can reduce absorption of nutrients from an unhealthy type and/or quantity of consumed food by releasing a substance which increases the speed with which that food passes through a portion of the person's gastrointestinal tract.

In an example, a computer-to-human interface can comprise an implanted reservoir of a food absorption affecting substance which is released in a person's gastrointestinal tract when the person consumes an unhealthy type and/or quantity of food. In an example, the amount of substance which is released degree to which absorption of food through a person's gastrointestinal tract can be remotely adjusted based on the degree to which a type and/or quantity of consumed food is identified as being unhealthy for that person. In an example, a computer-to-human interface can reduce consumption and/or absorption of nutrients from unhealthy types and/or quantities of food by releasing an absorption-reducing substance into the person's gastrointestinal tract.

In an example, a computer-to-human interface can allow normal consumption and absorption of healthy food, but can reduce a person's consumption and/or absorption of unhealthy food by delivering electromagnetic energy to a portion of the person's gastrointestinal tract (and/or to nerves which innervate that portion of the person's gastrointestinal tract) when the person consumes unhealthy food. In an example, a computer-to-human interface can allow normal consumption and absorption of a healthy quantity of food, but can reduce a person's consumption and/or absorption of an unhealthy quantity of food by delivering electromagnetic energy to a portion of the person's gastrointestinal tract (and/or to nerves which innervate that portion of the person's gastrointestinal tract) when the person consumes an unhealthy quantity of food.

In an example, a computer-to-human interface can deliver electromagnetic energy to a person's stomach and/or to a nerve which innervates the person's stomach. In an example, delivery of electromagnetic energy to a nerve can decrease transmission of natural impulses through that nerve. In an example, delivery of electromagnetic energy to a nerve can simulate natural impulse transmissions through that nerve. In an example, delivery of electromagnetic energy to a person's stomach or associated nerve can cause a feeling of satiety which, in turn, causes the person to consume less food. In an example, delivery of electromagnetic energy to a person's stomach or associated nerve can cause a feeling of nausea which, in turn, causes the person to consume less food.

In an example, delivery of electromagnetic energy to a person's stomach can interfere with the stomach's preparation to receive food, thereby causing the person to consume less food. In an example, delivery of electromagnetic energy to a person's stomach can slow the passage of food through a person's stomach, thereby causing the person to consume less food. In an example, delivery of electromagnetic energy to a person's stomach can interfere with the stomach's preparation to digest food, thereby causing less absorption of nutrients from consumed food. In an example, delivery of electromagnetic energy to a person's stomach can accelerate passage of food through a person's stomach, thereby causing less absorption of nutrients from consumed food. In an example, delivery of electromagnetic energy to a person's stomach can interfere with a person's sensory enjoyment of food and thus cause the person to consume less food.

In an example, a computer-to-human interface can comprise a gastric electric stimulator (GES). In an example, a computer-to-human interface can deliver electromagnetic energy to the wall of a person's stomach. In an example, a computer-to-human interface can be a neurostimulation device. In an example, a computer-to-human interface can be a neuroblocking device. In an example, a computer-to-human interface can stimulate, simulate, block, or otherwise modify electromagnetic signals in a peripheral nervous system pathway.

In an example, a computer-to-human interface can deliver electromagnetic energy to the vagus nerve. In an example, the magnitude and/or pattern of electromagnetic energy which is delivered to a person's stomach (and/or to a nerve which innervates the person's stomach) can be adjusted based on the degree to which a type and/or quantity of consumed food is identified as being unhealthy for that person. Selective interference with the consumption and/or absorption of unhealthy food (versus normal consumption and absorption of healthy food) is an advantage over food-blind gastric stimulation devices and methods in the prior art. In an example, a computer-to-human interface can reduce consumption and/or absorption of nutrients from unhealthy types and/or quantities of food by delivering electromagnetic energy to a portion of the person's gastrointestinal tract and/or to nerves which innervate that portion.

In an example, a computer-to-human interface can allow normal sensory perception of a healthy type of food, but can modify sensory perception of unhealthy food by delivering electromagnetic energy to nerves which innervate a person's tongue and/or nasal passages when the person consumes an unhealthy type of food. In an example, a computer-to-human interface can allow normal sensory perception of a healthy quantity of food, but can modify sensory perception of an unhealthy quantity of food by delivering electromagnetic energy to nerves which innervate a person's tongue and/or nasal passages when the person consumes an unhealthy quantity of food.

In an example, a computer-to-human interface can cause a person to experience an unpleasant virtual taste and/or smell when the person consumes an unhealthy type or quantity of food by delivering electromagnetic energy to afferent nerves which innervate a person's tongue and/or nasal passages. In an example, a computer-to-human interface can cause temporary dysgeusia when a person consumes an unhealthy type or quantity of food. In an example, a computer-to-human interface can cause a person to experience reduced taste and/or smell when the person consumes an unhealthy type or quantity of food by delivering electromagnetic energy to afferent nerves which innervate a person's tongue and/or nose. In an example, a computer-to-human interface can cause temporary ageusia when a person consumes an unhealthy type or quantity of food.

In an example, a computer-to-human interface can stimulate, simulate, block, or otherwise modify electromagnetic signals in an afferent nerve pathway that conveys taste and/or smell information to the brain. In an example, electromagnetic energy can be delivered to synapses between taste receptors and afferent neurons. In an example, a computer-to-human interface can deliver electromagnetic energy to a person's CN VII (Facial Nerve), CN IX (Glossopharyngeal Nerve) CN X (Vagus Nerve), and/or CN V (Trigeminal Nerve). In an example, a computer-to-human interface can inhibit or block the afferent nerves which are associated with selected T1R receptors in order to diminish or eliminate a person's perception of sweetness. In an example, a computer-to-human interface can stimulate or excite the afferent nerves which are associated with T2R receptors in order to create a virtual or phantom bitter taste.

In an example, a computer-to-human interface can deliver a selected pattern of electromagnetic energy to afferent nerves in order to make unhealthy food taste and/or smell bad. In an example, a computer-to-human interface can deliver a selected pattern of electromagnetic energy to afferent nerves in order to make healthy food taste and/or smell good. In an example, the magnitude and/or pattern of electromagnetic energy which is delivered to an afferent nerve can be adjusted based on the degree to which a type and/or quantity of consumed food is identified as being unhealthy for that person. In an example, a computer-to-human interface can reduce consumption and/or absorption of nutrients from unhealthy types and/or quantities of food by delivering electromagnetic energy to nerves which innervate a person's tongue and/or nasal passages.

In an example, a computer-to-human interface can allow normal sensory perception of a healthy type of food, but can modify the taste and/or smell of an unhealthy type of food by releasing a taste and/or smell modifying substance into a person's oral cavity and/or nasal passages. In an example, a computer-to-human interface can allow normal sensory perception of a healthy quantity of food, but can modify the taste and/or smell of an unhealthy quantity of food by releasing a taste and/or smell modifying substance into a person's oral cavity and/or nasal passages. In an example, a computer-to-human interface can release a substance with a strong flavor into a person's oral cavity when the person consumes an unhealthy type and/or quantity of food. In an example, a computer-to-human interface can release a substance with a strong smell into a person's nasal passages when the person consumes an unhealthy type and/or quantity of food. In an example, the release of a taste-modifying or smell-modifying substance can be triggered based on analysis of the type and/or quantity of food consumed.

In an example, a taste-modifying substance can be contained in a reservoir which is attached or implanted within a person's oral cavity. In an example, a taste-modifying substance can be contained in a reservoir which is attached to a person's upper palate. In an example, a taste-modifying substance can be contained in a reservoir within a dental appliance or a dental implant. In an example, a taste-modifying substance can be contained in a reservoir which is implanted so as to be in fluid or gaseous communication with a person's oral cavity. In an example, a smell-modifying substance can be contained in a reservoir which is attached or implanted within a person's nasal passages. In an example, a smell-modifying substance can be contained in a reservoir which is implanted so as to be in gaseous or fluid communication with a person's nasal passages.

In an example, a taste-modifying substance can have a strong flavor which overpowers the natural flavor of food when the substance is released into a person's oral cavity. In an example, a taste-modifying substance can be bitter, sour, hot, or just plain noxious. In an example, a taste-modifying substance can anesthetize or otherwise reduce the taste-sensing function of taste buds on a person's tongue. In an example, a taste-modifying substance can cause temporary ageusia. In an example, a smell-modifying substance can have a strong smell which overpowers the natural smell of food when the substance is released into a person's nasal passages. In an example, a smell-modifying substance can anesthetize or otherwise reduce the smell-sensing function of olfactory receptors in a person's nasal passages. In an example, a computer-to-human interface can reduce consumption and/or absorption of nutrients from unhealthy types and/or quantities of food by releasing a taste and/or smell modifying substance into a person's oral cavity and/or nasal passages.

In an example, a computer-to-human interface can modify a person's food consumption by sending a communication or message to the person wearing the device and/or to another person. In an example, a computer-to-human interface can display information on a wearable or mobile device, send a text, make a phone call, or initiate another form of electronic communication regarding food that is near a person and/or consumed food. In an example, a computer-to-human interface can display information on a wearable or mobile device, send a text, make a phone call, or initiate another form of electronic communication when a person is near food, purchasing food, ordering food, preparing food, and/or consuming food. In an example, information concerning a person's food consumption can be stored in a remote computing device, such as via the internet, and be available for the person to view.

In an example, a computer-to-human interface can send a communication or message to a person who is wearing a device. In an example, a computer-to-human interface can send the person nutritional information concerning food that the person is near, food that the person is purchasing, food that the person is ordering, and/or food that the person is consuming. This nutritional information can include food ingredients, nutrients, and/or calories. In an example, a computer-to-human interface can send the person information concerning the likely health effects of consuming food that the person is near, food that the person is purchasing, food that the person is ordering, and/or food that the person has already starting consuming. In an example, food information which is communicated to the person can be in text form. In an example, a communication can recommend a healthier substitute for unhealthy food which the person is considering consuming.

In an example, food information which is communicated to the person can be in graphic form. In an example, food information which is communicated to the person can be in spoken and/or voice form. In an example, a communication can be in a person's own voice. In an example, a communication can be a pre-recorded message from the person. In an example, a communication can be in the voice of a person who is significant to the person wearing a device. In an example, a communication can be a pre-recorded message from that significant person. In an example, a communication can provide negative feedback in association with consumption of unhealthy food. In an example, a communication can provide positive feedback in association with consumption of healthy food and/or avoiding consumption of unhealthy food. In an example, negative information associated with unhealthy food can encourage the person to eat less unhealthy food and positive information associated with healthy foods can encourage the person to eat more healthy food.

In an example, a computer-to-human interface can send a communication to a person other than the person who is wearing a device. In an example, this other person can provide encouragement and support for the person wearing the device to eat less unhealthy food and/or eat more healthy food. In an example, this other person can be a friend, support group member, family member, or a health care provider. In an example, this device could send a text to Kevin Bacon, or someone who knows him, or someone who knows someone who knows him. In an example, a computer-to-human interface can comprise connectivity with a social network website and/or an internet-based support group. In an example, a computer-to-human interface can encourage a person to reduce consumption of unhealthy types and/or quantities of food (and increase consumption of healthy food) in order to achieve personal health goals. In an example, a computer-to-human interface can encourage a person to reduce consumption of unhealthy types and/or quantities of food (and increase consumption of healthy food) in order to compete with friends and/or people in a peer group with respect to achievement of health goals. In an example, a computer-to-human interface can function as a virtual dietary health coach. In an example, a computer-to-human interface can reduce consumption and/or absorption of nutrients from unhealthy types and/or quantities of food by constricting, slowing, and/or reducing passage of food through the person's gastrointestinal tract.

In an example, a computer-to-human interface can display images or other visual information in a person's field of view which modify the person's consumption of food. In an example, a computer-to-human interface can display images or other visual information in proximity to food in the person's field of view in a manner which modifies the person's consumption of that food. In an example, a computer-to-human interface can be part of an augmented reality system which displays virtual images and/or information in proximity to real world objects. In an example, a nutritional intake modification system can superimpose virtual images and/or information on food in a person's field of view.

In an example, a computer-to-human interface can display virtual nutrition information concerning food that is in a person's field of view. In an example, a computer-to-human interface can display information concerning the ingredients, nutrients, and/or calories in a portion of food which is within a person's field of view. In an example, this information can be based on analysis of images from the imaging device, one or more (other) wearable sensors, or both. In an example, virtual nutrition information can be displayed on a screen (or other display mode) which is separate from a person's view of their environment.

In an example, virtual nutrition information can be superimposed on a person's view of their environment as part of an augmented reality system. In an augmented reality system, virtual nutrition information can be superimposed directly over the food in question. In an example, display of negative nutritional information and/or information about the potential negative effects of unhealthy nutrients can reduce a person's consumption of an unhealthy type or quantity of food. In an example, a computer-to-human interface can display warnings about potential negative health effects and/or allergic reactions. In an example, display of positive nutritional information and/or information on the potential positive effects of healthy nutrients can increase a person's consumption of healthy food. In an example, a computer-to-human interface can display encouraging information about potential health benefits of selected foods or nutrients.

In an example, a computer-to-human interface can display virtual images in response to food that is in a person's field of view. In an example, virtual images can be displayed on a screen (or other display mode) which is separate from a person's view of their environment. In an example, virtual images can be superimposed on a person's view of their environment, such as part of an augmented reality system. In an augmented reality system, a virtual image can be superimposed directly over the food in question. In an example, display of unpleasant image (or one with negative connotations) can reduce a person's consumption of an unhealthy type or quantity of food. In an example, display of an appealing image (or one with positive connotations) can increase a person's consumption of healthy food. In an example, a computer-to-human interface can display an image of a virtual person in response to food, wherein the weight, size, shape, and/or health status of this person is based on the potential effects of (repeatedly) consuming this food. In an example, this virtual person can be a modified version of the person wearing a device, wherein the modification is based on the potential effects of (repeatedly) consuming the food in question. In an example, this invention can show the person how they will probably look if they (repeatedly) consume this type and/or quantity of food.

In an example, a computer-to-human interface can be part of an augmented reality system which changes a person's visual perception of unhealthy food to make it less appealing and/or changes the person's visual perception of healthy food to make it more appealing. In an example, a change in visual perception of food can be selected from the group consisting of: a change in perceived color and/or light spectrum; a change in perceived texture or shading; and a change in perceived size or shape. In an example, a computer-to-human interface can display an unappealing image which is unrelated to food but which, when shown in juxtaposition with unhealthy food, will decrease the appeal of that food by association. In an example, a computer-to-human interface can display an appealing image which is unrelated to food but which, when shown in juxtaposition with healthy food, will increase the appeal of that food by association. In an example, a computer-to-human interface can reduce consumption and/or absorption of nutrients from unhealthy types and/or quantities of food by displaying images or other visual information in a person's field of view.

In an example, a computer-to-human interface can allow normal passage of a healthy type of food through a person's gastrointestinal tract, but can constrict, slow, and/or reduce passage of an unhealthy type of food through the person's gastrointestinal tract. In an example, a computer-to-human interface can allow normal passage of up to a healthy cumulative quantity of food (during a meal or selected period of time) through a person's gastrointestinal tract, but can constrict, slow, and/or reduce passage of food in excess of this quantity. In an example, a type and/or quantity of food can be identified as healthy or unhealthy based on analysis of images from the imaging member. In an example, a type and/or quantity of food can be identified as unhealthy based on analysis of images from an imaging device, analysis of data from one or more wearable or implanted sensors, or both. In an example, unhealthy food can be identified as having large (relative) quantities of simple sugars, carbohydrates, saturated fats, bad cholesterol, and/or sodium compounds.

In an example, a computer-to-human interface can selectively constrict, slow, and/or reduce passage of food through a person's gastrointestinal tract by adjustably constricting or resisting jaw movement, adjustably changing the size or shape of the person's oral cavity, adjustably changing the size or shape of the entrance to a person's stomach, adjustably changing the size, shape, or function of the pyloric sphincter, and/or adjustably changing the size or shape of the person's stomach. In an example, such adjustment can be done in a non-invasive (such as through wireless communication) and reversible manner after an operation in which a device is implanted. In an example, the degree to which passage of food through a person's gastrointestinal tract is constricted, slowed, and/or reduced can be adjusted based on the degree to which a type and/or quantity of food is identified as being unhealthy for that person.

In an example, a computer-to-human interface can allow normal absorption of nutrients from consumed food which is identified as a healthy type of food, but can reduce absorption of nutrients from consumed food which is identified as an unhealthy type of food. In an example, a computer-to-human interface can allow normal absorption of nutrients from consumed food up to a selected cumulative quantity (during a meal or selected period of time) which is identified as a healthy quantity of food, but can reduce absorption of nutrients from consumed food greater than this selected cumulative quantity. In an example, a type and/or quantity of food can be identified as healthy or unhealthy based on analysis of images from the imaging member. In an example, a type and/or quantity of food can be identified as unhealthy based on analysis of images from an imaging device, analysis of data from one or more wearable or implanted sensors, or both. In an example, unhealthy food can be identified as having large (relative) quantities of simple sugars, carbohydrates, saturated fats, bad cholesterol, and/or sodium compounds.

In an example, a computer-to-human interface can selectively reduce absorption of nutrients from consumed food by changing the route through which that food passes as that food travels through the person's gastrointestinal tract. In an example, a computer-to-human interface can comprise an adjustable valve within a person's gastrointestinal tract. In an example, an adjustable valve of an intake modification component can be located within a person's stomach. In an example, an adjustable food valve can have a first configuration which directs food through a first route through a person's gastrointestinal tract and can have a second configuration which directs food through a second configuration in a person's gastrointestinal tract. In an example, the first configuration can be shorter or bypass key nutrient-absorbing structures (such as the duodenum) in the gastrointestinal tract. In an example, a computer-to-human interface can direct a healthy type and/or quantity of food through a longer route through a person's gastrointestinal tract and can direct an unhealthy type and/or quantity of food through a shorter route through a person's gastrointestinal tract. In an example, a computer-to-human interface can reduce consumption and/or absorption of nutrients from unhealthy types and/or quantities of food by sending a communication to the person wearing the imaging member and/or to another person.

In an example, a computer-to-human interface can comprise one or more actuators which exert inward pressure on the exterior surface of a person's body in response to consumption of an unhealthy type and/or quantity of food. In an example a computer-to-human interface can comprise one or more actuators which are incorporated into an article of clothing or a clothing accessory, wherein these one or more actuators are constricted when a person consumes an unhealthy type and/or amount of food. In an example, an article of clothing can be smart shirt. In an example, a clothing accessory can be a belt. In an example, an actuator can be a piezoelectric actuator. In an example, an actuator can be a piezoelectric textile or fabric.

In an example, a computer-to-human interface can deliver a low level of electromagnetic energy to the exterior surface of a person's body in response to consumption of an unhealthy type and/or quantity of food. In an example, this electromagnetic energy can act as an adverse stimulus which reduces a person's consumption of unhealthy food. In an example, this electromagnetic energy can interfere with the preparation of the stomach to receive and digest. In an example, a computer-to-human interface can comprise a financial restriction function which impedes the purchase of an unhealthy type and/or quantity of food. In an example, this invention can reduce the ability of a person to purchase or order food when the food is identified as being unhealthy.

In an example, a computer-to-human interface can be implanted so as to deliver electromagnetic energy to one or more organs or body tissues selected from the group consisting of: brain, pyloric sphincter, small intestine, large intestine, liver, pancreas, and spleen. In an example, a computer-to-human interface can be implanted so as to deliver electromagnetic energy to the muscles which move one or more organs or body tissues selected from the group consisting of: esophagus, stomach, pyloric sphincter, small intestine, large intestine, liver, pancreas, and spleen. In an example, a computer-to-human interface can be implanted so as to deliver electromagnetic energy to the nerves which innervate one or more organs or body tissues selected from the group consisting of: esophagus, stomach, pyloric sphincter, small intestine, large intestine, liver, pancreas, and spleen.

In an example, a computer-to-human interface can comprise an implanted or wearable drug dispensing device which dispenses an appetite and/or digestion modifying drug in response to consumption of an unhealthy type and/or quantity of food. In an example, a computer-to-human interface can comprise a light-based computer-to-human interface which emits light in response to consumption of an unhealthy type and/or quantity of food. In an example, this interface can comprise an LED array. In an example, a computer-to-human interface can comprise a sound-based computer-to-human interface which emits sound in response to consumption of an unhealthy type and/or quantity of food. In an example, this sound can be a voice, tones, and/or music. In an example, a computer-to-human interface can comprise a tactile-based computer-to-human interface which creates tactile sensations in response to consumption of an unhealthy type and/or quantity of food. In an example, this tactile sensation can be a vibration (and not a good one).

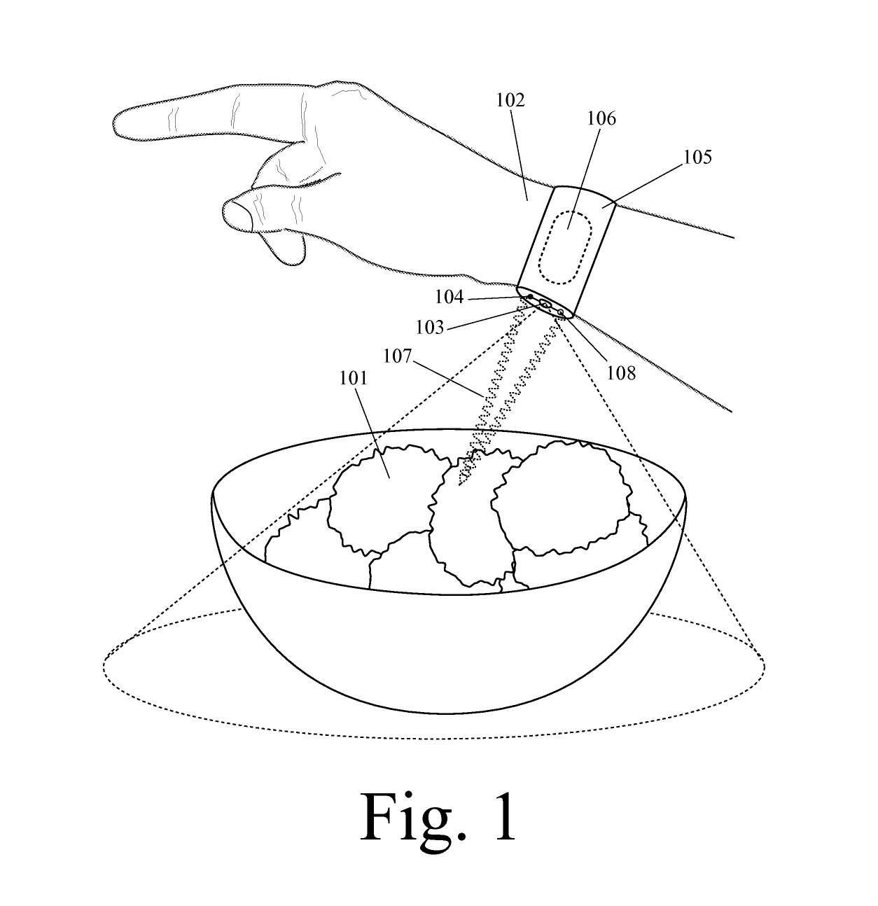

### 21. Detailed Description of FIGS. 1 Through 3

FIGS. 1 through 3 show examples of how this invention can be embodied in a wearable device or system for food identification and quantification comprising: at least one imaging member, wherein this imaging member takes pictures and/or records images of nearby food, and wherein these food pictures and/or images are automatically analyzed to identify the types and quantities of food; an optical sensor, wherein this optical sensor collects data concerning light that is transmitted through or reflected from nearby food, and wherein this data is automatically analyzed to identify the types of food, the types of ingredients in the food, and/or the types of nutrients in the food; one or more attachment mechanisms, wherein these one or more attachment mechanisms are configured to hold the imaging member and the optical sensor in close proximity to the surface of a person's body; and an image-analyzing member which automatically analyzes food pictures and/or images. The examples shown in FIGS. 1 through 3 can further comprise any of the variations in components or methods which were discussed herein in previous sections.

FIG. 1, in particular, shows an example of how this invention can be embodied in a wearable device for food identification and quantification comprising: imaging member 103, wherein imaging member 103 takes pictures and/or records images of nearby food 101, and wherein these food pictures and/or images are automatically analyzed to identify the types and quantities of food 101; optical sensor 104, wherein optical sensor 104 collects data concerning light 107 that is reflected from nearby food 101, and wherein this data is automatically analyzed to identify the types of food 101, the types of ingredients in food 101, and/or the types of nutrients in food 101; attachment mechanism 105, wherein attachment mechanism 105 is configured to hold imaging member 103 and optical sensor 104 in close proximity to the surface of a person's body 102; and image-analyzing member 106 which automatically analyzes food pictures and/or images.

The example shown in FIG. 1 also includes a light-emitting member 108 which emits light 107 which is then reflected from nearby food 101. In this example, imaging member 103 is a camera. In this example, imaging member 103 is configured to have a focal direction which points outward from the surface of the person's body 102. In this example, optical sensor 104 is a spectroscopic optical sensor that collects data concerning the spectrum of light 107 that is reflected from nearby food 101. In this example, optical sensor 104 is configured to have a sensing direction which points outward from the surface of the person's body 102.

In the example shown in FIG. 1, attachment mechanism 105 is a wrist band. In this example, image-analyzing member 106 is a data control unit which can further comprise one or more components selected from the group consisting of: data processing unit; motion sensor, electromagnetic sensor, optical sensor, and/or chemical sensor; graphic display component; human-to-computer communication component; memory component; power source; and wireless data transmission and reception component.

In this example, attachment mechanism 105 is configured to hold imaging member 103 in close proximity to the person's wrist 102. In this example, attachment mechanism 105 comprises a wrist band which is configured to hold imaging member 103 on the person's wrist 102. In this example, attachment mechanism 105 comprises a wrist band which is configured to hold imaging member 103 on the anterior/palmar/lower side of the person's wrist 103 in order to easily take pictures and/or record images of nearby food 101. In this example, close proximity is defined as being less than three inches away. In another example, close proximity can defined as being less than six inches away.

In the example shown in FIG. 1, attachment mechanism 105 is configured to hold optical sensor 104 in close proximity to the person's wrist 102. In this example, attachment mechanism 105 comprises a wrist band which is configured to hold optical sensor 104 on the person's wrist 102. In this example, attachment mechanism 105 comprises a wrist band which is configured to hold optical sensor 104 on the anterior/palmar/lower side of the person's wrist 103 in order to easily sense light 107 reflected from nearby food 101.

FIG. 1 shows a device which can support a method for food identification and quantification comprising the following steps: taking pictures and/or recording images of nearby food 101 using at least one imaging member 104 which is worn in proximity to a person's body 102; collecting data concerning the spectrum of light 107 that is transmitted through and/or reflected from nearby food 101 using at least one optical sensor 104 which is worn in proximity to a person's body 102; and automatically analyzing the food pictures and/or images in order to identify the types and quantities of food, ingredients, and/or nutrients using an image-analyzing member 106.

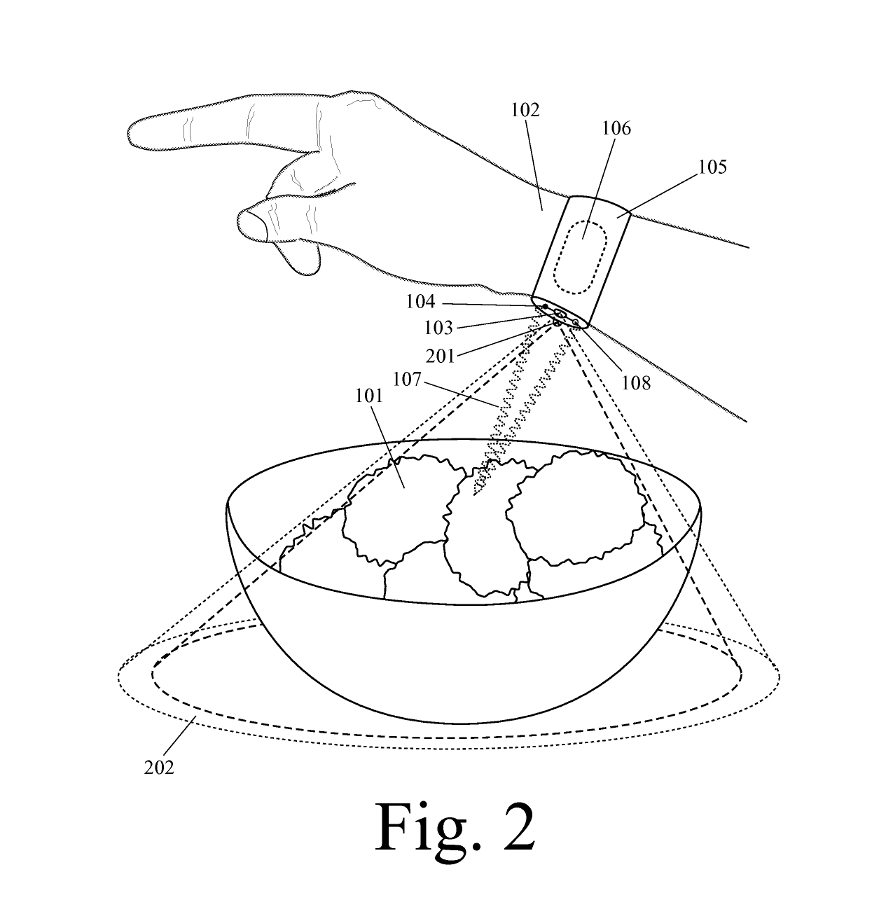

FIG. 2 shows an example of how this invention can be embodied in a wearable device for food identification and quantification which is the same as the embodiment shown in FIG. 1, except that FIG. 2 further comprises a light-emitting member 201 which projects a light-based fiducial marker 202 on, or in proximity to, nearby food 101 to better estimate the size of food 101. In an example, light-emitting member 201 can be a laser which emits coherent light.

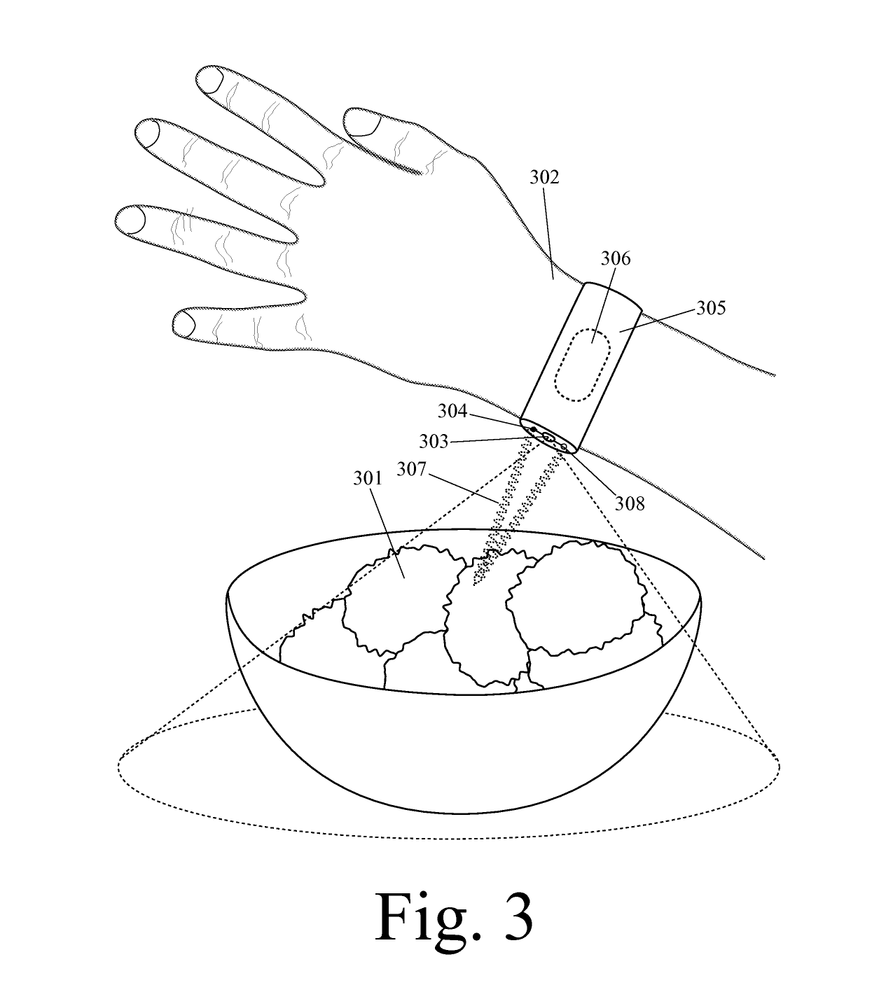

FIG. 3 shows an example of this invention which is similar to that shown in FIG. 1 except that the attachment mechanism in FIG. 3 holds the imaging member and the optical sensor on a lateral/narrow side of a person's wrist. FIG. 3 shows an example of how this invention can be embodied in a wearable device for food identification and quantification comprising: at least one imaging member 303, wherein this imaging member takes pictures and/or records images of nearby food 301, and wherein these food pictures and/or images are automatically analyzed to identify the types and quantities of food; an optical sensor 304, wherein this optical sensor collects data concerning light 307 that is transmitted through or reflected from nearby food 301, and wherein this data is automatically analyzed to identify the types of food 301, the types of ingredients in food 301, and/or the types of nutrients in food 301; one or more attachment mechanisms 305, wherein these one or more attachment mechanisms are configured to hold the imaging member 303 and the optical sensor 304 in close proximity to the surface of a person's body 302; and an image-analyzing member 306 which automatically analyzes food pictures and/or images. In an example, there can be two or more imaging members. In an example, there can be two imaging members, one on each of the two opposite lateral/narrow sides of a person's wrist.

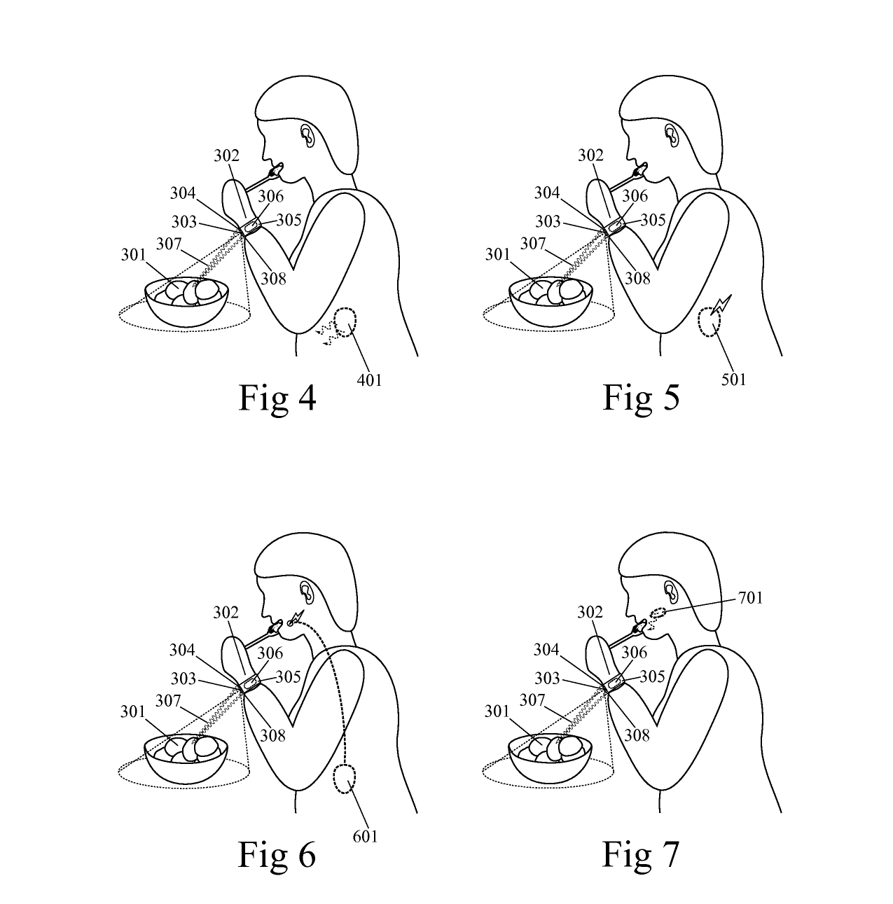

### 22. Detailed Description of FIGS. 4 Through 10

FIGS. 4 through 10 show examples of how this invention can be embodied in a wearable system or device for food identification and nutritional intake modification comprising: at least one imaging member, wherein this imaging member takes pictures and/or records images of nearby food, and wherein these food pictures and/or images are automatically analyzed to identify the types and quantities of food; an optical sensor, wherein this optical sensor collects data concerning light that is transmitted through or reflected from nearby food, and wherein this data is automatically analyzed to identify the types of food, the types of ingredients in the food, and/or the types of nutrients in the food; one or more attachment mechanisms, wherein these one or more attachment mechanisms are configured to hold the imaging member and the optical sensor in close proximity to the surface of a person's body; an image-analyzing member which automatically analyzes food pictures and/or images; and a computer-to-human interface which modifies the person's nutritional intake. The examples shown in FIGS. 4 through 10 can further comprise any of the variations in components or methods which were discussed herein in previous sections.

FIG. 4 shows an example of how this invention can be embodied in a wearable system or device for food identification and nutritional intake modification comprising: imaging member 303, wherein imaging member 303 takes pictures and/or records images of nearby food 301, and wherein these food pictures and/or images are automatically analyzed to identify the types and quantities of food 301; optical sensor 304, wherein optical sensor 304 collects data concerning light 307 that is reflected from nearby food 301, and wherein this data is automatically analyzed to identify the types of food 301, the types of ingredients in food 301, and/or the types of nutrients in food 301; attachment mechanism 305, wherein attachment mechanism 305 is configured to hold imaging member 303 and optical sensor 304 in close proximity to the surface of a person's body 302; image-analyzing member 306 which automatically analyzes food pictures and/or images; and computer-to-human interface 401 which modifies the person's nutritional intake. As discussed earlier, unhealthy types and/or quantities of food, ingredients, or nutrients can be identified based on data from the imaging member and the optical sensor.

In this example, computer-to-human interface 401 is an implanted substance-releasing device. In this example, computer-to-human interface 401 allows normal absorption of nutrients from healthy types and/or quantities of food, but reduces absorption of nutrients from unhealthy types and/or quantities of food. In this example, computer-to-human interface 401 reduces consumption and/or absorption of nutrients from unhealthy types and/or quantities of food by releasing an absorption-reducing substance into the person's gastrointestinal tract. In this example, computer-to-human interface 401 releases an absorption-reducing substance into the person's stomach.

FIG. 5 shows an example of how this invention can be embodied in a wearable system or device for food identification and nutritional intake modification comprising: imaging member 303, wherein imaging member 303 takes pictures and/or records images of nearby food 301, and wherein these food pictures and/or images are automatically analyzed to identify the types and quantities of food 301; optical sensor 304, wherein optical sensor 304 collects data concerning light 307 that is reflected from nearby food 301, and wherein this data is automatically analyzed to identify the types of food 301, the types of ingredients in food 301, and/or the types of nutrients in food 301; attachment mechanism 305, wherein attachment mechanism 305 is configured to hold imaging member 303 and optical sensor 304 in close proximity to the surface of a person's body 302; image-analyzing member 306 which automatically analyzes food pictures and/or images; and computer-to-human interface 501 which modifies the person's nutritional intake. As discussed earlier, unhealthy types and/or quantities of food, ingredients, or nutrients can be identified based on information from the imaging member and the optical sensor.

In this example, computer-to-human interface 501 is an implanted electromagnetic energy emitter. In this example, computer-to-human interface 501 allows normal absorption of nutrients from healthy types and/or quantities of food, but reduces absorption of nutrients from unhealthy types and/or quantities of food. In this example, computer-to-human interface 501 reduces consumption and/or absorption of nutrients from unhealthy types and/or quantities of food by delivering electromagnetic energy to a portion of the person's gastrointestinal tract and/or to nerves which innervate that portion. In this example, computer-to-human interface 501 delivers electromagnetic energy to the person's stomach and/or to a nerve which innervates the stomach.

FIG. 6 shows an example of how this invention can be embodied in a wearable system or device for food identification and nutritional intake modification comprising: imaging member 303, wherein imaging member 303 takes pictures and/or records images of nearby food 301, and wherein these food pictures and/or images are automatically analyzed to identify the types and quantities of food 301; optical sensor 304, wherein optical sensor 304 collects data concerning light 307 that is reflected from nearby food 301, and wherein this data is automatically analyzed to identify the types of food 301, the types of ingredients in food 301, and/or the types of nutrients in food 301; attachment mechanism 305, wherein attachment mechanism 305 is configured to hold imaging member 303 and optical sensor 304 in close proximity to the surface of a person's body 302; image-analyzing member 306 which automatically analyzes food pictures and/or images; and computer-to-human interface 601 which modifies the person's nutritional intake. As discussed earlier, unhealthy types and/or quantities of food, ingredients, or nutrients can be identified based on information from the imaging member and the optical sensor.

In this example, computer-to-human interface 601 is an implanted electromagnetic energy emitter. In this example, computer-to-human interface 601 allows normal consumption (and/or absorption) of nutrients from healthy types and/or quantities of food, but reduces consumption (and/or absorption) of nutrients from unhealthy types and/or quantities of food. In this example, computer-to-human interface 601 reduces consumption and/or absorption of nutrients from unhealthy types and/or quantities of food by delivering electromagnetic energy to nerves which innervate a person's tongue and/or nasal passages. In an example, this electromagnetic energy can reduce taste and/or smell sensations. In an example, this electromagnetic energy can create virtual taste and/or smell sensations.

FIG. 7 shows an example of how this invention can be embodied in a wearable system or device for food identification and nutritional intake modification comprising: imaging member 303, wherein imaging member 303 takes pictures and/or records images of nearby food 301, and wherein these food pictures and/or images are automatically analyzed to identify the types and quantities of food 301; optical sensor 304, wherein optical sensor 304 collects data concerning light 307 that is reflected from nearby food 301, and wherein this data is automatically analyzed to identify the types of food 301, the types of ingredients in food 301, and/or the types of nutrients in food 301; attachment mechanism 305, wherein attachment mechanism 305 is configured to hold imaging member 303 and optical sensor 304 in close proximity to the surface of a person's body 302; image-analyzing member 306 which automatically analyzes food pictures and/or images; and computer-to-human interface 701 which modifies the person's nutritional intake. As discussed earlier, unhealthy types and/or quantities of food, ingredients, or nutrients can be identified based on information from the imaging member and the optical sensor.

In this example, computer-to-human interface 701 is an implanted substance-releasing device. In this example, computer-to-human interface 701 allows normal consumption (and/or absorption) of nutrients from healthy types and/or quantities of food, but reduces consumption (and/or absorption) of nutrients from unhealthy types and/or quantities of food. In this example, computer-to-human interface 701 reduces consumption and/or absorption of nutrients from unhealthy types and/or quantities of food by releasing a taste and/or smell modifying substance into a person's oral cavity and/or nasal passages. In an example, this substance can overpower the taste and/or smell of food. In an example, this substance can be released selectively to make unhealthy food taste or smell bad.

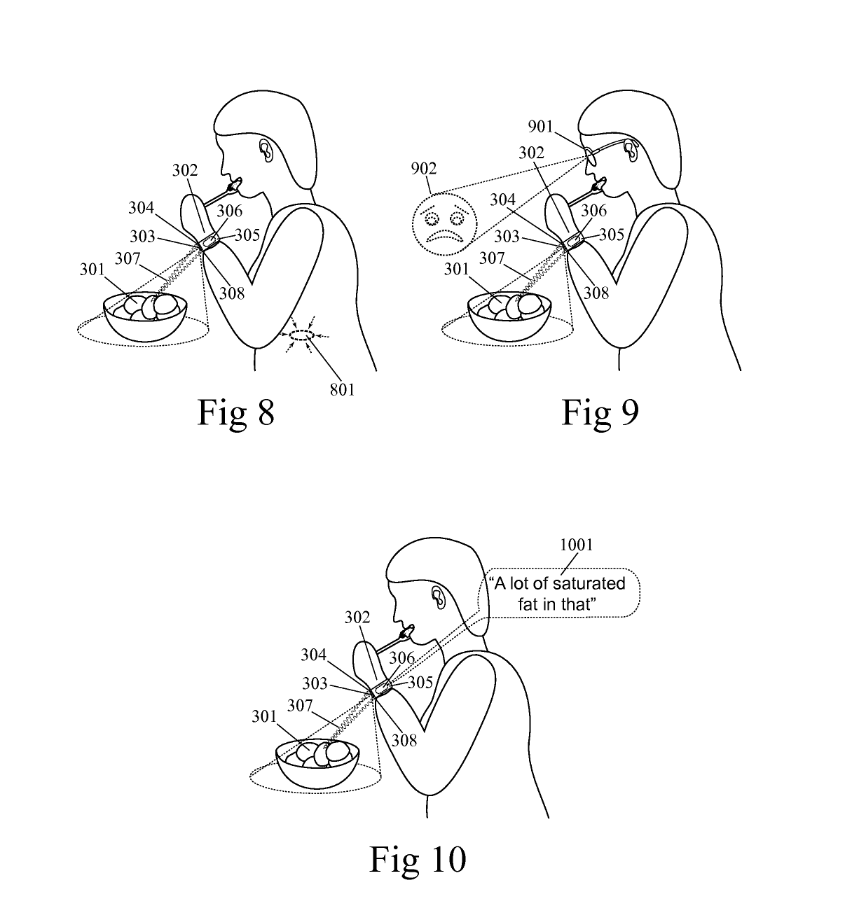

FIG. 8 shows an example of how this invention can be embodied in a wearable system or device for food identification and nutritional intake modification comprising: imaging member 303, wherein imaging member 303 takes pictures and/or records images of nearby food 301, and wherein these food pictures and/or images are automatically analyzed to identify the types and quantities of food 301; optical sensor 304, wherein optical sensor 304 collects data concerning light 307 that is reflected from nearby food 301, and wherein this data is automatically analyzed to identify the types of food 301, the types of ingredients in food 301, and/or the types of nutrients in food 301; attachment mechanism 305, wherein attachment mechanism 305 is configured to hold imaging member 303 and optical sensor 304 in close proximity to the surface of a person's body 302; image-analyzing member 306 which automatically analyzes food pictures and/or images; and computer-to-human interface 801 which modifies the person's nutritional intake. As discussed earlier, unhealthy types and/or quantities of food, ingredients, or nutrients can be identified based on information from the imaging member and the optical sensor.

In this example, computer-to-human interface 801 is an implanted gastrointestinal constriction device. In this example, computer-to-human interface 801 allows normal consumption (and/or absorption) of nutrients from healthy types and/or quantities of food, but reduces consumption (and/or absorption) of nutrients from unhealthy types and/or quantities of food. In this example, computer-to-human interface 801 reduces consumption and/or absorption of nutrients from unhealthy types and/or quantities of food by constricting, slowing, and/or reducing passage of food through the person's gastrointestinal tract. In an example, this computer-to-human interface 801 is a remotely-adjustable gastric band.

FIG. 9 shows an example of how this invention can be embodied in a wearable system or device for food identification and nutritional intake modification comprising: imaging member 303, wherein imaging member 303 takes pictures and/or records images of nearby food 301, and wherein these food pictures and/or images are automatically analyzed to identify the types and quantities of food 301; optical sensor 304, wherein optical sensor 304 collects data concerning light 307 that is reflected from nearby food 301, and wherein this data is automatically analyzed to identify the types of food 301, the types of ingredients in food 301, and/or the types of nutrients in food 301; attachment mechanism 305, wherein attachment mechanism 305 is configured to hold imaging member 303 and optical sensor 304 in close proximity to the surface of a person's body 302; image-analyzing member 306 which automatically analyzes food pictures and/or images; and a computer-to-human interface (comprising eyewear 901 and virtual image 902) which modifies the person's nutritional intake. As discussed earlier, unhealthy types and/or quantities of food, ingredients, or nutrients can be identified based on information from the imaging member and the optical sensor.

In this example, the computer-to-human interface comprises eyewear 901 (with which image-analyzing member 306 is in wireless communication) and a virtually-displayed image 902. In this example, virtually-displayed image 902 is a frowning face which is shown in proximity to unhealthy food 301. In an example, a virtually-displayed image or food information can be shown in a person's field of vision as part of augmented reality. In an example, a virtually-displayed image or food information can be shown on the surface of a wearable or mobile device. In this example, this computer-to-human interface allows normal consumption of nutrients from healthy types and/or quantities of food, but discourages consumption of nutrients from unhealthy types and/or quantities of food. In this example, a computer-to-human interface discourages consumption and/or absorption of nutrients from unhealthy types and/or quantities of food by displaying negative images or other visual information in a person's field of view. In this example, a computer-to-human interface provides negative stimuli in association with unhealthy types and quantities of food and/or provides positive stimuli in association with healthy types and quantities of food. This example can include other types of informational displays and other component variations which were discussed earlier.

FIG. 10 shows an example of how this invention can be embodied in a wearable system or device for food identification and nutritional intake modification comprising: imaging member 303, wherein imaging member 303 takes pictures and/or records images of nearby food 301, and wherein these food pictures and/or images are automatically analyzed to identify the types and quantities of food 301; optical sensor 304, wherein optical sensor 304 collects data concerning light 307 that is reflected from nearby food 301, and wherein this data is automatically analyzed to identify the types of food 301, the types of ingredients in food 301, and/or the types of nutrients in food 301; attachment mechanism 305, wherein attachment mechanism 305 is configured to hold imaging member 303 and optical sensor 304 in close proximity to the surface of a person's body 302; image-analyzing member 306 which automatically analyzes food pictures and/or images; and a computer-to-human interface which modifies the person's nutritional intake. As discussed earlier, unhealthy types and/or quantities of food, ingredients, or nutrients can be identified based on information from the imaging member and the optical sensor.

In this example, the computer-to-human interface comprises an audio message 1001 which is communicated to the person wearing the device. In an example, this audio message can be emitted from a speaker or other sound-emitting component which is incorporated into attachment mechanism 305. In this example, the computer-to-human interface allows normal consumption of nutrients from healthy types and/or quantities of food, but discourages consumption of nutrients from unhealthy types and/or quantities of food. In this example, the computer-to-human interface discourages consumption and/or absorption of nutrients from unhealthy types and/or quantities of food by sending an audio communication to the person wearing the imaging member and/or to another person. In this example, a computer-to-human interface provides negative stimuli in association with unhealthy types and quantities of food and/or provides positive stimuli in association with healthy types and quantities of food. This example can include other types of computer-to-human communication and other component variations which were discussed earlier.

I claim:

1. A wearable device or system for food identification and quantification comprising:
at least one imaging member, wherein this imaging member takes pictures and/or records images of nearby food, and wherein these food pictures and/or images are automatically analyzed to identify the types and quantities of food;
an optical sensor, wherein this optical sensor collects data concerning light that is transmitted through or reflected from nearby food, and wherein this data is automatically analyzed to identify the types of food, the types of ingredients in the food, and/or the types of nutrients in the food;
one or more attachment mechanisms, wherein these one or more attachment mechanisms are configured to hold the imaging member and the optical sensor in close proximity to the surface of a person's body; and
an image-analyzing member which automatically analyzes food pictures and/or images.

2. The device or system in claim 1 wherein the at least one imaging member is a camera.

3. The device or system in claim 1 wherein the at least one imaging member is configured to have a focal direction which points outward from the surface of a person's body or clothing.

4. The device or system in claim 1 wherein the optical sensor is a spectroscopic optical sensor that collects data concerning the spectrum of light that is transmitted through and/or reflected from nearby food.

5. The device or system in claim 1 wherein the optical sensor is configured to have a sensing direction which points outward from the surface of a person's body or clothing.

6. The device or system in claim 1 wherein the one or more attachment mechanisms are selected from the group consisting of: arm band, bracelet, brooch, collar, cuff link, dog tags, ear ring, ear-mounted bluetooth device, eyeglasses, finger ring, headband, hearing aid, necklace, pendant, wearable mouth microphone, wrist band, and wrist watch.

7. The device or system in claim 1 wherein the image-analyzing member is a data control unit.

8. The device or system in claim 1 wherein close proximity is defined as being less than three inches away.

9. The device or system in claim 1 wherein the one or more attachment mechanisms are configured to hold at least one imaging member in close proximity to a person's wrist, finger, hand, and/or arm.

10. The device or system in claim 1 wherein the one or more attachment mechanisms comprise a wrist band, bracelet, and/or smart watch which is configured to hold at least one imaging member on a person's wrist.

11. The device or system in claim 1 wherein the one or more attachment mechanisms comprise a wrist band, bracelet, and/or smart watch which is configured to hold at least one imaging member on the anterior/palmar/lower side or a lateral/narrow side of a person's wrist for imaging nearby food.

12. The device or system in claim 1 wherein the one or more attachment mechanisms are configured to hold at least one imaging member in close proximity to a person's neck or head.

13. The device or system in claim 1 wherein the one or more attachment mechanisms comprise a neck-encircling member which is configured to hold at least one imaging member in proximity to a person's neck.

14. The device or system in claim 1 wherein the one or more attachment mechanisms comprise eyewear which is configured to hold at least one imaging member in close proximity to a person's head.

15. The device or system in claim 1 wherein the one or more attachment mechanisms are configured to hold an optical sensor in close proximity to a person's wrist, finger, hand, and/or arm.

16. The device or system in claim 1 wherein the one or more attachment mechanisms comprise a wrist band, bracelet, and/or smart watch which is configured to hold an optical sensor on a person's wrist.

17. The device or system in claim 1 wherein the one or more attachment mechanisms comprise a wrist band, bracelet, and/or smart watch which is configured to hold an optical sensor on the anterior/palmar/lower side or a lateral/narrow side of a person's wrist for scanning nearby food.

18. The device or system in claim 1 wherein this system or device further comprises a light-emitting member which projects a light-based fiducial marker on, or in proximity to, nearby food to estimate food size.

19. A method for food identification and quantification comprising the following steps:
taking pictures and/or recording images of nearby food using at least one imaging member which is worn in close proximity to a person's body;
collecting data concerning the spectrum of light that is transmitted through and/or reflected from nearby food using at least one optical sensor which is worn in close proximity to a person's body; and
automatically analyzing the food pictures and/or images in order to identify the types and quantities of food, ingredients, and/or nutrients using an image-analyzing member.

20. A wearable device or system for food identification and nutritional intake modification comprising:
at least one imaging member, wherein this imaging member takes pictures and/or records images of nearby food, and wherein these food pictures and/or images are automatically analyzed to identify the types and quantities of food;
an optical sensor, wherein this optical sensor collects data concerning light that is transmitted through or reflected from nearby food, and wherein this data is automatically analyzed to identify the types of food, the types of ingredients in the food, and/or the types of nutrients in the food;
one or more attachment mechanisms, wherein these one or more attachment mechanisms are configured to hold the imaging member and the optical sensor in close proximity to the surface of a person's body;
an image-analyzing member which automatically analyzes food pictures and/or images; and
a computer-to-human interface which modifies the person's nutritional intake.
